(19) United States
(12) Patent Application Publication
(10) Pub. No.: US 2011/0230089 A1
(43) Pub. Date: Sep. 22, 2011

(54) COAXIAL CABLE CONNECTOR HAVING ELECTRICAL CONTINUITY MEMBER

(75) Inventors: Jeremy Amidon, Marcellus, NY (US); Brian K. Hanson, East Syracuse, NY (US); Noah Montena, Syracuse, NY (US); Eric Purdy, Constantia, NY (US)

(73) Assignee: JOHN MEZZALINGUA ASSOCIATES, INC., East Syracuse, NY (US)

(21) Appl. No.: 13/072,350

(22) Filed: Mar. 25, 2011

Related U.S. Application Data
(63) Continuation-in-part of application No. 12/633,792, filed on Dec. 8, 2009.
(60) Provisional application No. 61/180,835, filed on May 22, 2009.

(51) Int. Cl. H01R 9/05; H01R 43/16

(52) U.S. Cl. 439/578; 29/874

(57) ABSTRACT

A coaxial cable connector comprising a connector body a post engageable with connector body, wherein the post includes a flange, a coupling member, axially rotatable with respect to the post and the connector body, the coupling member having a first end, an opposing second end portion, and an internal lip, a continuity member disposed only axially rearward of a surface of the internal lip of the coupling member that faces the flange, an outer sleeve engageable with the coupling member, the sleeve configured to rotate the coupling member, and a compression portion structurally integral with the connector body, wherein the compression portion is configured to break apart from the body when axially compressed is provided. Furthermore, an associated method is also provided.

### CROSS-REFERENCE TO RELATED APPLICATIONS

This application is a continuation-in-part of United States Non-Provisional application Ser. No. 12/633,792, filed Dec. 8, 2009, and entitled COAXIAL CABLE CONNECTOR HAVING ELECTRICAL CONTINUITY MEMBER, which claims the priority benefit of U.S. Provisional Patent Application No. 61/180,835 filed May 22, 2009, and entitled COAXIAL CABLE CONNECTOR HAVING ELECTRICAL CONTINUITY MEMBER.

### FIELD OF TECHNOLOGY

The following relates to connectors used in coaxial cable communication applications, and more specifically to coaxial connectors having electrical continuity members that extend continuity of an electromagnetic interference shield from the cable and through the connector.

### BACKGROUND

Broadband communications have become an increasingly prevalent form of electromagnetic information exchange and coaxial cables are common conduits for transmission of broadband communications. Coaxial cables are typically designed so that an electromagnetic field carrying communications signals exists only in the space between inner and outer coaxial conductors of the cables. This allows coaxial cable runs to be installed next to metal objects without the power losses that occur in other transmission lines, and provides protection of the communications signals from external electromagnetic interference. Connectors for coaxial cables are typically connected onto complementary interface ports to electrically integrate coaxial cables to various electronic devices and cable communication equipment. Connection is often made through rotatable operation of an internally threaded nut of the connector about a corresponding externally threaded interface port. Fully tightening the threaded connection of the coaxial cable connector to the interface port helps to ensure a ground connection between the connector and the corresponding interface port. However, often connectors are not properly tightened or otherwise installed to the interface port and proper electrical mating of the connector with the interface port does not occur. Moreover, typical component elements and structures of common connectors may permit loss of ground and discontinuity of the electromagnetic shielding that is intended to be extended from the cable, through the connector, and to the corresponding coaxial cable interface port. Hence a need exists for an improved connector having structural component elements included for ensuring ground continuity between the coaxial cable, the connector and its various applicable structures, and the coaxial cable connector interface port.

### SUMMARY

The invention is directed toward a first aspect of providing a coaxial cable connector comprising; a connector body; a post engageable with connector body, wherein the post includes a flange; a nut, axially rotatable with respect to the post and the connector body, the nut having a first end and an opposing second end, wherein the nut includes an internal lip, and wherein a second end portion of the nut corresponds to the portion of the nut extending from the second end of the nut to the side of the lip of the nut facing the first end of the nut at a point nearest the second end of the nut, and a first end portion of the nut corresponds to the portion of the nut extending from the first end of the nut to the same point nearest the second end of the nut of the same side of the lip facing the first end of the nut; and a continuity member disposed within the second end portion of the nut and contacting the post and the nut, so that the continuity member extends electrical grounding continuity through the post and the nut.

A second aspect of the present invention provides a coaxial cable connector comprising a connector body; a post engageable with connector body, wherein the post includes a flange; a nut, axially rotatable with respect to the post and the connector body, the nut having a first end and an opposing second end, wherein the nut includes an internal lip, and wherein a second end portion of the nut starts at a side of the lip of the nut facing the first end of the nut and extends rearward to the second end of the nut; and a continuity member disposed only rearward the start of the second end portion of the nut and contacting the post and the nut, so that the continuity member extends electrical grounding continuity through the post and the nut

A third aspect of the present invention provides a coaxial cable connector comprising a connector body; a post operably attached to the connector body, the post having a flange; a nut axially rotatable with respect to the post and the connector body, the nut including an inward lip; and an electrical continuity member disposed axially rearward of a surface of the internal lip of the nut that faces the flange.

A fourth aspect of the present invention provides a method of obtaining electrical continuity for a coaxial cable connection, the method comprising: providing a coaxial cable connector including: a connector body; a post operably attached to the connector body, the post having a flange; a nut axially rotatable with respect to the post and the connector body, the nut including an inward lip; and an electrical continuity member disposed axially rearward of a surface of the internal lip of the nut that faces the flange; securely attaching a coaxial cable to the connector so that the grounding sheath of the cable electrically contacts the post; extending electrical continuity from the post through the continuity member to the nut; and fastening the nut to a conductive interface port to complete the ground path and obtain electrical continuity in the cable connection.

A fifth general aspect relates to a coaxial cable connector comprising: a connector body; a post engageable with connector body, wherein the post includes a flange; a coupling member, axially rotatable with respect to the post and the connector body, the coupling member having a first end, an opposing second end portion, and an internal lip; a continuity member disposed only axially rearward of a surface of the internal lip of the coupling member that faces the flange; an outer sleeve engageable with the coupling member, the sleeve configured to rotate the coupling member; and a compression portion structurally integral with the connector body, wherein the compression portion is configured to break apart from the body when axially compressed.

A sixth general aspect relates to a coaxial cable connector comprising; a connector body; a post engageable with connector body, wherein the post includes a flange; a coupling member, axially rotatable with respect to the post and the connector body, the coupling member having a first end, an opposing second end portion, and an internal lip; a continuity member disposed only axially rearward of a surface of the internal lip of the coupling member that faces the flange; and an outer sleeve engageable with the coupling member, the sleeve configured to rotate the coupling member.

A seventh general aspect relates to a coaxial cable connector comprising; a connector body; a post engageable with connector body, wherein the post includes a flange; a coupling member, axially rotatable with respect to the post and the connector body, the coupling member having a first end, an opposing second end portion, and an internal lip; a continuity member disposed only axially rearward of a surface of the internal lip of the coupling member that faces the flange; and a compression portion structurally integral with the connector body, wherein the compression portion is configured to break apart from the body when axially compressed.

An eighth general aspect relates to a method of obtaining electrical continuity for a coaxial cable connection, the method comprising: providing a coaxial cable connector including: a connector body; a post operably attached to the connector body, the post having a flange; a coupling member axially rotatable with respect to the post and the connector body, the coupling member including a lip; a continuity member located between the post and the coupling member; an outer sleeve engageable with the coupling member; and a compression portion structurally integral with the connector body, wherein the compression portion is configured to break apart from the body when axially compressed; securely attaching a coaxial cable to the connector so that the grounding shield of the cable electrically contacts the post, by axially compressing the compression portion so that the compression portion breaks away from the body and securely connects to the coaxial cable; extending electrical continuity from the post through the continuity member to the coupling member; and fastening the coupling member to a conductive interface port to complete the ground path and obtain electrical continuity in the cable connection.

The foregoing and other features of construction and operation of the invention will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts an exploded perspective cut-away view of an embodiment of the elements of an embodiment of a coaxial cable connector having an embodiment of an electrical continuity member;

FIG. 2 depicts a perspective view of an embodiment of the electrical continuity member depicted in FIG. 1;

FIG. 3 depicts a perspective view of a variation of the embodiment of the electrical continuity member depicted in FIG. 1, without a flange cutout;

FIG. 4 depicts a perspective view of a variation of the embodiment of the electrical continuity member depicted in FIG. 1, without a flange cutout or a through-slit;

FIG. 5 depicts a perspective cut-away view of a portion of the embodiment of a coaxial cable connector having an electrical continuity member of FIG. 1, as assembled;

FIG. 6 depicts a perspective cut-away view of a portion of an assembled embodiment of a coaxial cable connector having an electrical continuity member and a shortened nut;

FIG. 7 depicts a perspective cut-away view of a portion of an assembled embodiment of a coaxial cable connector having an electrical continuity member that does not touch the connector body;

FIG. 8 depicts a perspective view of another embodiment of an electrical continuity member;

FIG. 9 depicts a perspective cut-away view of a portion of an assembled embodiment of a coaxial cable connector having the electrical continuity member of FIG. 8;

FIG. 10 depicts a perspective view of a further embodiment of an electrical continuity member;

FIG. 11 depicts a perspective cut-away view of a portion of an assembled embodiment of a coaxial cable connector having the electrical continuity member of FIG. 10;

FIG. 12 depicts a perspective view of still another embodiment of an electrical continuity member;

FIG. 13 depicts a perspective cut-away view of a portion of an assembled embodiment of a coaxial cable connector having the electrical continuity member of FIG. 12;

FIG. 14 depicts a perspective view of a still further embodiment of an electrical continuity member;

FIG. 15 depicts a perspective cut-away view of a portion of an assembled embodiment of a coaxial cable connector having the electrical continuity member of FIG. 14;

FIG. 16 depicts a perspective view of even another embodiment of an electrical continuity member;

FIG. 17 depicts a perspective cut-away view of a portion of an assembled embodiment of a coaxial cable connector having the electrical continuity member of FIG. 16;

FIG. 18 depicts a perspective view of still even a further embodiment of an electrical continuity member;

FIG. 19 depicts a perspective cut-away view of a portion of an assembled embodiment of a coaxial cable connector having the electrical continuity member of FIG. 18;

FIG. 20 depicts a perspective cut-away view of an embodiment of a coaxial cable connector including an electrical continuity member and having an attached coaxial cable, the connector mated to an interface port;

FIG. 21 depicts a perspective cut-away view of an embodiment of a coaxial cable connector having still even another embodiment of an electrical continuity member;

FIG. 22 depicts a perspective view of the embodiment of the electrical continuity member depicted in FIG. 21;

FIG. 23 an exploded perspective view of the embodiment of the coaxial cable connector of FIG. 21;

FIG. 24 depicts a perspective cut-away view of another embodiment of a coaxial cable connector having the embodiment of the electrical continuity member depicted in FIG. 22;

FIG. 25 depicts an exploded perspective view of the embodiment of the coaxial cable connector of FIG. 24;

FIG. 26 depicts a perspective view of still further even another embodiment of an electrical continuity member;

FIG. 27 depicts a perspective view of another embodiment of an electrical continuity member;

FIG. 28 depicts a perspective view of an embodiment of an electrical continuity depicted in FIG. 27, yet comprising a completely annular post contact portion with no through-slit;

FIG. 29 depicts a perspective cut-away view of another embodiment of a coaxial cable connector operably having either of the embodiments of the electrical continuity member depicted in FIG. 27 or 28;

FIG. 30 depicts a perspective cut-away view of the embodiment of a coaxial cable connector of FIG. 29, wherein a cable is attached to the connector;

FIG. 31 depicts a side cross-section view of the embodiment of a coaxial cable connector of FIG. 29;

FIG. 32 depicts a perspective cut-away view of the embodiment of a coaxial cable connector of FIG. 29, wherein a cable is attached to the connector;

FIG. 33 depicts a perspective view of yet another embodiment of an electrical continuity member;

FIG. 34 depicts a side view of the embodiment of an electrical continuity member depicted in FIG. 33;

FIG. 35 depicts a perspective view of the embodiment of an electrical continuity member depicted in FIG. 33, wherein nut contact portions are bent;

FIG. 36 depicts a side view of the embodiment of an electrical continuity member depicted in FIG. 33, wherein nut contact portions are bent;

FIG. 37 depicts a perspective cut-away view of a portion of a further embodiment of a coaxial cable connector having the embodiment of the electrical continuity member depicted in FIG. 33;

FIG. 38 depicts a cut-away side view of a portion of the further embodiment of a coaxial cable connector depicted in FIG. 37 and having the embodiment of the electrical continuity member depicted in FIG. 33;

FIG. 39 depicts an exploded perspective cut-away view of another embodiment of the elements of an embodiment of a coaxial cable connector having an embodiment of an electrical continuity member;

FIG. 40 depicts a side perspective cut-away view of the other embodiment of the coaxial cable connector of FIG. 39;

FIG. 41 depicts a blown-up side perspective cut-away view of a portion of the other embodiment of the coaxial cable connector of FIG. 39;

FIG. 42 depicts a front cross-section view, at the location between the first end portion of the nut and the second end portion of the nut, of the other embodiment of the coaxial cable connector of FIG. 39;

FIG. 43 depicts a front perspective view of yet still another embodiment of an electrical continuity member;

FIG. 44 depicts another front perspective view of the embodiment of the electrical continuity member depicted in FIG. 43;

FIG. 45 depicts a front view of the embodiment of the electrical continuity member depicted in FIG. 43;

FIG. 46 depicts a side view of the embodiment of the electrical continuity member depicted in FIG. 43;

FIG. 47 depicts a rear perspective view of the embodiment of the electrical continuity member depicted in FIG. 43;

FIG. 48 depicts an exploded perspective cut-away view of a yet still other embodiment of the coaxial cable connector having the embodiment of the yet still other electrical continuity member depicted in FIG. 43;

FIG. 49 depicts a perspective cut-away view of a the yet still other embodiment of a coaxial cable connector depicted in FIG. 48 and having the embodiment of the yet still other electrical continuity member depicted in FIG. 43;

FIG. 50 depicts a blown-up perspective cut-away view of a portion of the yet still other embodiment of a coaxial cable connector depicted in FIG. 48 and having the embodiment of the yet still other electrical continuity member depicted in FIG. 43;

FIG. 51 depicts a perspective view of the embodiment of an electrical continuity member depicted in FIG. 43, yet without nut contact tabs;

FIG. 52 depicts a side view of the embodiment of the electrical continuity member depicted in FIG. 51;

FIG. 53 depicts a perspective cut-away view of a portion of an embodiment of a coaxial cable connector having the embodiment of the electrical continuity member depicted in FIG. 51;

FIG. 54A depicts a cross-section view of a first embodiment of a coaxial cable connector including an embodiment of a continuity member, an embodiment of a sleeve, an embodiment of a compression portion, and an embodiment of a radial restriction member;

FIG. 54B depicts a perspective view of an embodiment of a sleeve and an embodiment of a coupling member;

FIG. 54C depicts a cross-section view of an embodiment of a compression portion in a compressed position;

FIG. 54D depicts a perspective view of an embodiment of a coaxial cable connector having an embodiment of a radial restriction member with an embodiment of one or more gripping features;

FIG. 55 depicts a cross-section view of a second embodiment of a coaxial cable connector including an embodiment of a continuity member, an embodiment of a sleeve, an embodiment of a compression portion, and an embodiment of a radial restriction member;

FIG. 56A depicts a cross-section view of a third embodiment of a coaxial cable connector including an embodiment of a continuity member, an embodiment of a sleeve, an embodiment of a compression portion, and an embodiment of a radial restriction member;

FIG. 56B depicts a perspective view of the third embodiment of the coaxial cable connector, as depicted in FIG. 56;

FIG. 57A depicts a cross-section view of a fourth embodiment of a coaxial cable connector including an embodiment of a continuity member, an embodiment of a sleeve, an embodiment of a compression portion, and an embodiment of a radial restriction member

FIG. 57B depicts a perspective view of an embodiment of a sleeve and an embodiment of a coupling member;

FIG. 58 depicts a cross-section view of a fifth embodiment of a coaxial cable connector including an embodiment of a continuity member, an embodiment of a sleeve, an embodiment of a compression portion, and an embodiment of a radial restriction member;

FIG. 59 depicts a cross-section view of a sixth embodiment of a coaxial cable connector including an embodiment of a continuity member, an embodiment of a sleeve, an embodiment of a compression portion, and an embodiment of a radial restriction member;

FIG. 60 depicts a cross-section view of a seventh embodiment of a coaxial cable connector including an embodiment of a continuity member, an embodiment of a sleeve, an embodiment of a compression portion, and an embodiment of a radial restriction member;

FIG. 61 depicts a cross-section view of a eighth embodiment of a coaxial cable connector including an embodiment of a continuity member, an embodiment of a sleeve, an embodiment of a compression portion, and an embodiment of a radial restriction member;

FIG. 62 depicts a cross-section view of a ninth embodiment of a coaxial cable connector including an embodiment of a continuity member, an embodiment of a sleeve, an embodiment of a compression portion, and an embodiment of a radial restriction member;

FIG. 63 depicts a cross-section view of a tenth embodiment of a coaxial cable connector including an embodiment of a continuity member, an embodiment of a sleeve, an embodiment of a compression portion, and an embodiment of a radial restriction member;

FIG. 64 depicts a cross-section view of a eleventh embodiment of a coaxial cable connector including an embodiment of a continuity member, an embodiment of a sleeve, an embodiment of a compression portion, and an embodiment of a radial restriction member;

FIG. 65 depicts a cross-section view of a twelfth embodiment of a coaxial cable connector including an embodiment of a continuity member, an embodiment of a sleeve, an embodiment of a compression portion, and an embodiment of a radial restriction member;

FIG. 66 depicts a cross-section view of a thirteenth embodiment of a coaxial cable connector including an embodiment of a continuity member, an embodiment of a sleeve, an embodiment of a compression portion, and an embodiment of a radial restriction member;

FIG. 67 depicts a cross-section view of a fourteenth embodiment of a coaxial cable connector including an embodiment of a continuity member, an embodiment of a sleeve, an embodiment of a compression portion, and an embodiment of a radial restriction member;

FIG. 68 depicts a cross-section view of a fifteenth embodiment of a coaxial cable connector including an embodiment of a continuity member, an embodiment of a sleeve, an embodiment of a compression portion, and an embodiment of a radial restriction member;

FIG. 69 depicts a cross-section view of a sixteenth embodiment of a coaxial cable connector including an embodiment of a continuity member, an embodiment of a sleeve, an embodiment of a compression portion, and an embodiment of a radial restriction member;

FIG. 70 depicts a cross-section view of a seventeenth embodiment of a coaxial cable connector including an embodiment of a continuity member, an embodiment of a sleeve, an embodiment of a compression portion, and an embodiment of a radial restriction member;

FIG. 71 depicts a cross-section view of a eighteenth embodiment of a coaxial cable connector including an embodiment of a continuity member, an embodiment of a sleeve, an embodiment of a compression portion, and an embodiment of a radial restriction member;

FIG. 72 depicts a cross-section view of a nineteenth embodiment of a coaxial cable connector including an embodiment of a continuity member, an embodiment of a sleeve, an embodiment of a compression portion, and an embodiment of a radial restriction member;

FIG. 73 depicts a cross-section view of a twentieth embodiment of a coaxial cable connector including an embodiment of a continuity member, an embodiment of a sleeve, an embodiment of a compression portion, and an embodiment of a radial restriction member;

FIG. 74 depicts a cross-section view of a twenty-first embodiment of a coaxial cable connector including an embodiment of a continuity member, an embodiment of a sleeve, an embodiment of a compression portion, and an embodiment of a radial restriction member;

FIG. 75 depicts a cross-section view of a twenty-second embodiment of a coaxial cable connector including an embodiment of a continuity member, an embodiment of a sleeve, an embodiment of a compression portion, and an embodiment of a radial restriction member;

FIG. 76 depicts a cross-section view of a twenty third embodiment of a coaxial cable connector including an embodiment of a continuity member, an embodiment of a sleeve, an embodiment of a compression portion, and an embodiment of a radial restriction member;

FIG. 77 depicts a cross-section view of a twenty-fourth embodiment of a coaxial cable connector including an embodiment of a continuity member, an embodiment of a sleeve, an embodiment of a compression portion, and an embodiment of a radial restriction member;

FIG. 78 depicts a cross-section view of a first embodiment of a coaxial cable connector including an embodiment of a continuity member and an embodiment of a sleeve;

FIG. 79 depicts a cross-section view of a second embodiment of a coaxial cable connector including an embodiment of a continuity member and an embodiment of a sleeve;

FIG. 80 depicts a cross-section view of a third embodiment of a coaxial cable connector including an embodiment of a continuity member and an embodiment of a sleeve;

FIG. 81 depicts a cross-section view of a fourth embodiment of a coaxial cable connector including an embodiment of a continuity member and an embodiment of a sleeve;

FIG. 82 depicts a cross-section view of a fifth embodiment of a coaxial cable connector including an embodiment of a continuity member and an embodiment of a sleeve;

FIG. 83 depicts a cross-section view of a sixth embodiment of a coaxial cable connector including an embodiment of a continuity member and an embodiment of a sleeve;

FIG. 84 depicts a cross-section view of a seventh embodiment of a coaxial cable connector including an embodiment of a continuity member and an embodiment of a sleeve;

FIG. 85 depicts a cross-section view of a eighth embodiment of a coaxial cable connector including an embodiment of a continuity member and an embodiment of a sleeve;

FIG. 86 depicts a cross-section view of a ninth embodiment of a coaxial cable connector including an embodiment of a continuity member and an embodiment of a sleeve;

FIG. 87 depicts a cross-section view of a tenth embodiment of a coaxial cable connector including an embodiment of a continuity member and an embodiment of a sleeve;

FIG. 88 depicts a cross-section view of an eleventh embodiment of a coaxial cable connector including an embodiment of a continuity member and an embodiment of a sleeve;

FIG. 89 depicts a cross-section view of a twelfth embodiment of a coaxial cable connector including an embodiment of a continuity member and an embodiment of a sleeve;

FIG. 90 depicts a cross-section view of a thirteenth embodiment of a coaxial cable connector including an embodiment of a continuity member and an embodiment of a sleeve;

FIG. 91 depicts a cross-section view of a fourteenth embodiment of a coaxial cable connector including an embodiment of a continuity member and an embodiment of a sleeve;

FIG. 92 depicts a cross-section view of a fifteenth embodiment of a coaxial cable connector including an embodiment of a continuity member and an embodiment of a sleeve;

FIG. 93 depicts a cross-section view of a sixteenth embodiment of a coaxial cable connector including an embodiment of a continuity member and an embodiment of a sleeve;

FIG. 94 depicts a cross-section view of a first embodiment of a coaxial cable connector including an embodiment of a continuity member, an embodiment of a compression portion, and an embodiment of a radial restriction member;

FIG. 95 depicts a cross-section view of a second embodiment of a coaxial cable connector including an embodiment of a continuity member, an embodiment of a compression portion, and an embodiment of a radial restriction member;

FIG. 96 depicts a cross-section view of a third embodiment of a coaxial cable connector including an embodiment of a continuity member, an embodiment of a compression portion, and an embodiment of a radial restriction member;

FIG. 97 depicts a cross-section view of a fourth embodiment of a coaxial cable connector including an embodiment of a continuity member, an embodiment of a compression portion, and an embodiment of a radial restriction member;

FIG. 98A depicts a cross-section view of a fifth embodiment of a coaxial cable connector including an embodiment of a continuity member, an embodiment of a compression portion, and an embodiment of a radial restriction member;

FIG. 98B depicts a perspective cut-away view of the fifth embodiment of a coaxial cable connector, as depicted in FIG. 98A;

FIG. 98C depicts an exploded view of the fifth embodiment of a coaxial cable connector, as depicted in FIG. 98A;

FIG. 98D depicts a perspective view of the fifth embodiment of a coaxial cable connector, as depicted in FIG. 98A;

FIG. 99 depicts a cross-section view of a sixth embodiment of a coaxial cable connector including an embodiment of a continuity member, an embodiment of a compression portion, and an embodiment of a radial restriction member;

FIG. 100 depicts a cross-section view of a seventh embodiment of a coaxial cable connector including an embodiment of a continuity member, an embodiment of a compression portion, and an embodiment of a radial restriction member;

FIG. 101 depicts a cross-section view of an eighth embodiment of a coaxial cable connector including an embodiment of a continuity member, an embodiment of a compression portion, and an embodiment of a radial restriction member;

FIG. 102 depicts a cross-section view of a ninth embodiment of a coaxial cable connector including an embodiment of a continuity member, an embodiment of a compression portion, and an embodiment of a radial restriction member;

FIG. 103 depicts a cross-section view of a first embodiment of a coaxial cable connector including an embodiment of a continuity member, an embodiment of a compression portion, and an embodiment of a sleeve;

FIG. 104 depicts a cross-section view of a second embodiment of a coaxial cable connector including an embodiment of a continuity member, an embodiment of a compression portion, and an embodiment of a sleeve;

FIG. 105 depicts a cross-section view of a second embodiment of a coaxial cable connector including an embodiment of a continuity member, an embodiment of a compression portion, and an embodiment of a sleeve;

FIG. 106A depicts a cross-section view of a third embodiment of a coaxial cable connector including an embodiment of a continuity member, an embodiment of a compression portion, and an embodiment of a sleeve;

FIG. 106B depicts a perspective view of the third embodiment of a coaxial cable connector including an embodiment of a continuity member, an embodiment of a compression portion, and an embodiment of a sleeve;

FIG. 107 depicts a cross-section view of a fourth embodiment of a coaxial cable connector including an embodiment of a continuity member, an embodiment of a compression portion, and an embodiment of a sleeve;

FIG. 108A depicts a cross-section view of a first embodiment of a coaxial cable connector including an embodiment of a continuity member, a first embodiment of a compression portion, and an embodiment of a sleeve;

FIG. 108B depicts a cross-section view of a first embodiment of a coaxial cable connector including an embodiment of a continuity member, a second embodiment of a compression portion, and an embodiment of a sleeve;

FIG. 109 depicts a cross-section view of the first embodiment of a coaxial cable connector including an embodiment of a continuity member, an embodiment of a compression portion, and an embodiment of a sleeve, in a compressed position;

FIG. 110 depicts a cross-section view of the first embodiment of a coaxial cable connector including an embodiment of a continuity member, an embodiment of a compression portion, and an embodiment of a sleeve, in a compressed position on a coaxial cable;

FIG. 111A depicts a cross-section view of an embodiment of a coaxial cable connector including an embodiment of a continuity member and a first embodiment of a compression portion;

FIG. 111B depicts a cross-section view of an embodiment of a coaxial cable connector including an embodiment of a continuity member and a second embodiment of a compression portion;

FIG. 112 depicts a cross-section view of the first embodiment of a coaxial cable connector including an embodiment of a continuity member and an embodiment of a compression portion, in a compressed position

FIG. 113 depicts a cross-section view of the first embodiment of a coaxial cable connector including an embodiment of a continuity member and an embodiment of a compression portion, in a compressed position on a coaxial cable;

FIG. 114 depicts a cross-section view of a coaxial cable connector including an outer sleeve, a continuity member and an alternate embodiment of a connector body; and

FIG. 115 depicts a cross-section view of a first embodiment of a coaxial cable connector including an embodiment of a continuity member, an embodiment of a compression portion, an embodiment of a connector body with internal threads, and an embodiment of a sleeve.

### DETAILED DESCRIPTION

Although certain embodiments of the present invention are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

As a preface to the detailed description, it should be noted that, as used in this specification and the appended claims, the singular forms “a”, “an” and “the” include plural referents, unless the context clearly dictates otherwise.

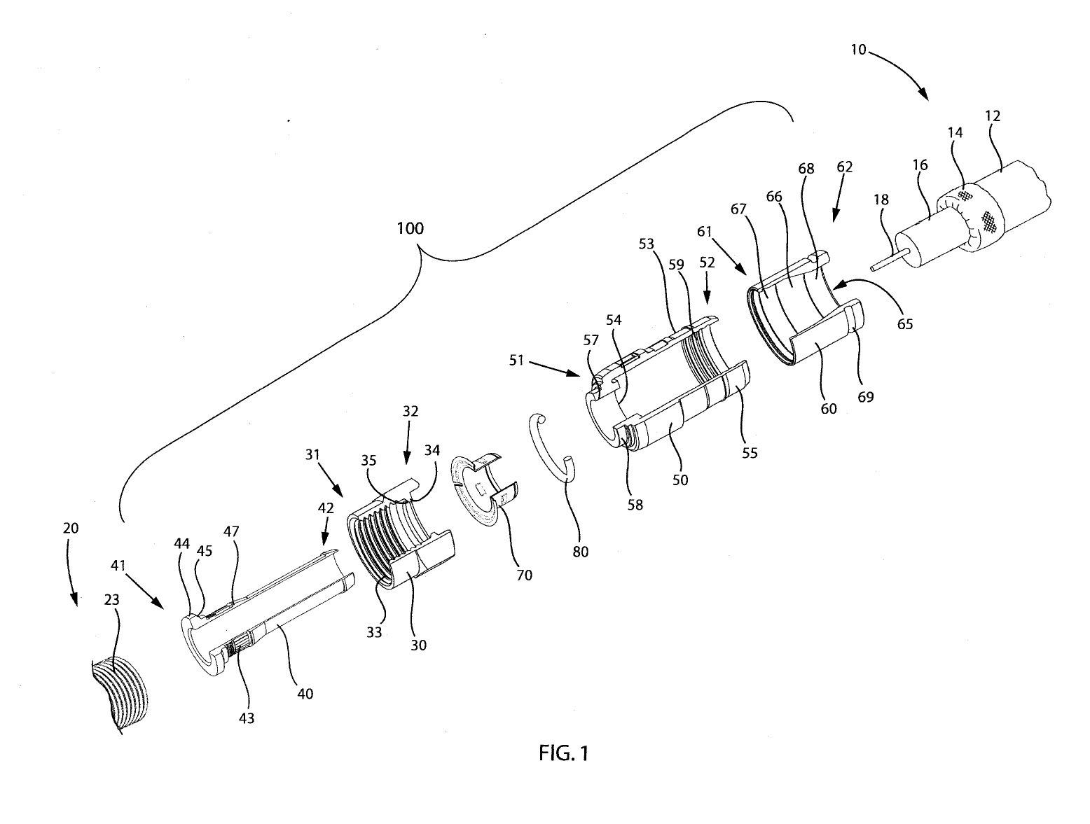

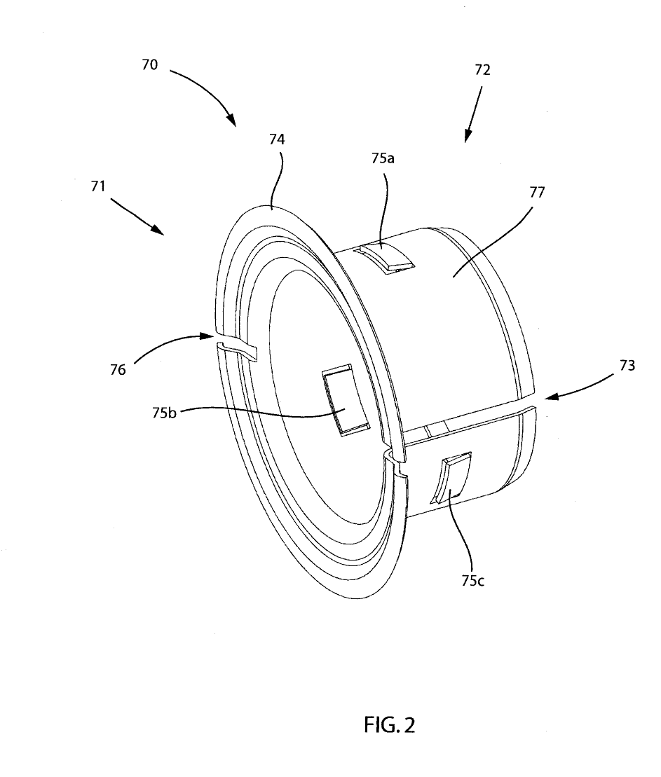

Referring to the drawings, FIG. 1 depicts one embodiment of a coaxial cable connector 100 having an embodiment of an electrical continuity member 70. The coaxial cable connector 100 may be operably affixed, or otherwise functionally attached, to a coaxial cable 10 having a protective outer jacket 12, a conductive grounding shield 14, an interior dielectric 16 and a center conductor 18. The coaxial cable 10 may be prepared as embodied in FIG. 1 by removing the protective outer jacket 12 and drawing back the conductive grounding shield 14 to expose a portion of the interior dielectric 16. Further preparation of the embodied coaxial cable 10 may include stripping the dielectric 16 to expose a portion of the center conductor 18. The protective outer jacket 12 is intended to protect the various components of the coaxial cable 10 from damage which may result from exposure to dirt or moisture and from corrosion. Moreover, the protective outer jacket 12 may serve in some measure to secure the various components of the coaxial cable 10 in a contained cable design that protects the cable 10 from damage related to movement during cable installation. The conductive grounding shield 14 may be comprised of conductive materials suitable for providing an electrical ground connection, such as cuprous braided material, aluminum foils, thin metallic elements, or other like structures. Various embodiments of the shield 14 may be employed to screen unwanted noise. For instance, the shield 14 may comprise a metal foil wrapped around the dielectric 16, or several conductive strands formed in a continuous braid around the dielectric 16. Combinations of foil and/or braided strands may be utilized wherein the conductive shield 14 may comprise a foil layer, then a braided layer, and then a foil layer. Those in the art will appreciate that various layer combinations may be implemented in order for the conductive grounding shield 14 to effectuate an electromagnetic buffer helping to prevent ingress of environmental noise that may disrupt broadband communications. The dielectric 16 may be comprised of materials suitable for electrical insulation, such as plastic foam material, paper materials, rubber-like polymers, or other functional insulating materials. It should be noted that the various materials of which all the various components of the coaxial cable 10 are comprised should have some degree of elasticity allowing the cable 10 to flex or bend in accordance with traditional broadband communication standards, installation methods and/or equipment. It should further be recognized that the radial thickness of the coaxial cable 10, protective outer jacket 12, conductive grounding shield 14, interior dielectric 16 and/or center conductor 18 may vary based upon generally recognized parameters corresponding to broadband communication standards and/or equipment.

Referring further to FIG. 1, the connector 100 may also include a coaxial cable interface port 20. The coaxial cable interface port 20 includes a conductive receptacle for receiving a portion of a coaxial cable center conductor 18 sufficient to make adequate electrical contact. The coaxial cable interface port 20 may further comprise a threaded exterior surface 23. It should be recognized that the radial thickness and/or the length of the coaxial cable interface port 20 and/or the conductive receptacle of the port 20 may vary based upon generally recognized parameters corresponding to broadband communication standards and/or equipment. Moreover, the pitch and height of threads which may be formed upon the threaded exterior surface 23 of the coaxial cable interface port 20 may also vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials corresponding to the port's 20 operable electrical interface with a connector 100. However, the receptacle of the port 20 should be formed of a conductive material, such as a metal, like brass, copper, or aluminum. Further still, it will be understood by those of ordinary skill that the interface port 20 may be embodied by a connective interface component of a coaxial cable communications device, a television, a modem, a computer port, a network receiver, or other communications modifying devices such as a signal splitter, a cable line extender, a cable network module and/or the like.

Referring still further to FIG. 1, an embodiment of a coaxial cable connector 100 may further comprise a threaded nut 30, a post 40, a connector body 50, a fastener member 60, a continuity member 70 formed of conductive material, and a connector body sealing member 80, such as, for example, a body O-ring configured to fit around a portion of the connector body 50.

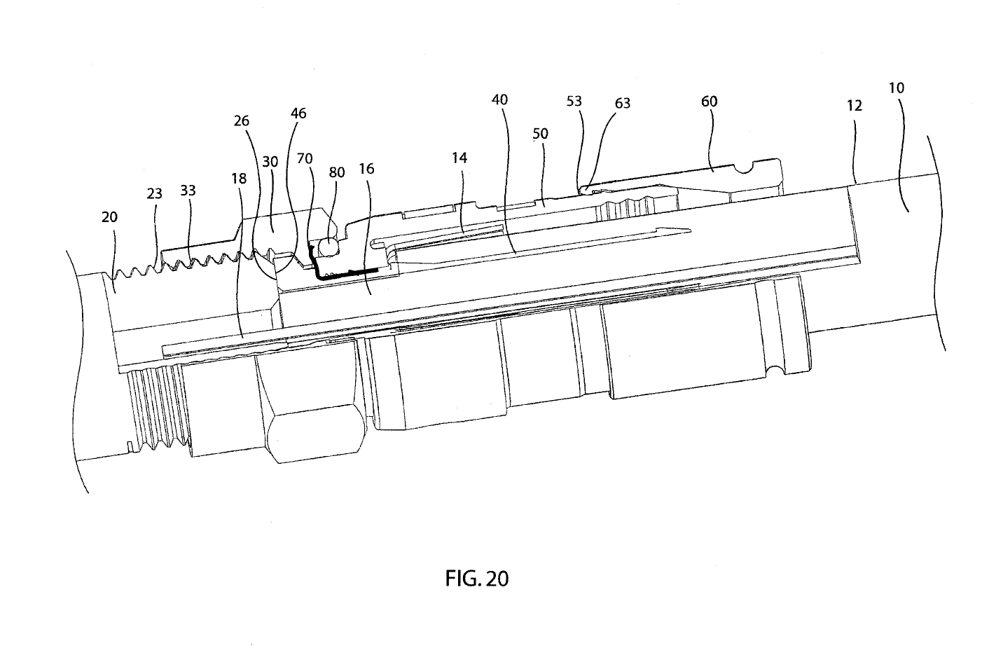

The threaded nut 30 of embodiments of a coaxial cable connector 100 has a first forward end 31 and opposing second rearward end 32. The threaded nut 30 may comprise internal threading 33 extending axially from the edge of first forward end 31a distance sufficient to provide operably effective threadable contact with the external threads 23 of a standard coaxial cable interface port 20 (as shown, by way of example, in FIG. 20). The threaded nut 30 includes an internal lip 34, such as an annular protrusion, located proximate the second rearward end 32 of the nut. The internal lip 34 includes a surface 35 facing the first forward end 31 of the nut 30. The forward facing surface 35 of the lip 34 may be a tapered surface or side facing the first forward end 31 of the nut 30. The structural configuration of the nut 30 may vary according differing connector design parameters to accommodate different functionality of a coaxial cable connector 100. For instance, the first forward end 31 of the nut 30 may include internal and/or external structures such as ridges, grooves, curves, detents, slots, openings, chamfers, or other structural features, etc., which may facilitate the operable joining of an environmental sealing member, such a water-tight seal or other attachable component element, that may help prevent ingress of environmental contaminants, such as moisture, oils, and dirt, at the first forward end 31 of a nut 30, when mated with an interface port 20. Moreover, the second rearward end 32, of the nut 30 may extend a significant axial distance to reside radially extent, or otherwise partially surround, a portion of the connector body 50, although the extended portion of the nut 30 need not contact the connector body 50. Those in the art should appreciate that the nut need not be threaded. Moreover, the nut may comprise a coupler commonly used in connecting RCA-type, or BNC-type connectors, or other common coaxial cable connectors having standard coupler interfaces. The threaded nut 30 may be formed of conductive materials, such as copper, brass, aluminum, or other metals or metal alloys, facilitating grounding through the nut 30. Accordingly, the nut 30 may be configured to extend an electromagnetic buffer by electrically contacting conductive surfaces of an interface port 20 when a connector 100 is advanced onto the port 20. In addition, the threaded nut 30 may be formed of both conductive and non-conductive materials. For example the external surface of the nut 30 may be formed of a polymer, while the remainder of the nut 30 may be comprised of a metal or other conductive material. The threaded nut 30 may be formed of metals or polymers or other materials that would facilitate a rigidly formed nut body. Manufacture of the threaded nut 30 may include casting, extruding, cutting, knurling, turning, tapping, drilling, injection molding, blow molding, combinations thereof, or other fabrication methods that may provide efficient production of the component. The forward facing surface 35 of the nut 30 faces a flange 44 the post 40 when operably assembled in a connector 100, so as to allow the nut to rotate with respect to the other component elements, such as the post 40 and the connector body 50, of the connector 100.

Referring still to FIG. 1, an embodiment of a connector 100 may include a post 40. The post 40 comprises a first forward end 41 and an opposing second rearward end 42. Furthermore, the post 40 may comprise a flange 44, such as an externally extending annular protrusion, located at the first end 41 of the post 40. The flange 44 includes a rearward facing surface 45 that faces the forward facing surface 35 of the nut 30, when operably assembled in a coaxial cable connector 100, so as to allow the nut to rotate with respect to the other component elements, such as the post 40 and the connector body 50, of the connector 100. The rearward facing surface 45 of flange 44 may be a tapered surface facing the second rearward end 42 of the post 40. Further still, an embodiment of the post 40 may include a surface feature 47 such as a lip or protrusion that may engage a portion of a connector body 50 to secure axial movement of the post 40 relative to the connector body 50. However, the post need not include such a surface feature 47, and the coaxial cable connector 100 may rely on press-fitting and friction-fitting forces and/or other component structures having features and geometries to help retain the post 40 in secure location both axially and rotationally relative to the connector body 50. The location proximate or near where the connector body is secured relative to the post 40 may include surface features 43, such as ridges, grooves, protrusions, or knurling, which may enhance the secure attachment and locating of the post 40 with respect to the connector body 50. Moreover, the portion of the post 40 that contacts embodiments of a continuity member 70 may be of a different diameter than a portion of the nut 30 that contacts the connector body 50. Such diameter variance may facilitate assembly processes. For instance, various components having larger or smaller diameters can be readily press-fit or otherwise secured into connection with each other. Additionally, the post 40 may include a mating edge 46, which may be configured to make physical and electrical contact with a corresponding mating edge 26 of an interface port 20 (as shown in exemplary fashion in FIG. 20). The post 40 should be formed such that portions of a prepared coaxial cable 10 including the dielectric 16 and center conductor 18 (examples shown in FIGS. 1 and 20) may pass axially into the second end 42 and/or through a portion of the tube-like body of the post 40. Moreover, the post 40 should be dimensioned, or otherwise sized, such that the post 40 may be inserted into an end of the prepared coaxial cable 10, around the dielectric 16 and under the protective outer jacket 12 and conductive grounding shield 14. Accordingly, where an embodiment of the post 40 may be inserted into an end of the prepared coaxial cable 10 under the drawn back conductive grounding shield 14, substantial physical and/or electrical contact with the shield 14 may be accomplished thereby facilitating grounding through the post 40. The post 40 should be conductive and may be formed of metals or may be formed of other conductive materials that would facilitate a rigidly formed post body. In addition, the post may be formed of a combination of both conductive and non-conductive materials. For example, a metal coating or layer may be applied to a polymer of other non-conductive material. Manufacture of the post 40 may include casting, extruding, cutting, turning, drilling, knurling, injection molding, spraying, blow molding, component overmolding, combinations thereof, or other fabrication methods that may provide efficient production of the component.

Embodiments of a coaxial cable connector, such as connector 100, may include a connector body 50. The connector body 50 may comprise a first end 51 and opposing second end 52. Moreover, the connector body may include a post mounting portion 57 proximate or otherwise near the first end 51 of the body 50, the post mounting portion 57 configured to securely locate the body 50 relative to a portion of the outer surface of post 40, so that the connector body 50 is axially secured with respect to the post 40, in a manner that prevents the two components from moving with respect to each other in a direction parallel to the axis of the connector 100. The internal surface of the post mounting portion 57 may include an engagement feature 54 that facilitates the secure location of a continuity member 70 with respect to the connector body 50 and/or the post 40, by physically engaging the continuity member 70 when assembled within the connector 100. The engagement feature 54 may simply be an annular detent or ridge having a different diameter than the rest of the post mounting portion 57. However other features such as grooves, ridges, protrusions, slots, holes, keyways, bumps, nubs, dimples, crests, rims, or other like structural features may be included to facilitate or possibly assist the positional retention of embodiments of electrical continuity member 70 with respect to the connector body 50. Nevertheless, embodiments of a continuity member 70 may also reside in a secure position with respect to the connector body 50 simply through press-fitting and friction-fitting forces engendered by corresponding tolerances, when the various coaxial cable connector 100 components are operably assembled, or otherwise physically aligned and attached together. In addition, the connector body 50 may include an outer annular recess 58 located proximate or near the first end 51 of the connector body 50. Furthermore, the connector body 50 may include a semi-rigid, yet compliant outer surface 55, wherein the outer surface 55 may be configured to form an annular seal when the second end 52 is deformably compressed against a received coaxial cable 10 by operation of a fastener member 60. The connector body 50 may include an external annular detent 53 located proximate or close to the second end 52 of the connector body 50. Further still, the connector body 50 may include internal surface features 59, such as annular serrations formed near or proximate the internal surface of the second end 52 of the connector body 50 and configured to enhance frictional restraint and gripping of an inserted and received coaxial cable 10, through tooth-like interaction with the cable. The connector body 50 may be formed of materials such as plastics, polymers, bendable metals or composite materials that facilitate a semi-rigid, yet compliant outer surface 55. Further, the connector body 50 may be formed of conductive or non-conductive materials or a combination thereof. Manufacture of the connector body 50 may include casting, extruding, cutting, turning, drilling, knurling, injection molding, spraying, blow molding, component overmolding, combinations thereof, or other fabrication methods that may provide efficient production of the component.

With further reference to FIG. 1, embodiments of a coaxial cable connector 100 may include a fastener member 60. The fastener member 60 may have a first end 61 and opposing second end 62. In addition, the fastener member 60 may include an internal annular protrusion 63 (see FIG. 20) located proximate the first end 61 of the fastener member 60 and configured to mate and achieve purchase with the annular detent 53 on the outer surface 55 of connector body 50 (shown again, by way of example, in FIG. 20). Moreover, the fastener member 60 may comprise a central passageway 65 defined between the first end 61 and second end 62 and extending axially through the fastener member 60. The central passageway 65 may comprise a ramped surface 66 which may be positioned between a first opening or inner bore 67 having a first diameter positioned proximate with the first end 61 of the fastener member 60 and a second opening or inner bore 68 having a second diameter positioned proximate with the second end 62 of the fastener member 60. The ramped surface 66 may act to deformably compress the outer surface 55 of a connector body 50 when the fastener member 60 is operated to secure a coaxial cable 10. For example, the narrowing geometry will compress squeeze against the cable, when the fastener member is compressed into a tight and secured position on the connector body. Additionally, the fastener member 60 may comprise an exterior surface feature 69 positioned proximate with or close to the second end 62 of the fastener member 60. The surface feature 69 may facilitate gripping of the fastener member 60 during operation of the connector 100. Although the surface feature 69 is shown as an annular detent, it may have various shapes and sizes such as a ridge, notch, protrusion, knurling, or other friction or gripping type arrangements. The first end 61 of the fastener member 60 may extend an axial distance so that, when the fastener member 60 is compressed into sealing position on the coaxial cable 100, the fastener member 60 touches or resides substantially proximate significantly close to the nut 30. It should be recognized, by those skilled in the requisite art, that the fastener member 60 may be formed of rigid materials such as metals, hard plastics, polymers, composites and the like, and/or combinations thereof. Furthermore, the fastener member 60 may be manufactured via casting, extruding, cutting, turning, drilling, knurling, injection molding, spraying, blow molding, component overmolding, combinations thereof, or other fabrication methods that may provide efficient production of the component.

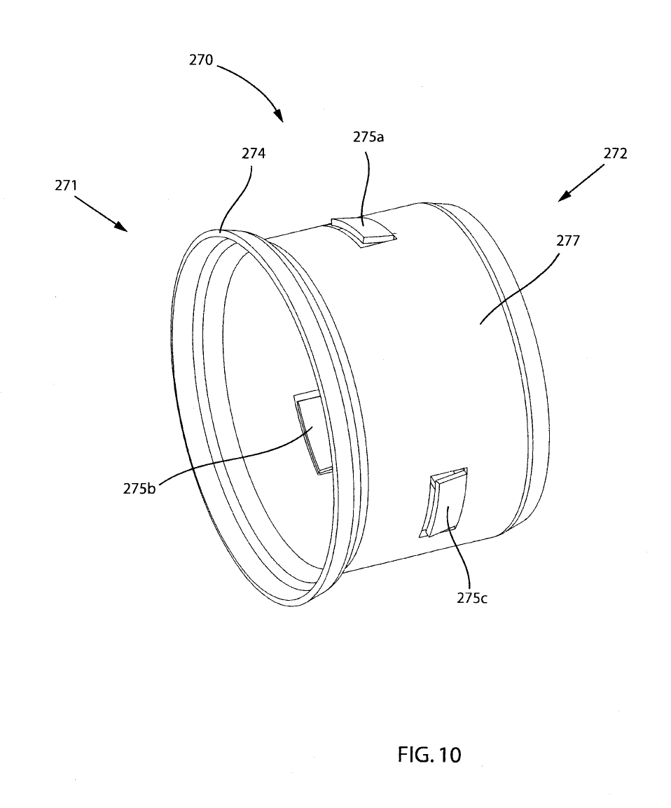

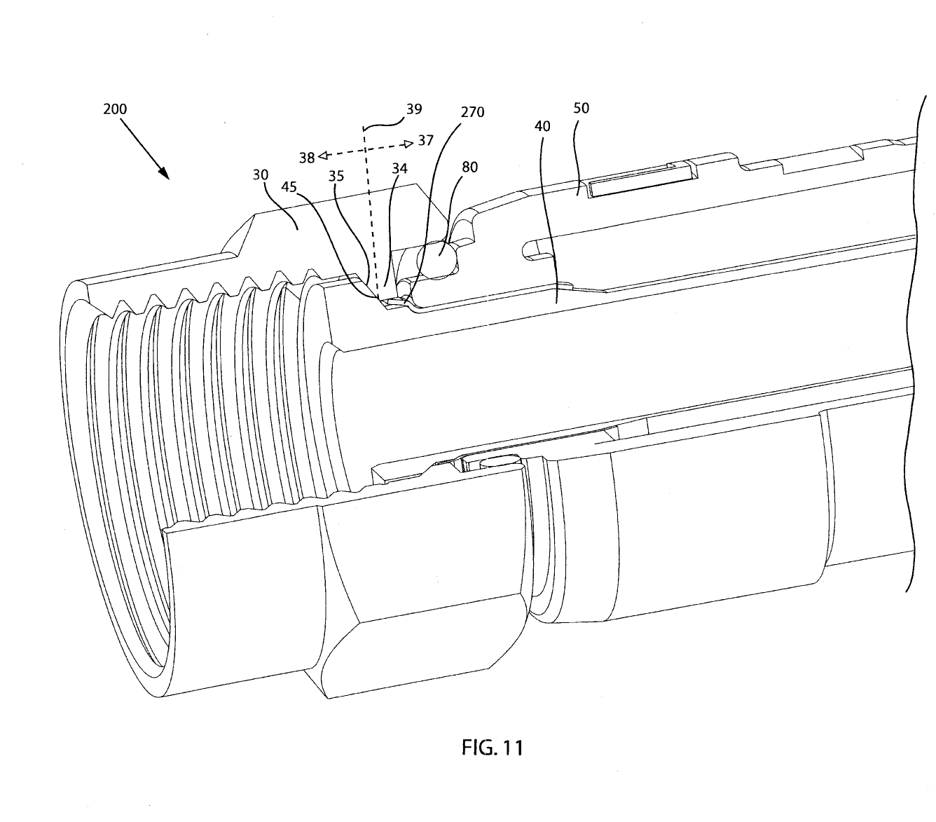

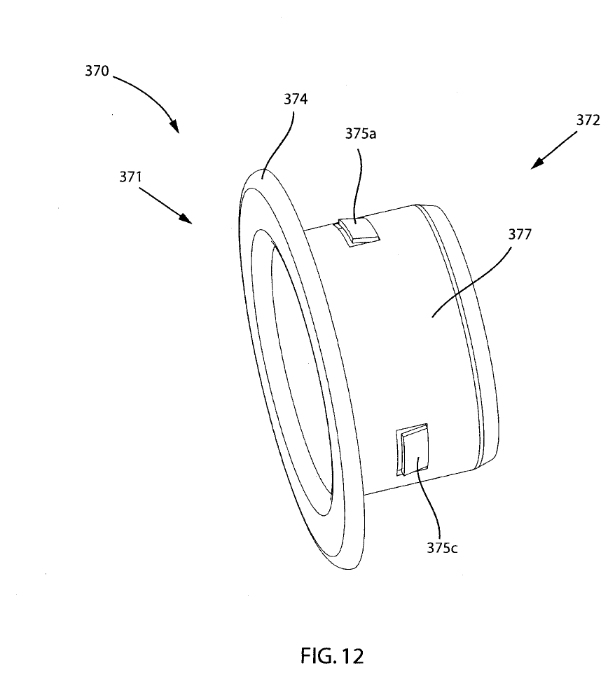

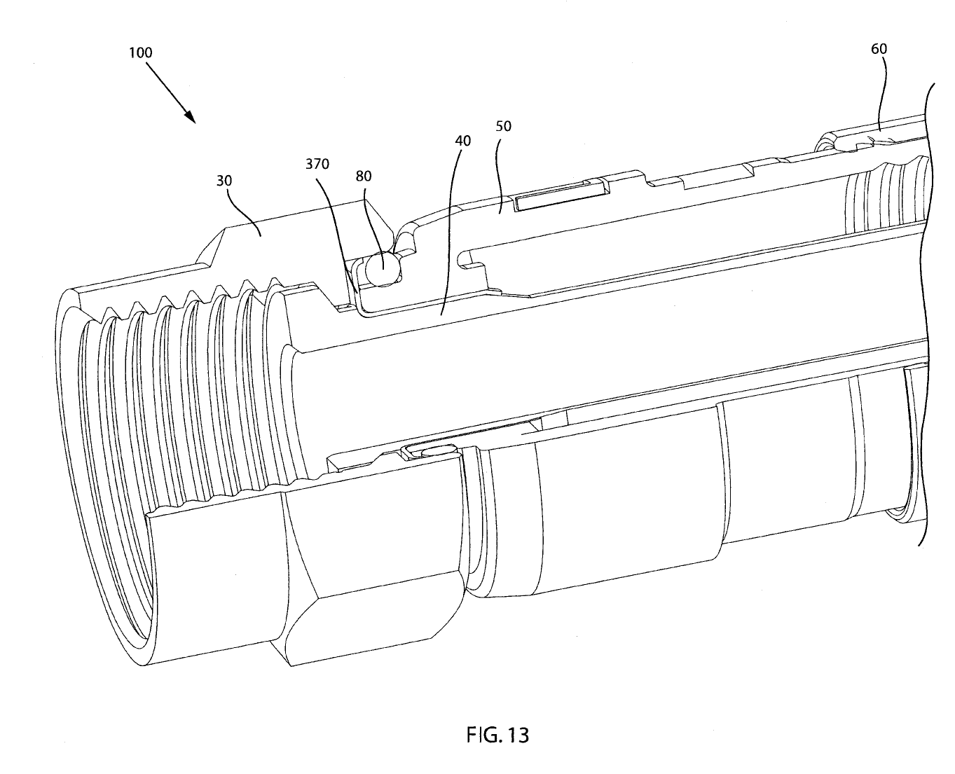

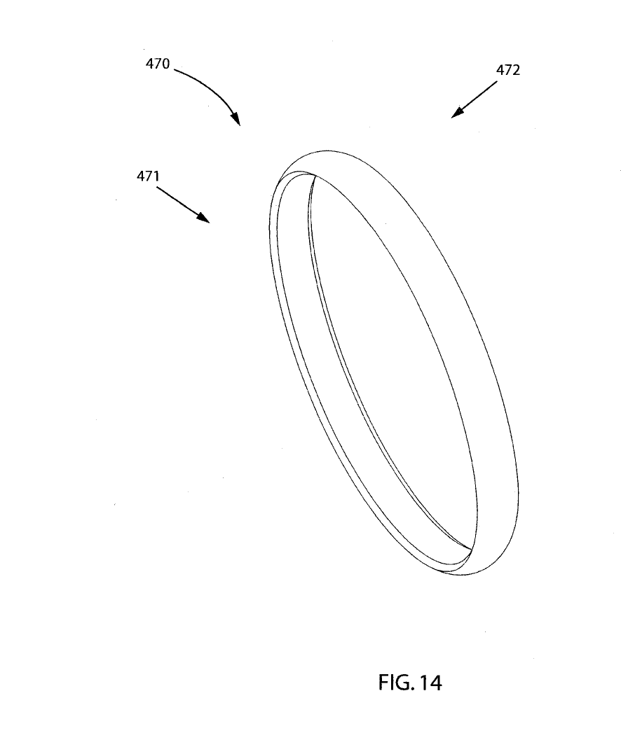

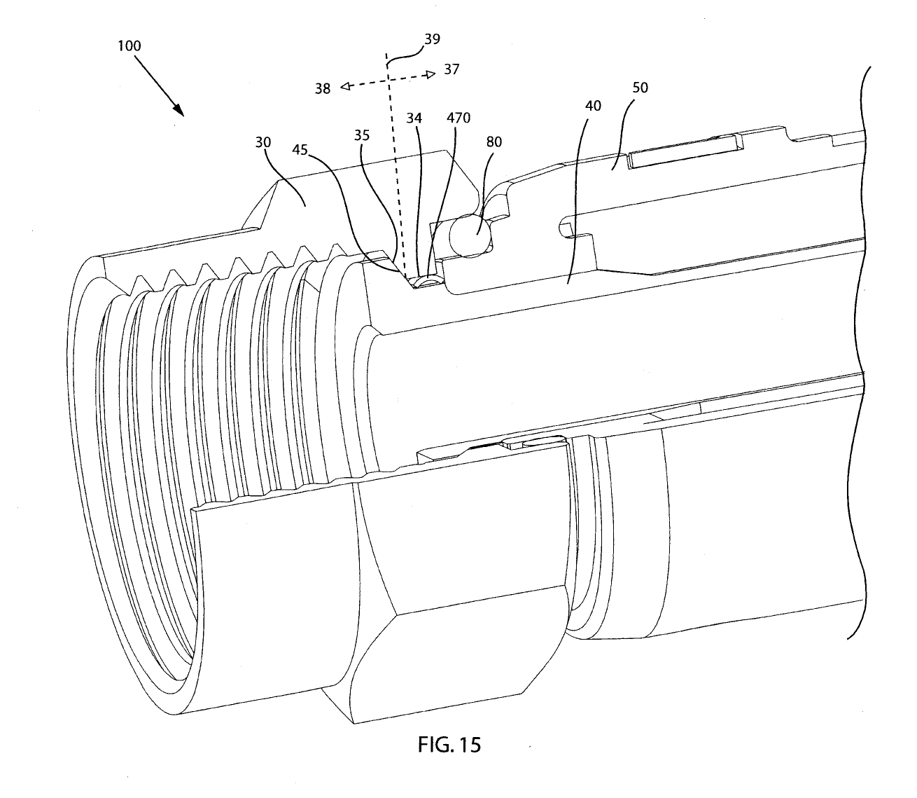

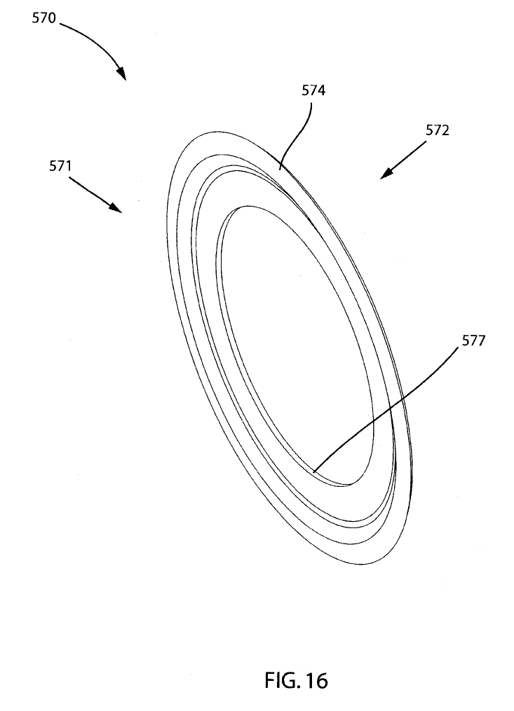

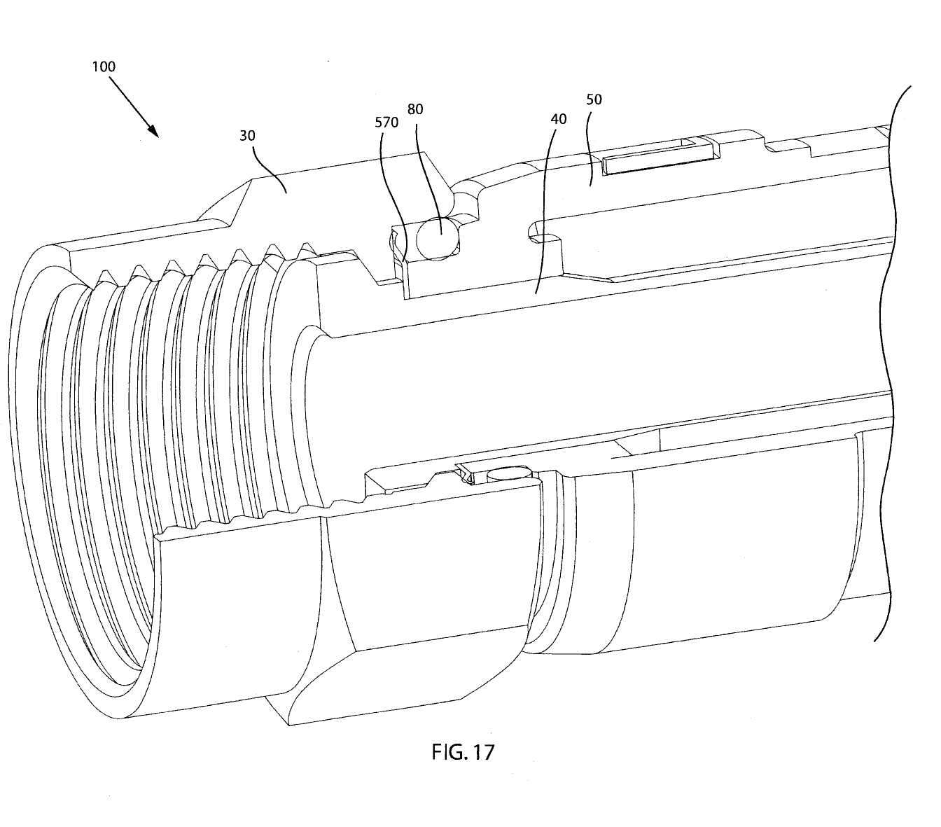

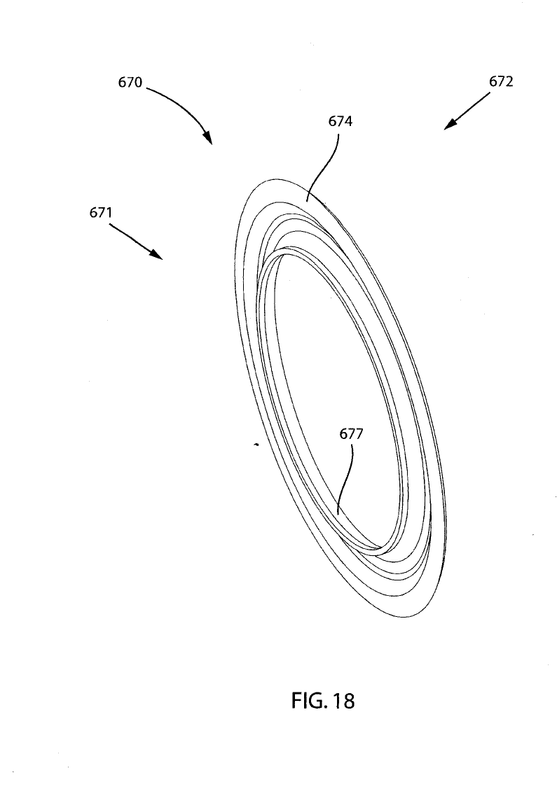

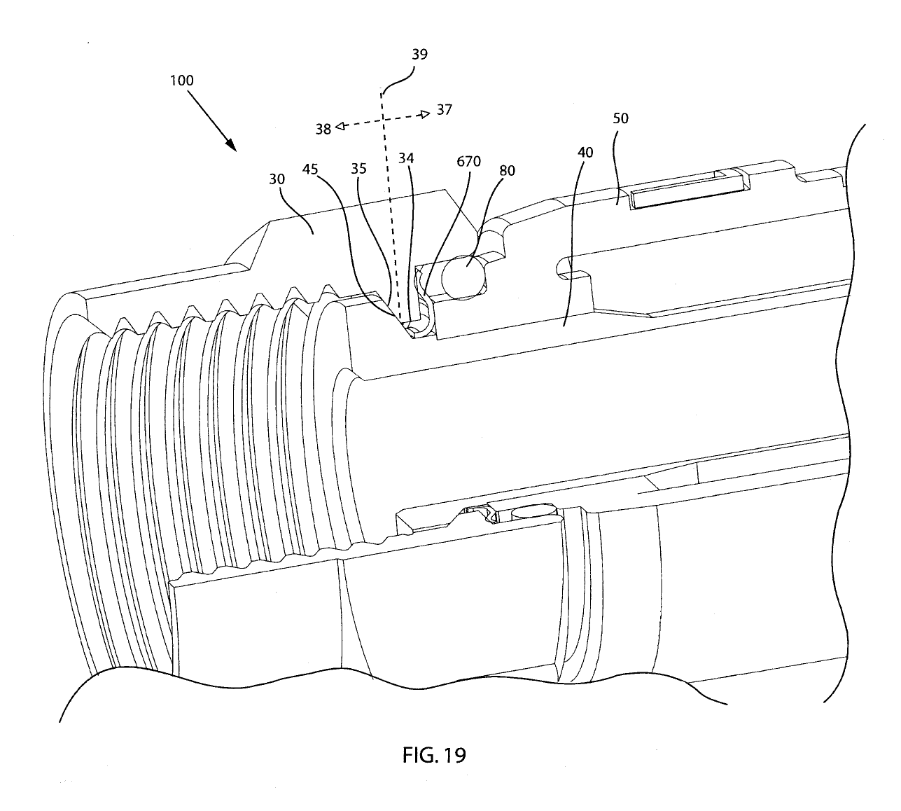

The manner in which the coaxial cable connector 100 may be fastened to a received coaxial cable 10 (such as shown, by way of example, in FIG. 20) may also be similar to the way a cable is fastened to connector having an insertable compression sleeve that is pushed into the connector body 50 to squeeze against and secure the cable 10. The coaxial cable connector 100 includes an outer connector body 50 having a first end 51 and a second end 52. The body 50 at least partially surrounds a tubular inner post 40. The tubular inner post 40 has a first end 41 including a flange 44 and a second end 42 configured to mate with a coaxial cable 10 and contact a portion of the outer conductive grounding shield or sheath 14 of the cable 10. The connector body 50 is secured relative to a portion of the tubular post 40 proximate or close to the first end 41 of the tubular post 40 and cooperates, or otherwise is functionally located in a radially spaced relationship with the inner post 40 to define an annular chamber with a rear opening. A tubular locking compression member may protrude axially into the annular chamber through its rear opening. The tubular locking compression member may be slidably coupled or otherwise movably affixed to the connector body 50 to compress into the connector body and retain the cable 10 and may be displaceable or movable axially or in the general direction of the axis of the connector 100 between a first open position (accommodating insertion of the tubular inner post 40 into a prepared cable 10 end to contact the grounding shield 14), and a second clamped position compressibly fixing the cable 10 within the chamber of the connector 100, because the compression sleeve is squeezed into retraining contact with the cable 10 within the connector body 50. A coupler or nut 30 at the front end of the inner post 40 serves to attach the connector 100 to an interface port. In a connector having an insertable compression sleeve, the structural configuration and functional operation of the nut 30 may be similar to the structure and functionality of similar components of a connector 100 described in FIGS. 1-20, and having reference numerals denoted similarly.

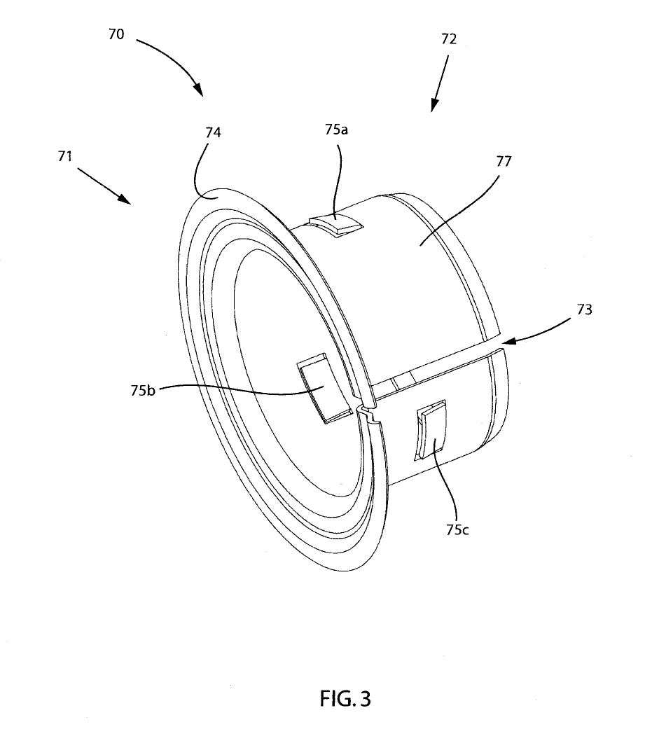

Turning now to FIGS. 2-4, variations of an embodiment of an electrical continuity member 70 are depicted. A continuity member 70 is conductive. The continuity member may have a first end 71 and an axially opposing second end 72. Embodiments of a continuity member 70 include a post contact portion 77. The post contact portion 77 makes physical and electrical contact with the post 40, when the coaxial cable connector 100 is operably assembled, and helps facilitate the extension of electrical ground continuity through the post 40. As depicted in FIGS. 2-4, the post contact portion 77 comprises a substantially cylindrical body that includes an inner dimension corresponding to an outer dimension of a portion of the post 40. A continuity member 70 may also include a securing member 75 or a plurality of securing members, such as the tabs 75a-c, which may help to physically secure the continuity member 70 in position with respect to the post 40 and/or the connector body 50. The securing member 75 may be resilient and, as such, may be capable of exerting spring-like force on operably adjoining coaxial cable connector 100 components, such as the post 40. Embodiments of a continuity member 70 include a nut contact portion 74. The nut contact portion 74 makes physical and electrical contact with the nut 30, when the coaxial cable connector 100 is operably assembled or otherwise put together in a manner that renders the connector 100 functional, and helps facilitate the extension of electrical ground continuity through the nut 30. The nut contact portion 74 may comprise a flange-like element that may be associated with various embodiments of a continuity member 70. In addition, as depicted in FIGS. 2-3, various embodiments of a continuity member 70 may include a through-slit 73. The through-slit 73 extends through the entire continuity member 70. Furthermore, as depicted in FIG. 2, various embodiments of a continuity member 70 may include a flange cutout 76 located on a flange-like nut contact portion 74 of the continuity member 70. A continuity member 70 is formed of conductive materials. Moreover, embodiments of a continuity member 70 may exhibit resiliency, which resiliency may be facilitated by the structural configuration of the continuity member 70 and the material make-up of the continuity member 70.

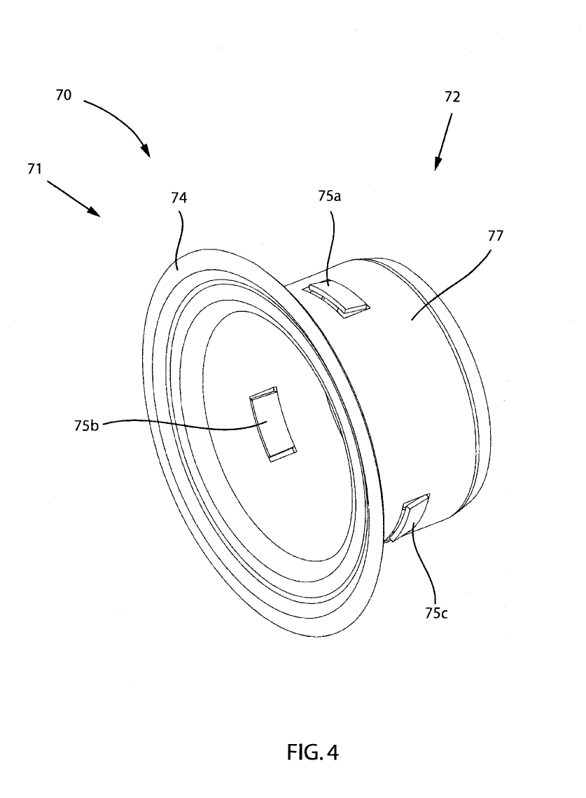

Embodiments of a continuity member 70 may be formed, shaped, fashioned, or otherwise manufactured via any operable process that will render a workable component, wherein the manufacturing processes utilized to make the continuity member may vary depending on the structural configuration of the continuity member. For example, a continuity member 70 having a through-slit 73 may be formed from a sheet of material that may be stamped and then bent into an operable shape that allows the continuity member 70 to function as it was intended. The stamping may accommodate various operable features of the continuity member 70. For instance, the securing member 75, such as tabs 75a-c, may be cut during the stamping process. Moreover, the flange cutout 76 may also be rendered during a stamping process. Those in the art should appreciate that various other surface features may be provided on the continuity member 70 through stamping or by other manufacturing and shaping means. Accordingly, it is contemplated that features of the continuity member 70 may be provided to mechanically interlock or interleave, or otherwise operably physically engage complimentary and corresponding features of embodiments of a nut 30, complimentary and corresponding features of embodiments of a post 40, and/or complimentary and corresponding features of embodiments of a connector body 50. The flange cutout 76 may help facilitate bending that may be necessary to form a flange-like nut contact member 74. However, as is depicted in FIG. 3, embodiments of a continuity member 70 need not have a flange cutout 76. In addition, as depicted in FIG. 4, embodiments of a continuity member 70 need also not have a through-slit 73. Such embodiments may be formed via other manufacturing methods. Those in the art should appreciate that manufacture of embodiments of a continuity member 70 may include casting, extruding, cutting, knurling, turning, coining, tapping, drilling, bending, rolling, forming, component overmolding, combinations thereof, or other fabrication methods that may provide efficient production of the component.

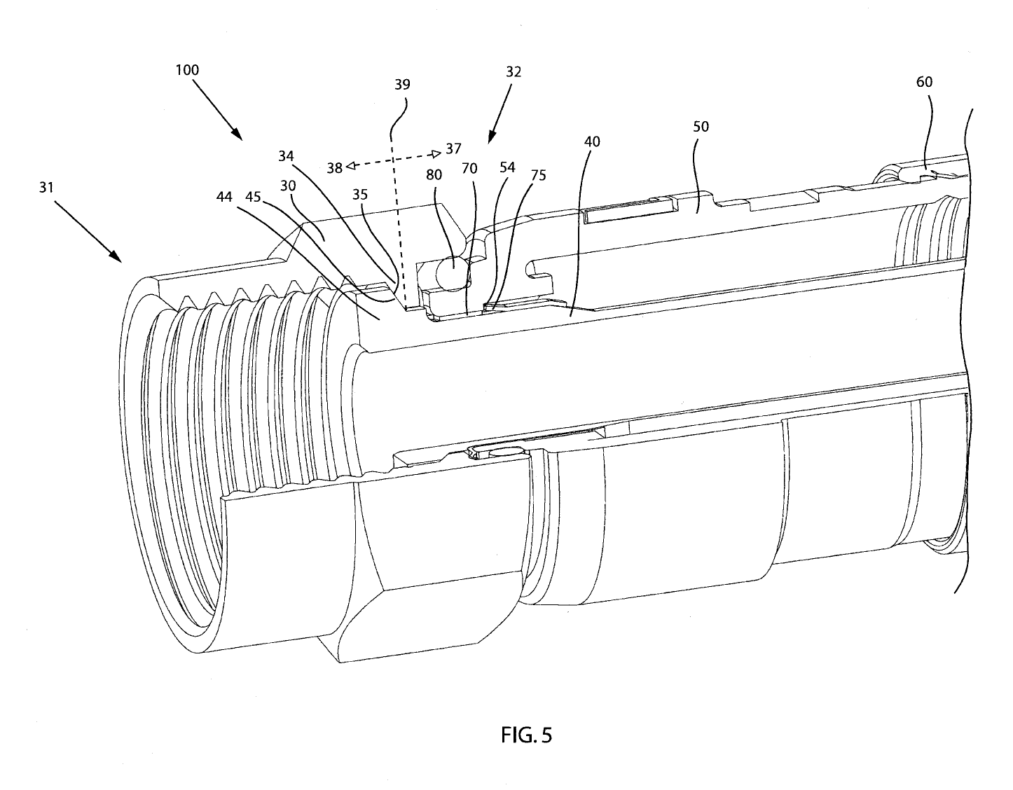

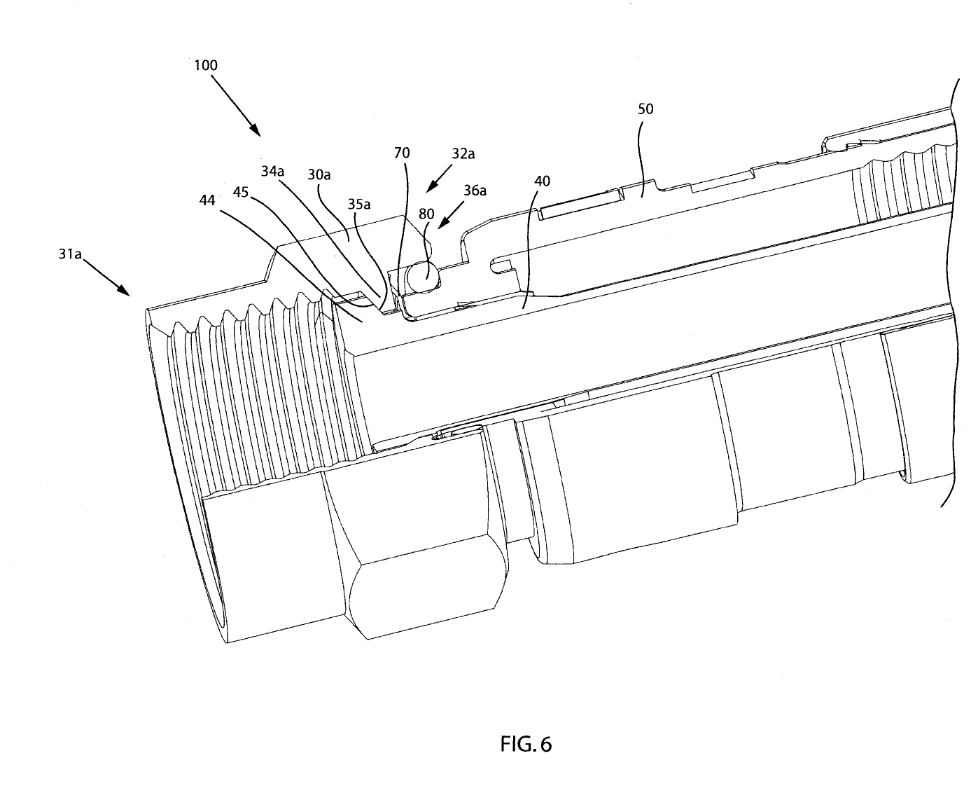

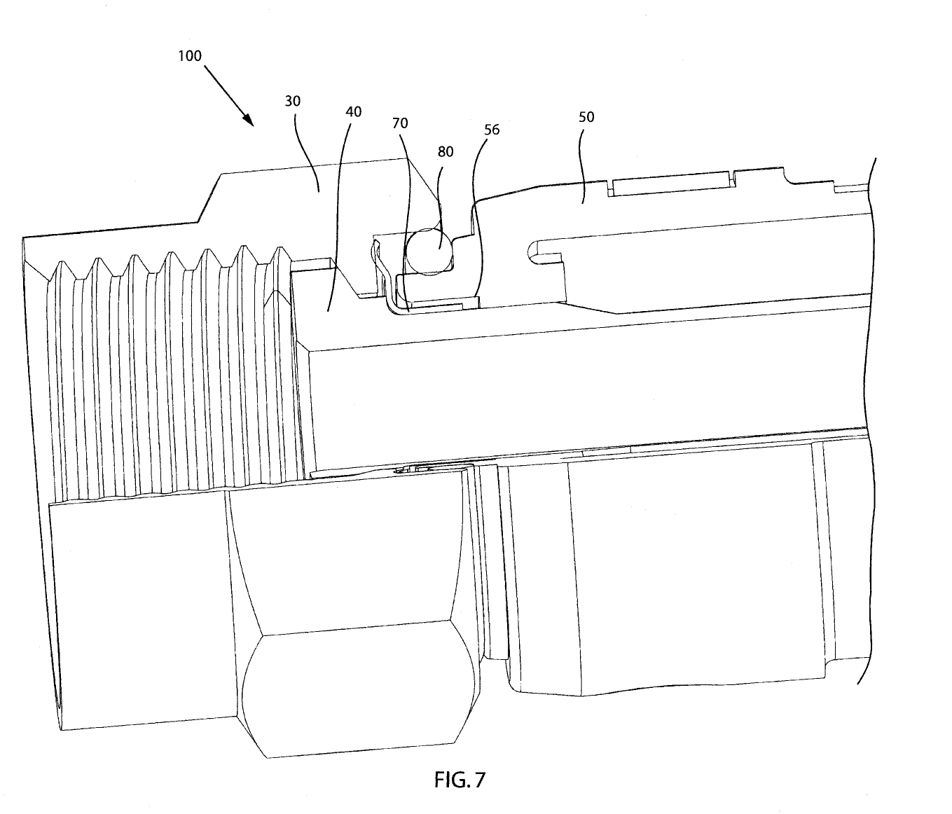

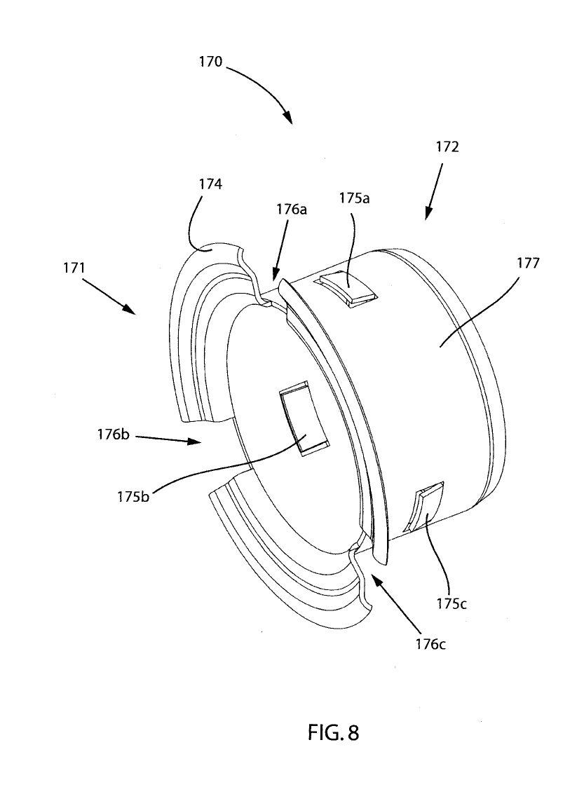

With continued reference to the drawings, FIGS. 5-7 depict perspective cut-away views of portions of embodiments of coaxial cable connectors 100 having an electrical continuity member 70, as assembled. In particular, FIG. 6 depicts a coaxial cable connector embodiment 100 having a shortened nut 30a, wherein the second rearward end 32a of the nut 30a does not extend as far as the second rearward end 32 of nut 30 depicted in FIG. 5. FIG. 7 depicts a coaxial cable connector embodiment 100 including an electrical continuity member 70 that does not touch the connector body 50, because the connector body 50 includes an internal detent 56 that, when assembled, ensures a physical gap between the continuity member 70 and the connector body 50. A continuity member 70 may be positioned around an external surface of the post 40 during assembly, while the post 40 is axially inserted into position with respect to the nut 30. The continuity member 70 should have an inner diameter sufficient to allow it to move up a substantial length of the post body 40 until it contacts a portion of the post 40 proximate the flange 44 at the first end 41 of the post 40.

The continuity member 70 should be configured and positioned so that, when the coaxial cable connector 100 is assembled, the continuity member 70 resides rearward a second end portion 37 of the nut 30, wherein the second end portion 37 starts at a side 35 of the lip 34 of the nut facing the first end 31 of the nut 30 and extends rearward to the second end 32 of the nut 30. The location or the continuity member 70 within a connector 100 relative to the second end portion 37 of the nut being disposed axially rearward of a surface 35 of the internal lip 34 of the nut 30 that faces the flange 44 of the post 40. The second end portion 37 of the nut 30 extends from the second rearward end 32 of the nut 30 to the axial location of the nut 30 that corresponds to the point of the forward facing side 35 of the internal lip 34 that faces the first forward end 31 of the nut 30 that is also nearest the second end 32 of the nut 30. Accordingly, the first end portion 38 of the nut 30 extends from the first end 31 of the nut 30 to that same point of the forward facing side 35 of the lip 34 that faces the first forward end 31 of the nut 30 that is nearest the second end 32 of the nut 30. For convenience, dashed line 39 shown in FIG. 5, depicts the axial point and a relative radial perpendicular plane defining the demarcation of the first end portion 38 and the second end portion 37 of embodiments of the nut 30. As such, the continuity member 70 does not reside between opposing complimentary surfaces 35 and 45 of the lip 34 of the nut 30 and the flange 44 of the post 40. Rather, the continuity member 70 contacts the nut 30 at a location rearward and other than on the side 35 of the lip 34 of the nut 30 that faces the flange 44 of the post 40, at a location only pertinent to and within the second end 37 portion of the nut 30.

With further reference to FIGS. 5-7, a body sealing member 80, such as an O-ring, may be located proximate the second end portion 37 of the nut 30 in front of the internal lip 34 of the nut 30, so that the sealing member 80 may compressibly rest or be squeezed between the nut 30 and the connector body 50. The body sealing member 80 may fit snugly over the portion of the body 50 corresponding to the annular recess 58 proximate the first end 51 of the body 50. However, those in the art should appreciate that other locations of the sealing member 80 corresponding to other structural configurations of the nut 30 and body 50 may be employed to operably provide a physical seal and barrier to ingress of environmental contaminants. For example, embodiments of a body sealing member 80 may be structured and operably assembled with a coaxial cable connector 100 to prevent contact between the nut 30 and the connector body 50.

When assembled, as in FIGS. 5-7, embodiments of a coaxial cable connector 100 may have axially secured components. For example, the body 50 may obtain a physical fit with respect to the continuity member 70 and portions of the post 40, thereby securing those components together both axially and rotationally. This fit may be engendered through press-fitting and/or friction-fitting forces, and/or the fit may be facilitated through structures which physically interfere with each other in axial and/or rotational configurations. Keyed features or interlocking structures on any of the post 40, the connector body 50, and/or the continuity member 70, may also help to retain the components with respect to each other. For instance, the connector body 50 may include an engagement feature 54, such as an internal ridge that may engage the securing member(s) 75, such as tabs 75a-c, to foster a configuration wherein the physical structures, once assembled, interfere with each other to prevent axial movement with respect to each other. Moreover, the same securing structure(s) 75, or other structures, may be employed to help facilitate prevention of rotational movement of the component parts with respect to each other. Additionally, the flange 44 of the post 40 and the internal lip 34 of the nut 30 work to restrict axial movement of those two components with respect to each other toward each other once the lip 34 has contact the flange 44. However, the assembled configuration should not prevent rotational movement of the nut 30 with respect to the other coaxial cable connector 100 components. In addition, when assembled, the fastener member 60 may be secured to a portion of the body 50 so that the fastener member 60 may have some slidable axial freedom with respect to the body 50, thereby permitting operable attachment of a coaxial cable 10. Notably, when embodiments of a coaxial cable connector 100 are assembled, the continuity member 70 is disposed at the second end portion 37 of the nut 30, so that the continuity member 70 physically and electrically contacts both the nut 30 and the post 40, thereby extending ground continuity between the components.

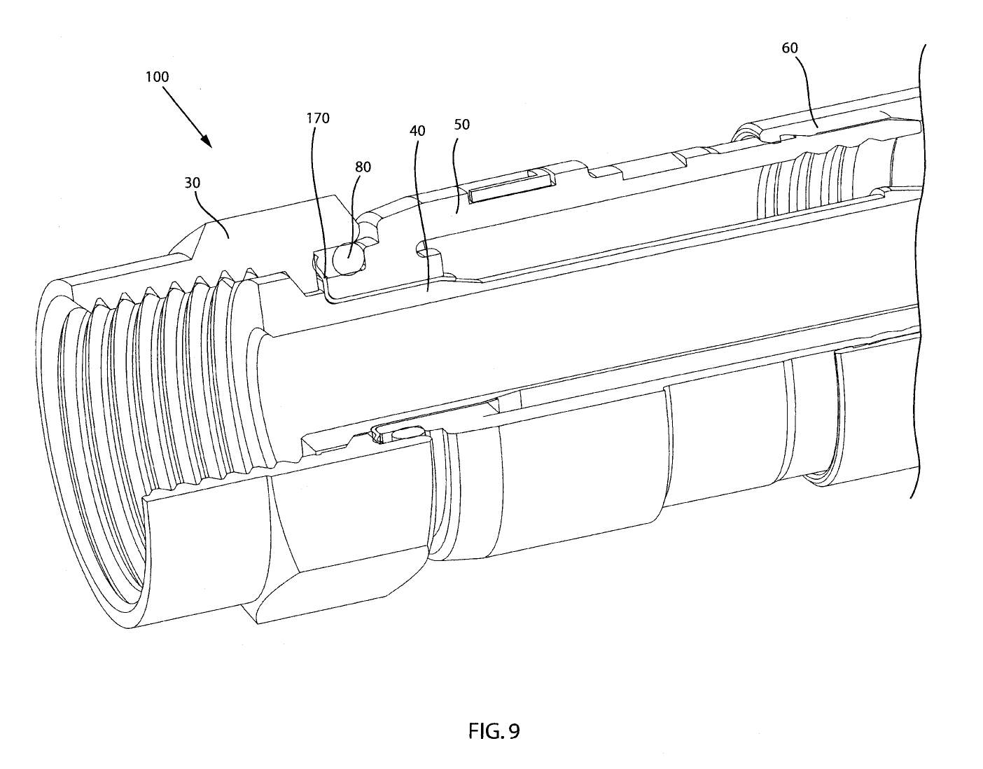

With continued reference to the drawings, FIGS. 8-19 depict various continuity member embodiments 170-670 and show how those embodiments are secured within coaxial cable connector 100 embodiments, when assembled. As depicted, continuity members may vary in shape and functionality. However, all continuity members have at least a conductive portion and all reside rearward of the forward facing surface 35 of the internal lip 34 of the nut 30 and rearward the start of the second end portion 37 of the nut 30 of each coaxial cable connector embodiment 100 into which they are assembled. For example, a continuity member embodiment 170 may have multiple flange cutouts 176a-c. A continuity member embodiment 270 includes a nut contact portion 274 configured to reside radially between the nut 30 and the post 40 rearward the start of the second end portion 37 of the nut 30, so as to be rearward of the forward facing surface 35 of the internal lip 34 of the nut. A continuity member embodiment 370 is shaped in a manner kind of like a top hat, wherein the nut contact portion 374 contacts a portion of the nut 30 radially between the nut 30 and the connector body 50. A continuity member embodiment 470 resides primarily radially between the innermost part of the lip 34 of nut 30 and the post 40, within the second end portion 37 of the nut 30. In particular, the nut 30 of the coaxial cable connector 100 having continuity member 470 does not touch the connector body 50 of that same coaxial cable connector 100. A continuity member embodiment 570 includes a post contact portion 577, wherein only a radially inner edge of the continuity member 570, as assembled, contacts the post 40. A continuity member embodiment 670 includes a post contact portion that resides radially between the lip 34 of the nut 30 and the post 40, rearward the start of the second end portion 37 of the nut 30.

Turning now to FIG. 20, an embodiment of a coaxial cable connector 100 is depicted in a mated position on an interface port 20. As depicted, the coaxial cable connector 100 is fully tightened onto the interface port 20 so that the mating edge 26 of the interface port 20 contacts the mating edge 46 of the post 40 of the coaxial cable connector 100. Such a fully tightened configuration provides optimal grounding performance of the coaxial cable connector 100. However, even when the coaxial connector 100 is only partially installed on the interface port 20, the continuity member 70 maintains an electrical ground path between the mating port 20 and the outer conductive shield (ground 14) of cable 10. The ground path extends from the interface port 20 to the nut 30, to the continuity member 70, to the post 40, to the conductive grounding shield 14. Thus, this continuous grounding path provides operable functionality of the coaxial cable connector 100 allowing it to work as it was intended even when the connector 100 is not fully tightened.

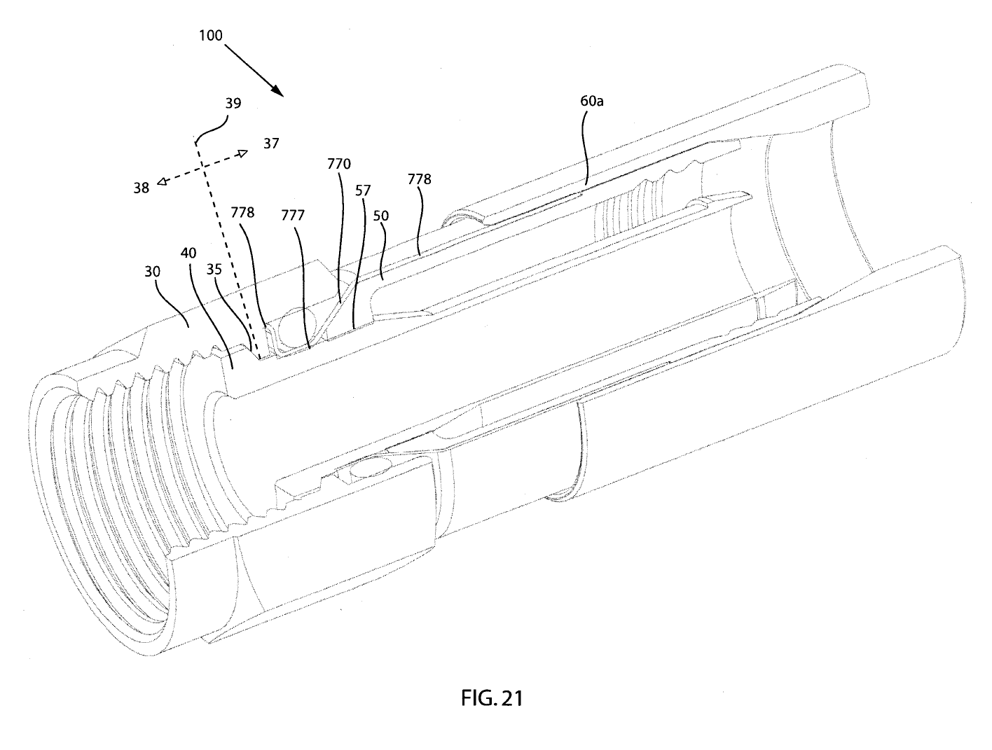

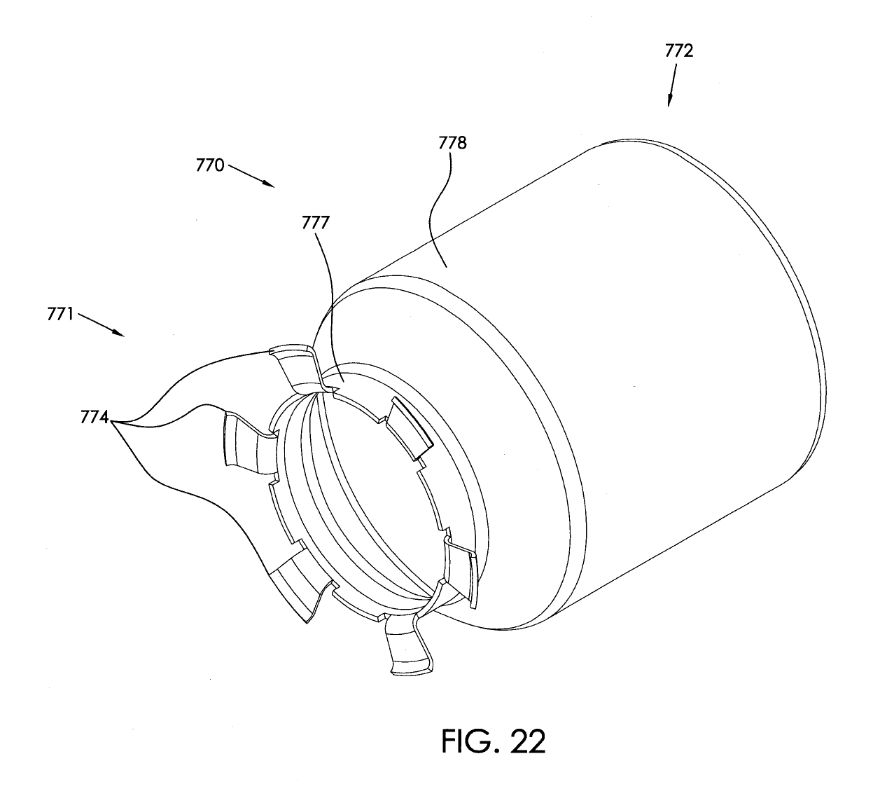

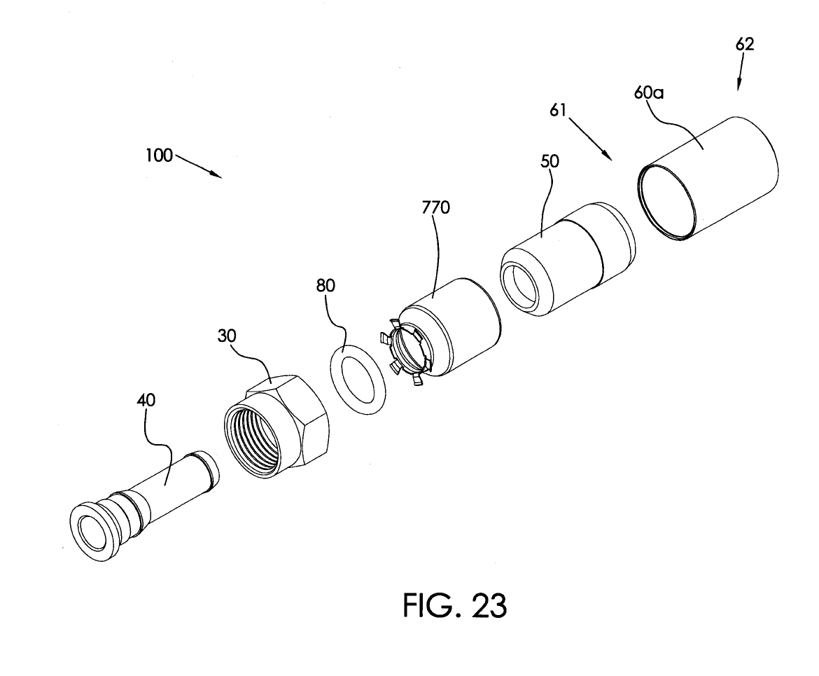

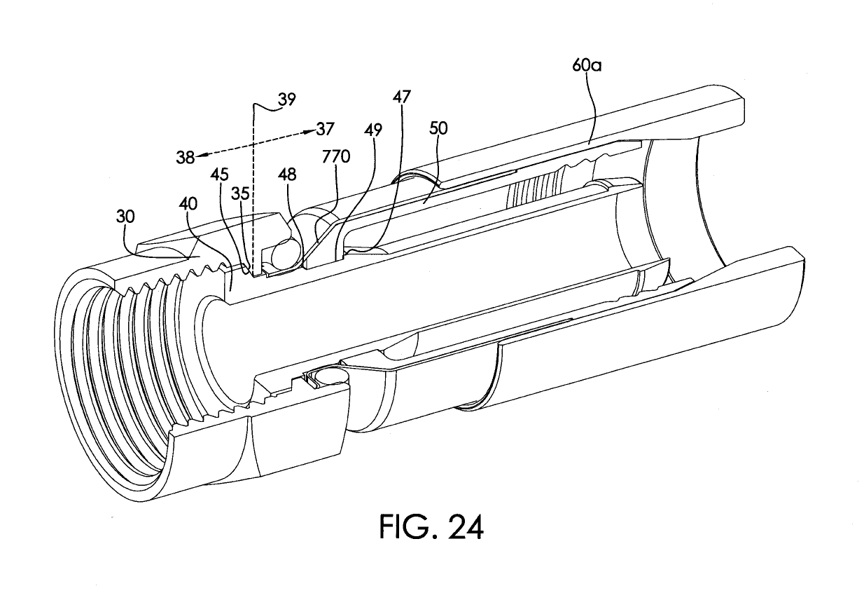

With continued reference to the drawings, FIG. 21-23 depict cut-away, exploded, perspective views of an embodiment of a coaxial cable connector 100 having still even another embodiment of an electrical continuity member 770, in accordance with the present invention. As depicted, the continuity member 770 does not reside in the first end portion 38 of the nut 30. Rather, portions of the continuity member 770 that contact the nut 30 and the post 40, such as the nut contacting portion(s) 774 and the post contacting portion 777, reside rearward the start (beginning at forward facing surface 35) of the second end portion 37 of the nut 30, like all other embodiments of continuity members. The continuity member 770, includes a larger diameter portion 778 that receives a portion of a connector body 50, when the coaxial cable connector 100 is assembled. In essence, the continuity member 770 has a sleeve-like configuration and may be press-fit onto the received portion of the connector body 50. When the coaxial cable connector 100 is assembled, the continuity member 770 resides between the nut 30 and the connector body 50, so that there is no contact between the nut 30 and the connector body 50. The fastener member 60a may include an axially extended first end 61. The first end 61 of the fastener member 60 may extend an axial distance so that, when the fastener member 60a is compressed into sealing position on the coaxial cable 100 (not shown, but readily comprehensible by those of ordinary skill in the art), the fastener member 60a touches or otherwise resides substantially proximate or very near the nut 30. This touching, or otherwise close contact between the nut 30 and the fastener member 60 coupled with the in-between or sandwiched location of the continuity member 770 may facilitate enhanced prevention of RF ingress and/or ingress of other environmental contaminants into the coaxial cable connector 100 at or near the second end 32 of the nut 30. As depicted, the continuity member 770 and the associated connector body 50 may be press-fit onto the post 40, so that the post contact portion 777 of the continuity member 770 and the post mounting portion 57 of the connector body 50 are axially and rotationally secured to the post 40. The nut contacting portion(s) 774 of the continuity member 770 are depicted as resilient members, such as flexible fingers, that extend to resiliently engage the nut 30. This resiliency of the nut contact portions 774 may facilitate enhanced contact with the nut 30 when the nut 30 moves during operation of the coaxial cable connector 100, because the nut contact portions 774 may flex and retain constant physical and electrical contact with the nut 30, thereby ensuring continuity of a grounding path extending through the nut 30.

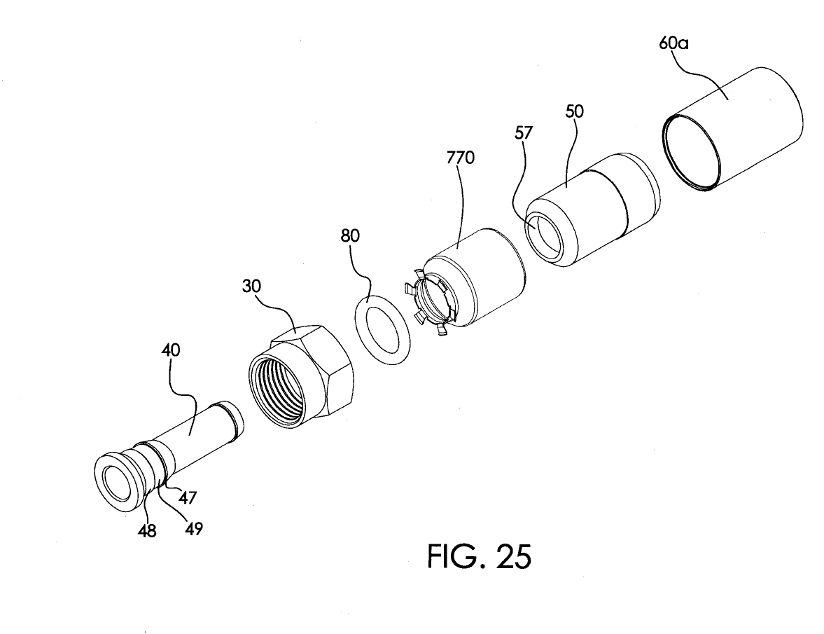

Referring still further to the drawings, FIGS. 24-25 depict perspective views of another embodiment of a coaxial cable connector 100 having a continuity member 770. As depicted, the post 40 may include a surface feature 47, such as a lip extending from a connector body engagement portion 49 having a diameter that is smaller than a diameter of a continuity member engagement portion 48. The surface feature lip 47, along with the variably-diametered continuity member and connector body engagement portions 48 and 49, may facilitate efficient assembly of the connector 100 by permitting various component portions having various structural configurations and material properties to move into secure location, both radially and axially, with respect to one another.

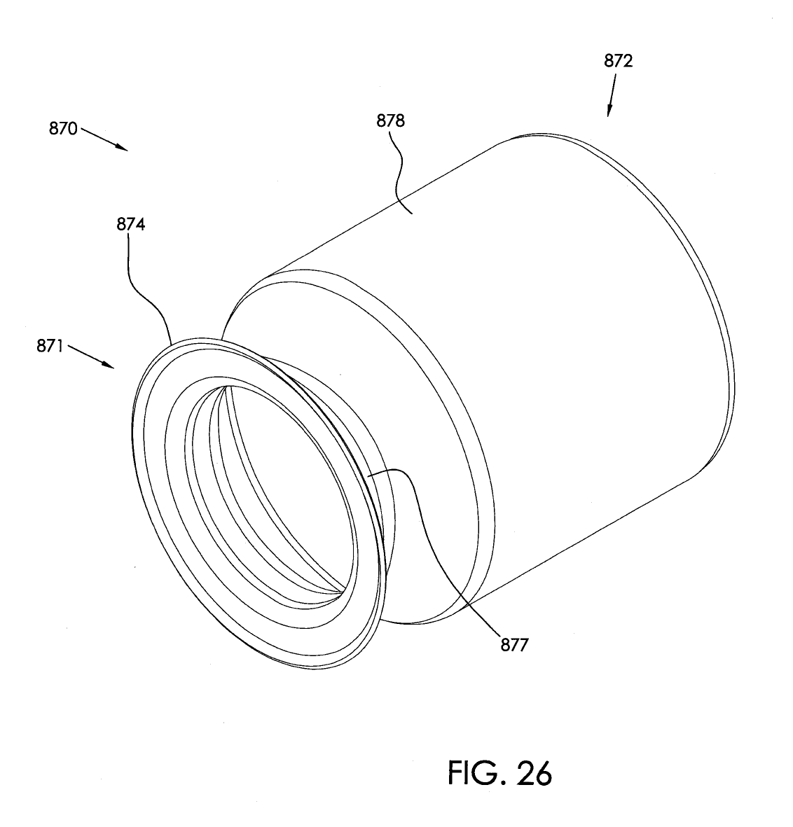

With still further reference to the drawings, FIG. 26 depicts a perspective view of still further even another embodiment of an electrical continuity member 870, in accordance with the present invention. The continuity member 870 may be similar in structure to the continuity member 770, in that it is also sleeve-like and extends about a portion of connector body 50 and resides between the nut 30 and the connector body 50 when the coaxial cable connector 100 is assembled. However, the continuity member 870 includes an unbroken flange-like nut contact portion 874 at the first end 871 of the continuity member 870. The flange-like nut contact portion 874 may be resilient and include several functional properties that are very similar to the properties of the finger-like nut contact portion(s) 774 of the continuity member 770. Accordingly, the continuity member 870 may efficiently extend electrical continuity through the nut 30.

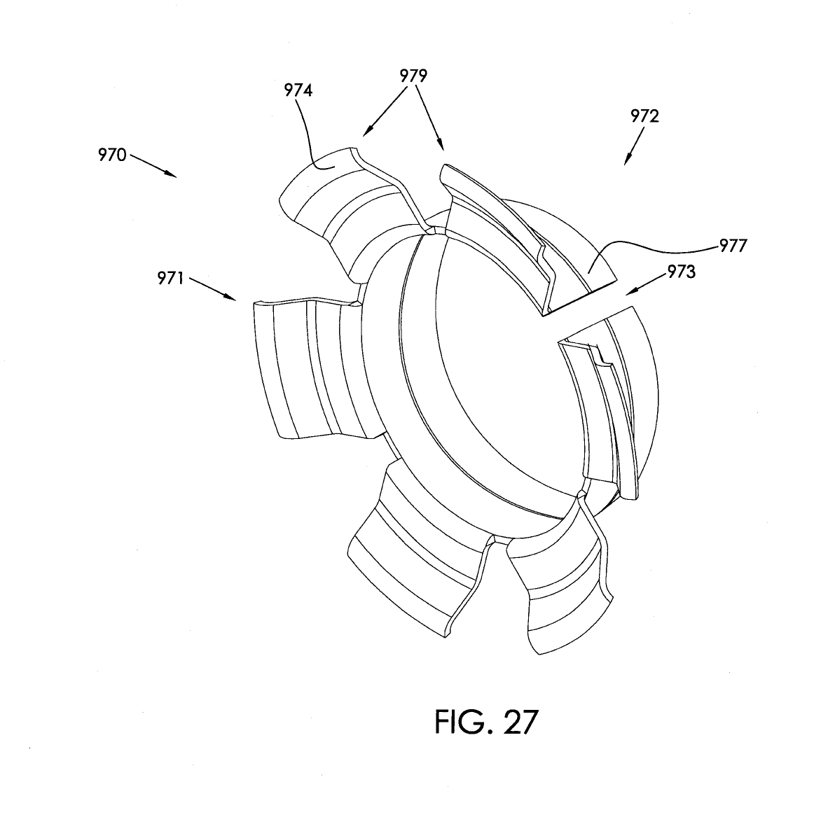

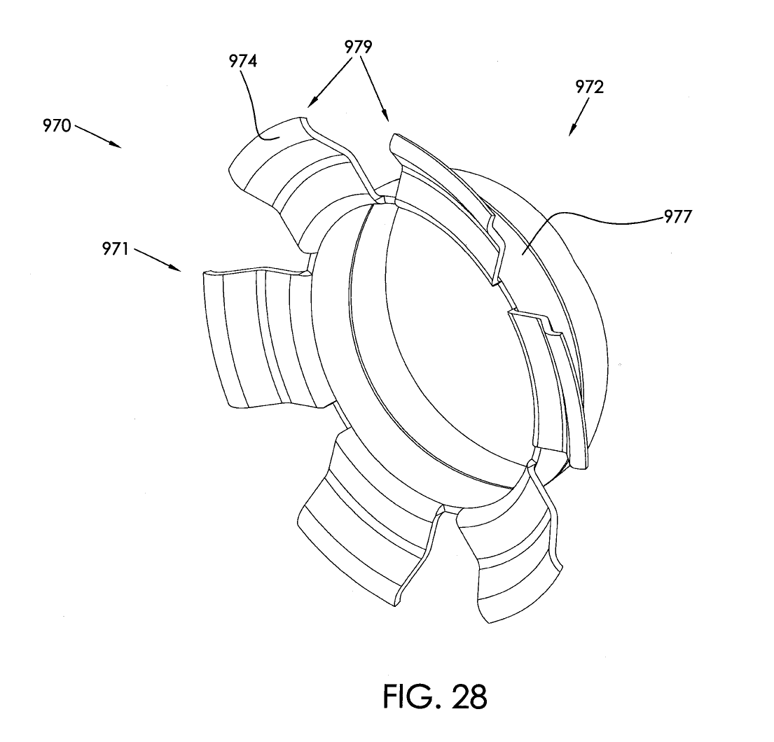

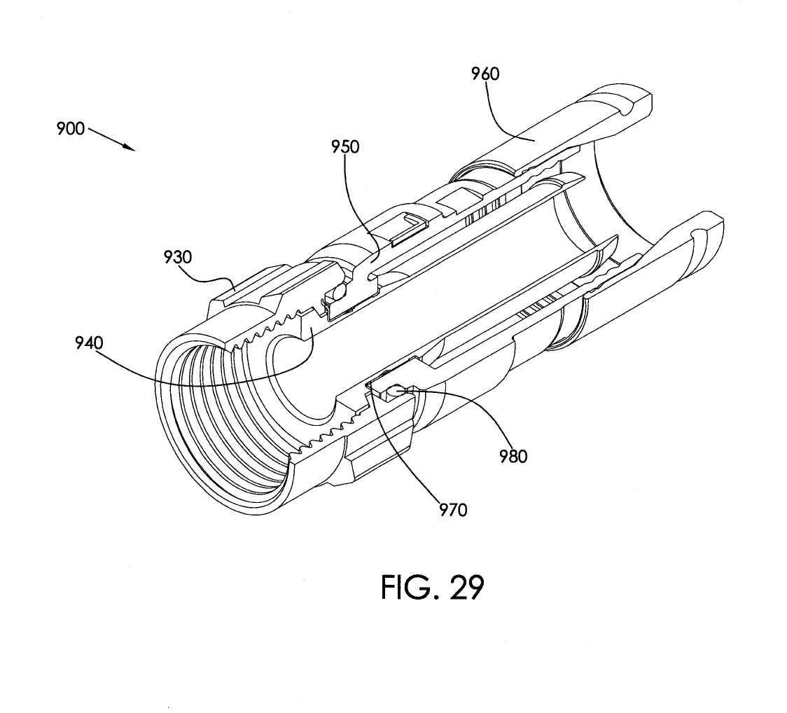

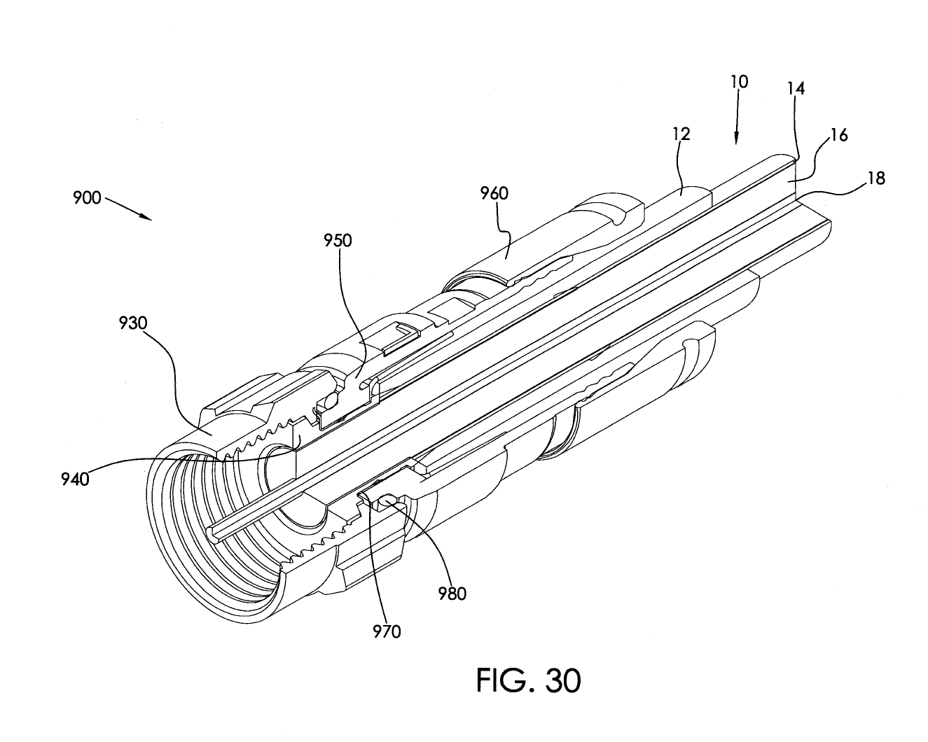

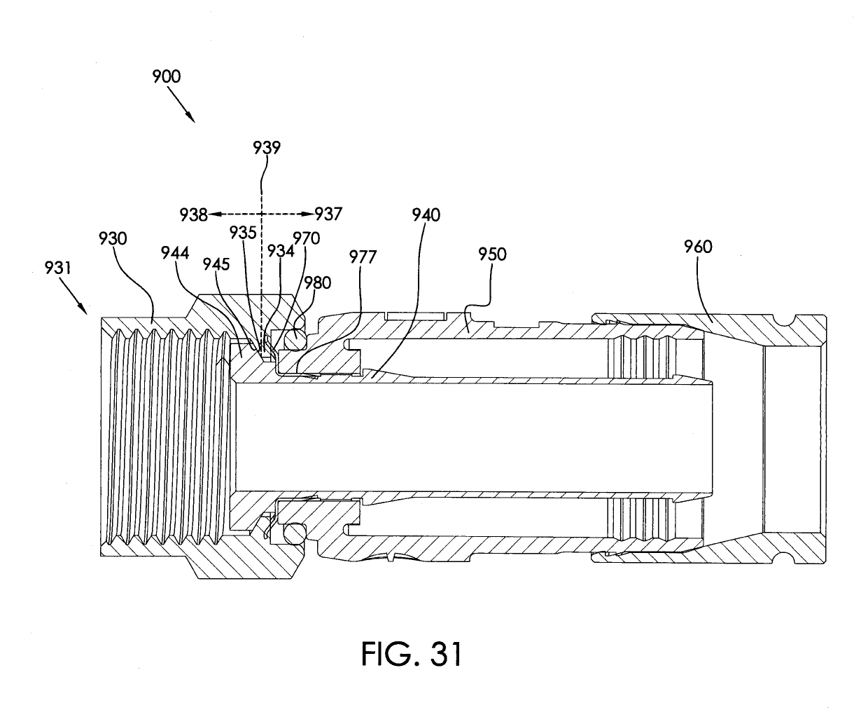

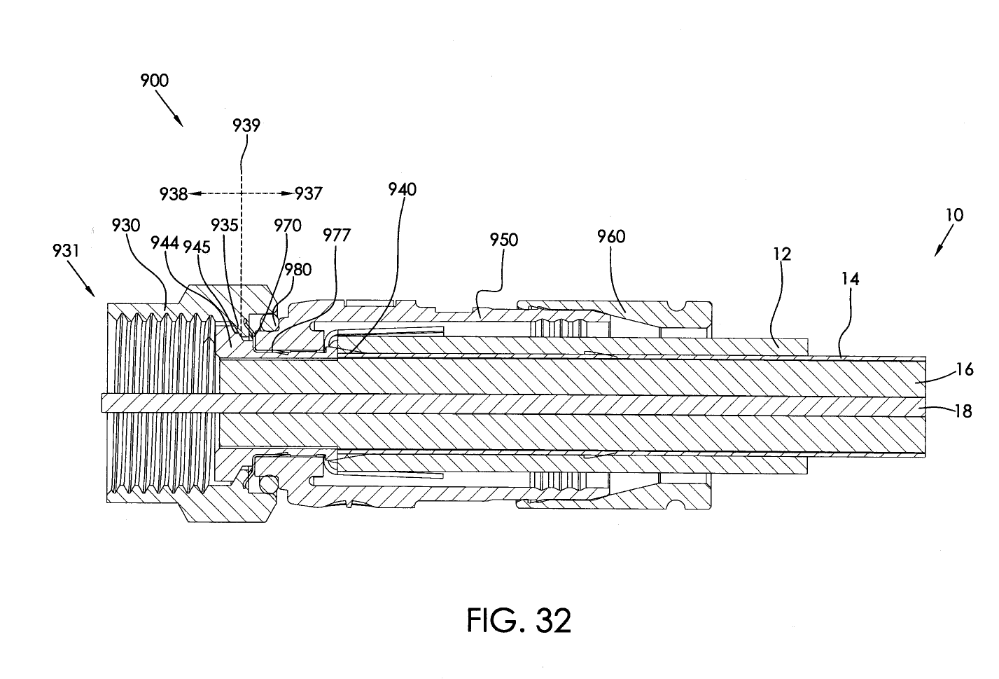

With an eye still toward the drawings and with particular respect to FIGS. 27-32, another embodiment of an electrical continuity member 970 is depicted in several views, and is also shown as included in a further embodiment of a coaxial cable connector 900. The electrical continuity member 970 has a first end 971 and a second end 972. The first end 971 of the electrical continuity member 970 may include one or more flexible portions 979. For example, the continuity member 970 may include multiple flexible portions 979, each of the flexible portions 979 being equidistantly arranged so that in perspective view the continuity member 970 looks somewhat daisy-like. However, those knowledgeable in the art should appreciate that a continuity member 970 may only need one flexible portion 979 and associated not contact portion 974 to obtain electrical continuity for the connector 900. Each flexible portion 979 may associate with a nut contact portion 974 of the continuity member 970. The nut contact portion 974 is configured to engage a surface of the nut 930, wherein the surface of the nut 930 that is engaged by the nut contact portion 974 resides rearward the forward facing surface 935 of nut 930 and the start of the second end portion 937 of the nut 930. A post contact portion 977, may physically and electrically contact the post 940. The electrical continuity member 970 may optionally include a through-slit 973, which through-slit 973 may facilitate various processes for manufacturing the member 970, such as those described in like manner above. Moreover, a continuity member 970 with a through-slit 973 may also be associated with different assembly processes and/or operability than a corresponding electrical continuity member 970 that does not include a through-slit.

When in operation, an electrical continuity member 970 should maintain electrical contact with both the post 940 and the nut 930, as the nut 930 operably moves rotationally about an axis with respect to the rest of the coaxial cable connector 900 components, such as the post 940, the connector body 950 and the fastener member 960. Thus, when the connector 900 is fastened with a coaxial cable 10, a continuous electrical shield may extend from the outer grounding sheath 14 of the cable 10, through the post 940 and the electrical continuity member 970 to the nut or coupler 930, which coupler 930 ultimately may be fastened to an interface port (see, for example port 20 of FIG. 1), thereby completing a grounding path from the cable 10 through the port 20. A sealing member 980 may be operably positioned between the nut 930, the post 940, and the connector body 950, so as to keep environmental contaminants from entering within the connector 900, and to further retain proper component placement and prevent ingress of environmental noise into the signals being communicated through the cable 10 as attached to the connector 900. Notably, the design of various embodiments of the coaxial cable connector 900 includes elemental component configuration wherein the nut 930 does not (and even cannot) contact the body 950.

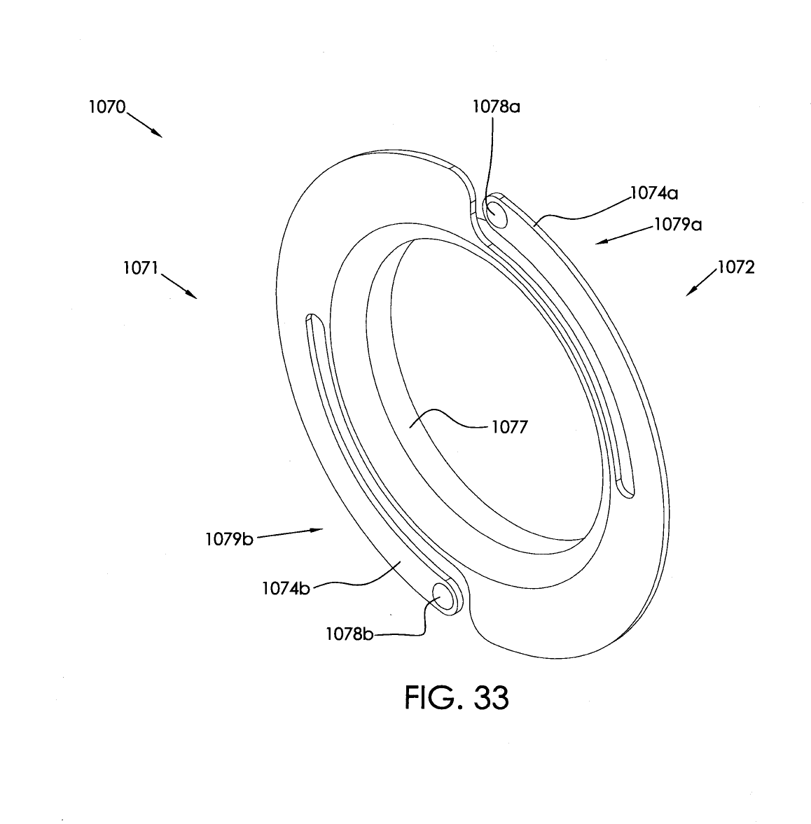

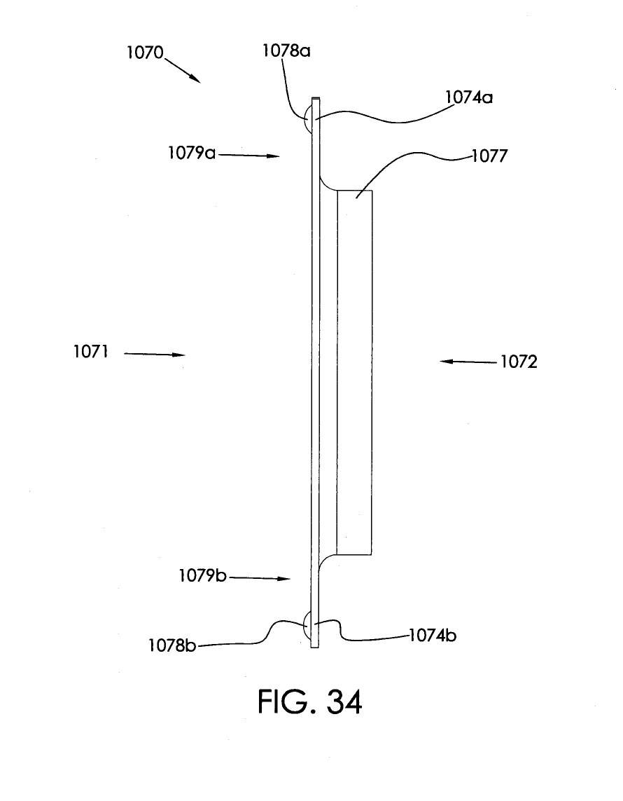

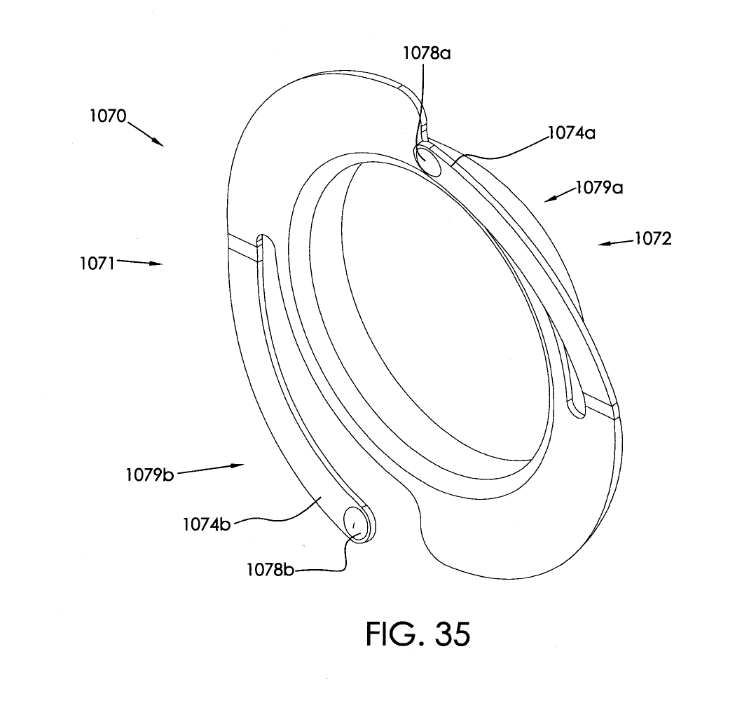

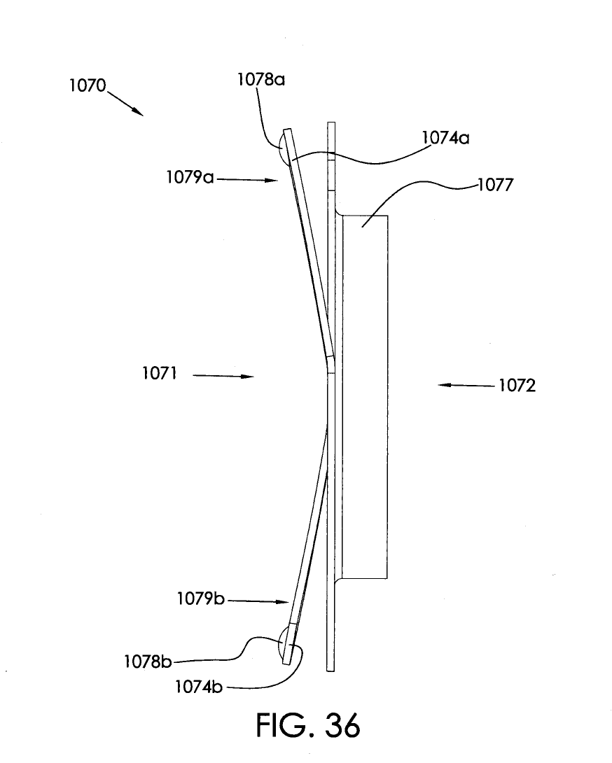

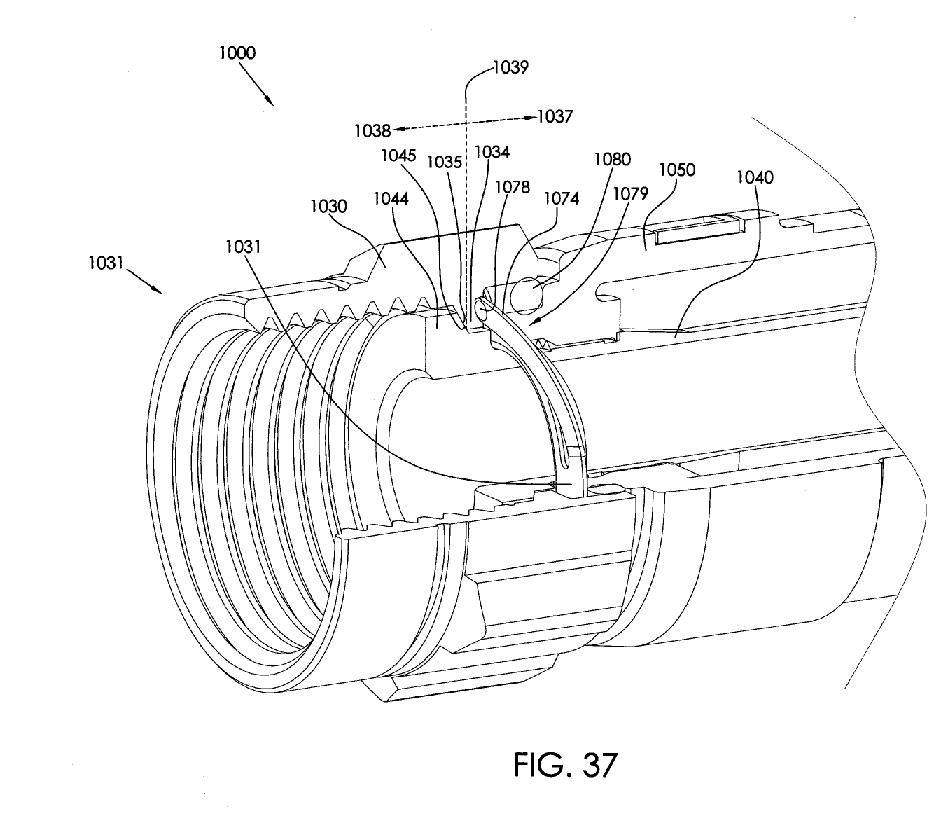

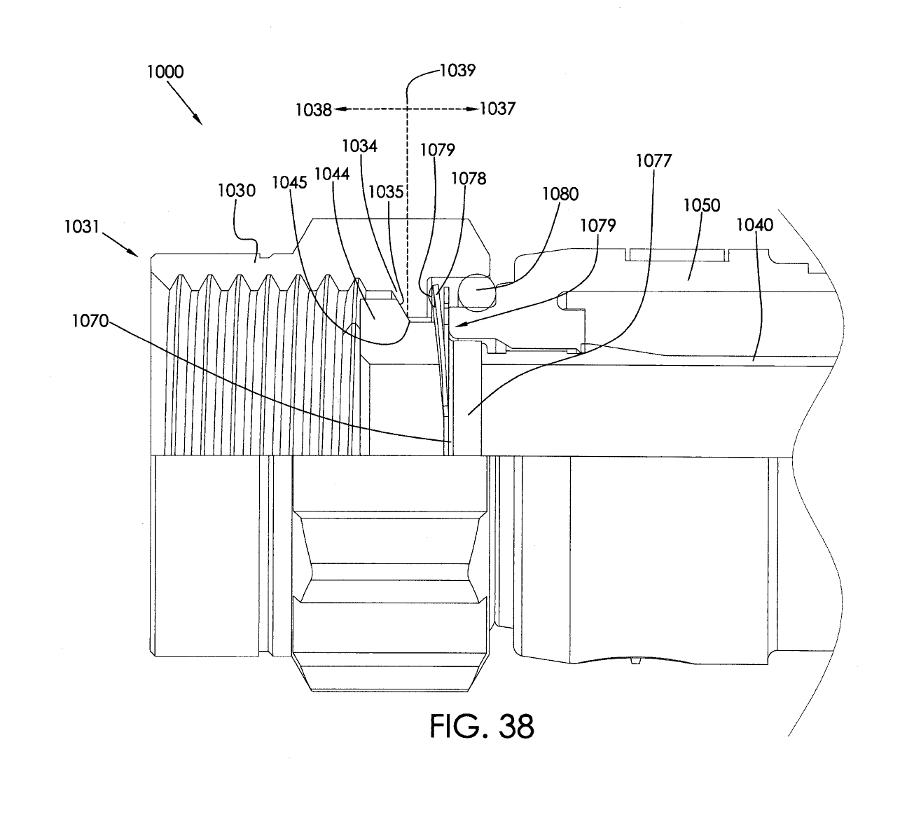

Turning further to the drawings, FIGS. 33-38 depict yet another embodiment of an electrical continuity member 1070. The electrical continuity member 1070 is operably included, to help facilitate electrical continuity in an embodiment of a coaxial cable connector 1000 having multiple component features, such as a coupling nut 1030, an inner post 1040, a connector body 1050, and a sealing member 1080, along with other like features, wherein such component features are, for the purposes of description herein, structured similarly to corresponding structures (referenced numerically in a similar manner) of other coaxial cable connector embodiments previously discussed herein above, in accordance with the present invention. The electrical continuity member 1070 has a first end 1071 and opposing second end 1072, and includes at least one flexible portion 1079 associated with a nut contact portion 1074. The nut contact portion 1074 may include a nut contact tab 1078. As depicted, an embodiment of an electrical continuity member 1070 may include multiple flexible portions 1079a-b associated with corresponding nut contact portions 1074a-b. The nut contact portions 1074a-b may include respective corresponding nut contact tabs 1078a-b. Each of the multiple flexible portions 1079a-b, nut contact portions 1074a-b, and nut contact tabs 1078a-b may be located so as to be oppositely radially symmetrical about a central axis of the electrical continuity member 1070. A post contact portion 1077 may be formed having an axial length, so as to facilitate axial lengthwise engagement with the post 1040, when assembled in a coaxial cable connector embodiment 1000. The flexible portions 1079a-b may be pseudo-coaxially curved arm members extending in yin/yang like fashion around the electrical continuity member 1070. Each of the flexible portions 1079a-b may independently bend and flex with respect to the rest of the continuity member 1070. For example, as depicted in FIGS. 35 and 36, the flexible portions 1079a-b of the continuity member are bent upwards in a direction towards the first end 1071 of the continuity member 1070. Those skilled in the relevant art should appreciate that a continuity member 1070 may only need one flexible portion 1079 to efficiently obtain electrical continuity for a connector 1000.

When operably assembled within an embodiment of a coaxial cable connector 1000, electrical continuity member embodiments 1070 utilize a bent configuration of the flexible portions 1079a-b, so that the nut contact tabs 1078a-b associated with the nut contact portions 1074a-b of the continuity member 1070 make physical and electrical contact with a surface of the nut 1030, wherein the contacted surface of the nut 1030 resides rearward of the forward facing surface 1035 of the inward lip 1034 of nut 1030, and rearward of the start (at surface 1035) of the second end portion 1037 of the nut 1030. For convenience, dashed line 1039 (similar, for example, to dashed line 39 shown in FIG. 5) depicts the axial point and a relative radial perpendicular plane defining the demarcation of the first end portion 1038 and the second end portion 1037 of embodiments of the nut 1030. As such, the continuity member 1070 does not reside between opposing complimentary surfaces of the lip 1034 of the nut 1030 and the flange 1044 of the post 1040. Rather, the electrical continuity member 1070 contacts the nut 1030 at a rearward location other than on the forward facing side of the lip 1034 of the nut 1030 that faces the flange 1044 of the post 1040, at a location only pertinent to the second end 1037 portion of the nut 1030.

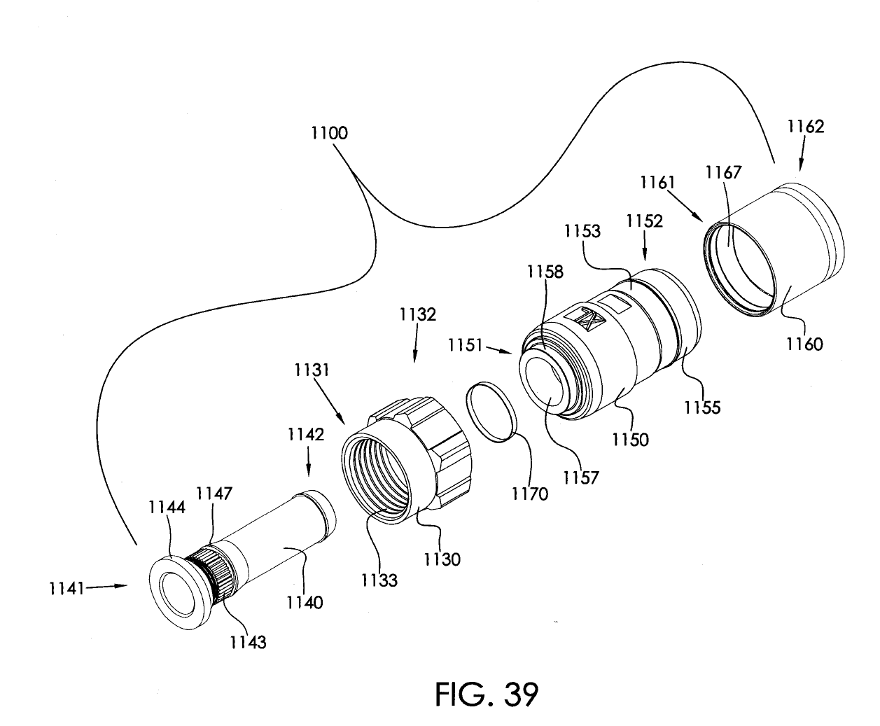

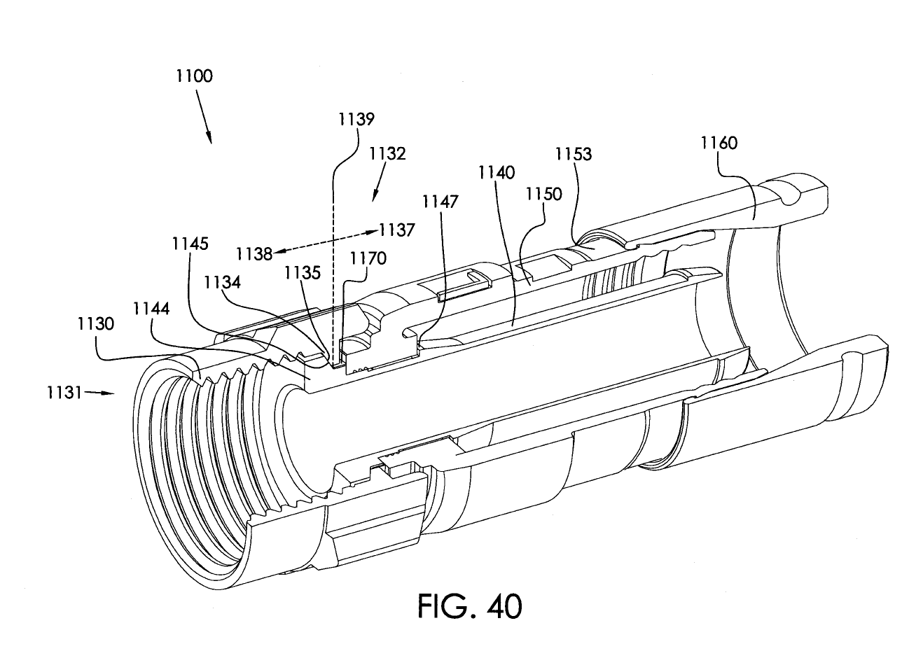

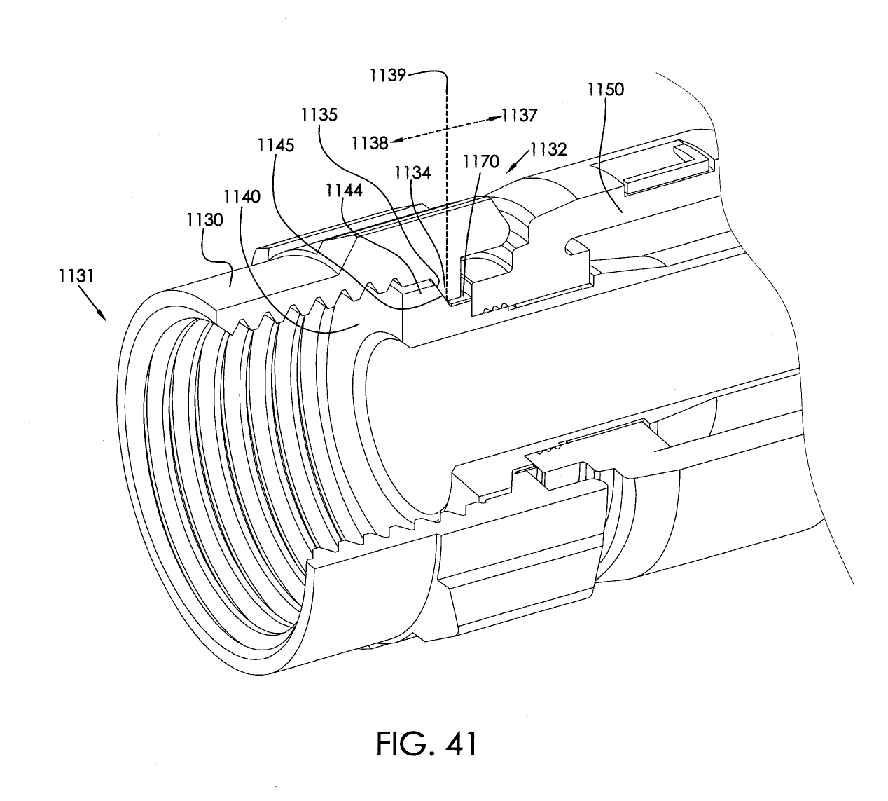

Referring still to the drawings, FIGS. 39-42 depict various views of another embodiment of a coaxial cable connector 1100 having an embodiment of an electrical continuity member 1170, in accordance with the present invention. Embodiments of an electrical continuity member, such as embodiment 1170, or any of the other embodiments 70, 170, 270, 370, 470, 570, 670, 770, 870, 970, 1070, 1270 and other like embodiments, may utilize materials that may enhance conductive ability. For instance, while it is critical that continuity member embodiments be comprised of conductive material, it should be appreciated that continuity members may optionally be comprised of alloys, such as cuprous alloys formulated to have excellent resilience and conductivity. In addition, part geometries, or the dimensions of component parts of a connector 1100 and the way various component elements are assembled together in coaxial cable connector 1100 embodiments may also be designed to enhance the performance of embodiments of electrical continuity members. Such part geometries of various component elements of coaxial cable connector embodiments may be constructed to minimize stress existent on components during operation of the coaxial cable connector, but still maintain adequate contact force, while also minimizing contact friction, but still supporting a wide range of manufacturing tolerances in mating component parts of embodiments of electrical continuity coaxial cable connectors.

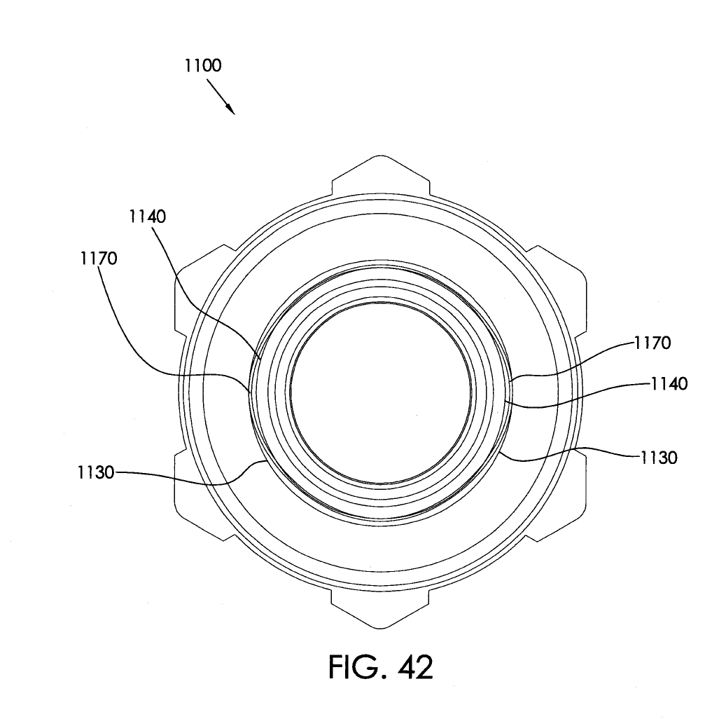

An embodiment of an electrical continuity member 1170 may comprise a simple continuous band, which, when assembled within embodiments of a coaxial cable connector 1100, encircles a portion of the post 1140, and is in turn surrounded by the second end portion 1137 of the nut 1130. The band-like continuity member 1170 resides rearward a second end portion 1137 of the nut that starts at a side 1135 of the lip 1134 of the nut 1130 facing the first end 1131 of the nut 1130 and extends rearward to the second end 1132 of the nut. The simple band-like embodiment of an electrical continuity member 1170 is thin enough that it occupies an annular space between the second end portion 1137 of the nut 1130 and the post 1140, without causing the post 1140 and nut 1130 to bind when rotationally moved with respect to one another. The nut 1130 is free to rotate, and has some freedom for slidable axial movement, with respect to the connector body 1150. The band-like embodiment of an electrical continuity member 1170 can make contact with both the nut 1130 and the post 1140, because it is not perfectly circular (see, for example, FIG. 42 depicted the slightly oblong shape of the continuity member 1170). This non-circular configuration may maximize the beam length between contact points, significantly reducing stress in the contact between the nut 1130, the post 1140 and the electrical continuity member 1170. Friction may also be significantly reduced because normal force is kept low based on the structural relationship of the components; and there are no edges or other friction enhancing surfaces that could scrape on the nut 1130 or post 1140. Rather, the electrical continuity member 1170 comprises just a smooth tangential-like contact between the component elements of the nut 1130 and the post 1140. Moreover, if permanent deformation of the oblong band-like continuity member 1170 does occur, it will not significantly reduce the efficacy of the electrical contact, because if, during assembly or during operation, continuity member 1170 is pushed out of the way on one side, then it will only make more substantial contact on the opposite side of the connector 1100 and corresponding connector 1100 components. Likewise, if perchance the two relevant component surfaces of the nut 1130 and the post 1140 that the band-like continuity member 1170 interacts with have varying diameters (a diameter of a radially inward surface of the nut 1130 and a diameter of a radially outward surface of the post 1140) vary in size between provided tolerances, or if the thickness of the band-like continuity member 1170 itself varies, then the band-like continuity member 1170 can simply assume a more or less circular shape to accommodate the variation and still make contact with the nut 1130 and the post 1140. The various advantages obtained through the utilization of a band-like continuity member 1170 may also be obtained, where structurally and functionally feasible, by other embodiments of electrical continuity members described herein, in accordance with the objectives and provisions of the present invention.

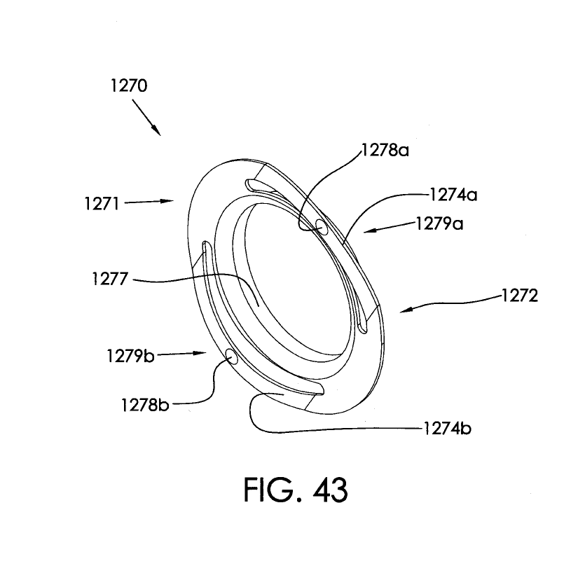

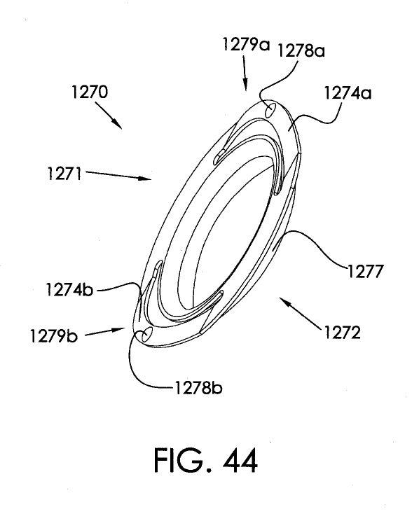

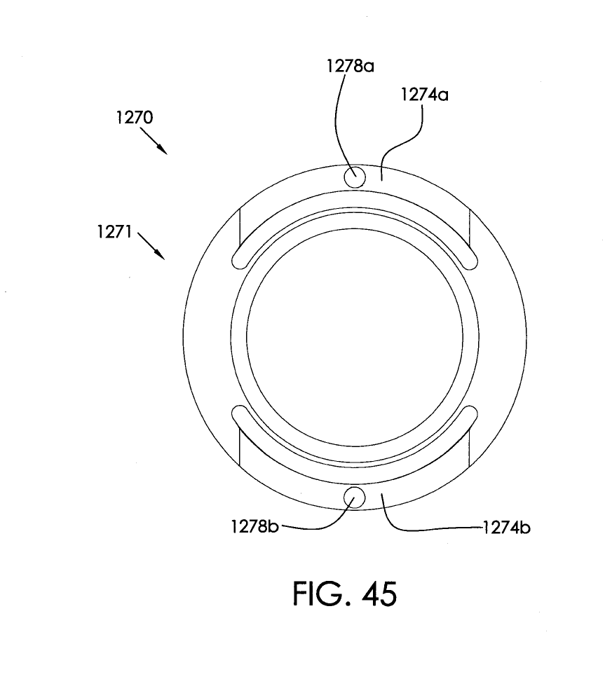

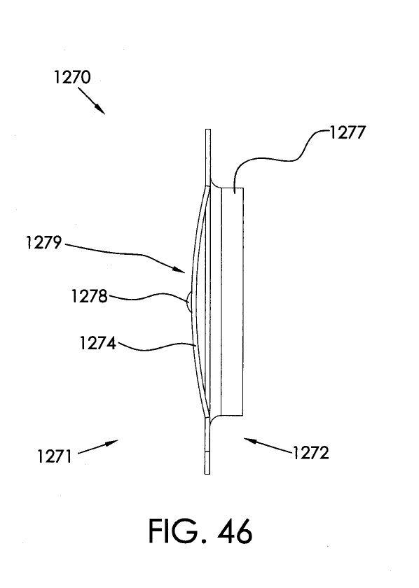

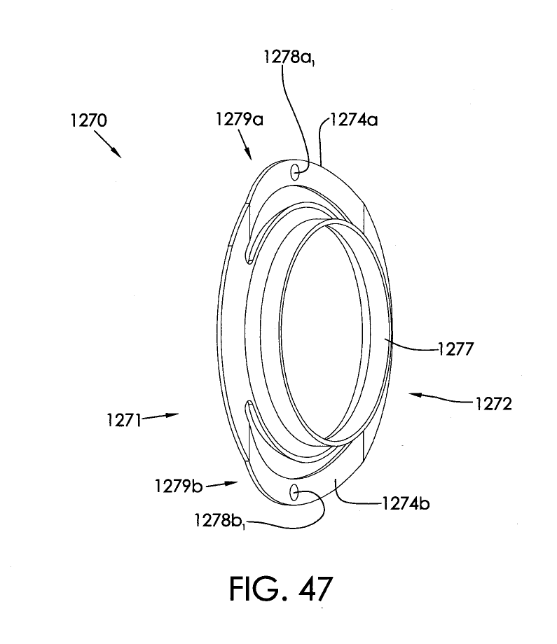

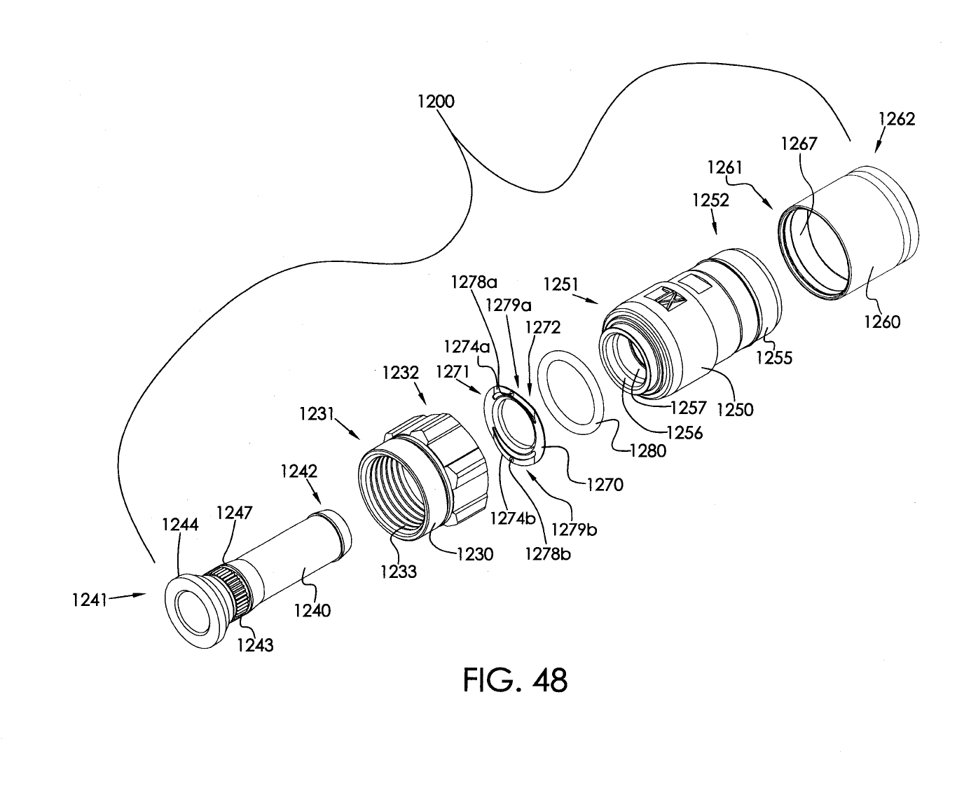

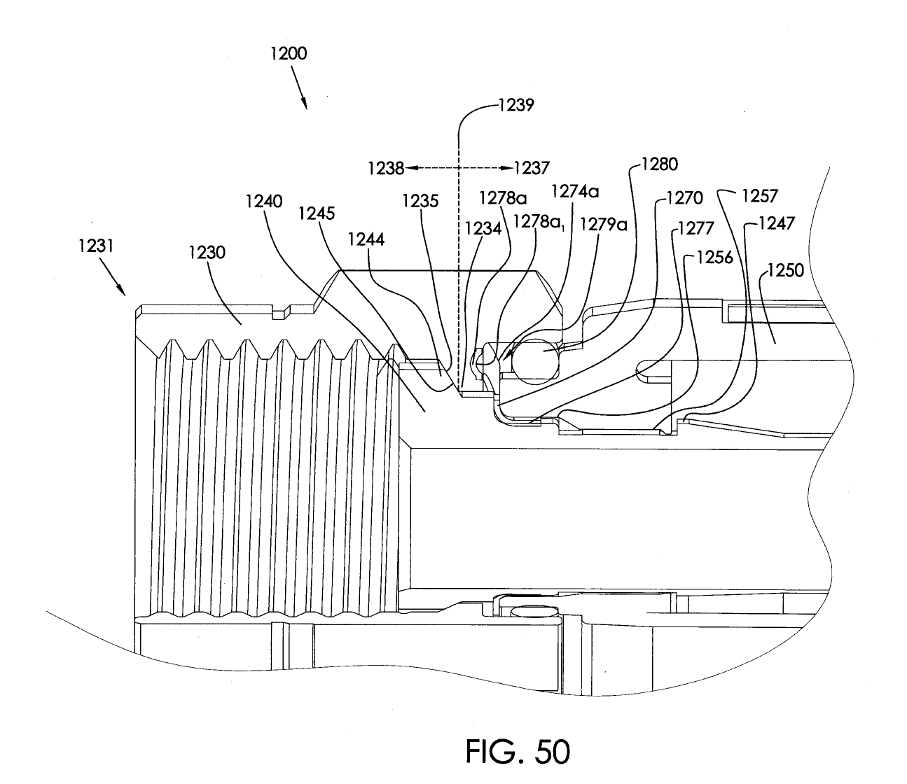

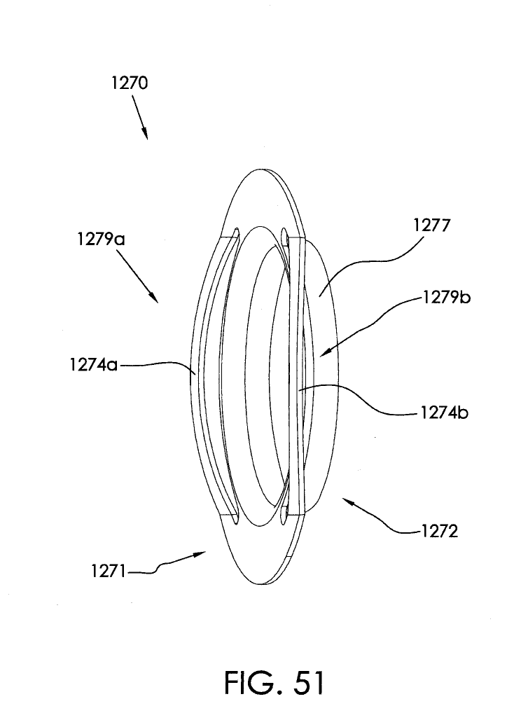

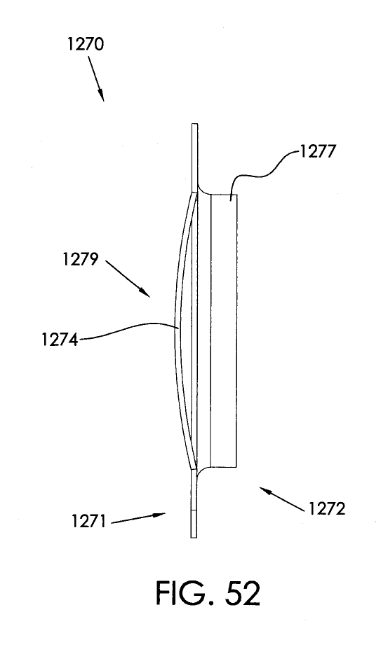

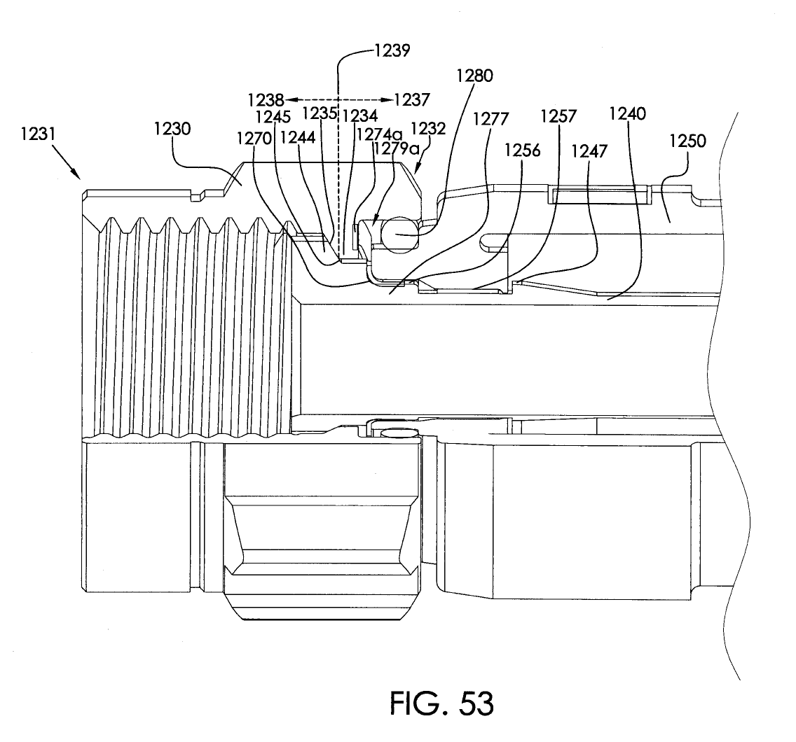

Referencing the drawings still further, it is noted that FIGS. 43-53 depict different views of another coaxial cable connector 1200, the connector 1200 including various embodiments of an electrical continuity member 1270. The electrical continuity member 1270, in a broad sense, has some physical likeness to a disc having a central circular opening and at least one section being flexibly raised above the plane of the disc; for instance, at least one raised flexible portion 1279 of the continuity member 1270 is prominently distinguishable in the side views of both FIG. 46 and FIG. 52, as being arched above the general plane of the disc, in a direction toward the first end 1271 of the continuity member 1270. The electrical continuity member 1270 may include two symmetrically radially opposite flexibly raised portions 1279a-b physically and/or functionally associated with nut contact portions 1274a-b, wherein nut contact portions 1274a-b may each respectively include a nut contact tab 1278a-b. As the flexibly raised portions 1279a-b arch away from the more generally disc-like portion of the electrical continuity member 1270, the flexibly raised portions (being also associated with nut contact portions 1274a-b) make resilient and consistent physical and electrical contact with a conductive surface of the nut 1230, when operably assembled to obtain electrical continuity in the coaxial cable connector 1200. The surface of the nut 1230 that is contacted by the nut contact portion 1274 resides within the second end portion 1237 of the nut 1230.

The electrical continuity member 1270 may optionally have nut contact tabs 1278a-b, which tabs 1278a-b may enhance the member's 1270 ability to make consistent operable contact with a surface of the nut 1230. As depicted, the tabs 1278a-b comprise a simple bulbous round protrusion extending from the nut contact portion. However, other shapes and geometric design may be utilized to accomplish the advantages obtained through the inclusion of nut contact tabs 1278a-b. The opposite side of the tabs 1278a-b may correspond to circular detents or dimples 1278a₁-b₁. These oppositely structured features 1278a₁-b₁ may be a result of common manufacturing processes, such as the natural bending of metallic material during a stamping or pressing process possibly utilized to create a nut contact tab 1278.

As depicted, embodiments of an electrical continuity member 1270 include a cylindrical section extending axially in a lengthwise direction toward the second end 1272 of the continuity member 1270, the cylindrical section comprising a post contact portion 1277, the post contact portions 1277 configured so as to make axially lengthwise contact with the post 1240. Those skilled in the art should appreciated that other geometric configurations may be utilized for the post contact portion 1277, as long as the electrical continuity member 1270 is provided so as to make consistent physical and electrical contact with the post 1240 when assembled in a coaxial cable connector 1200.

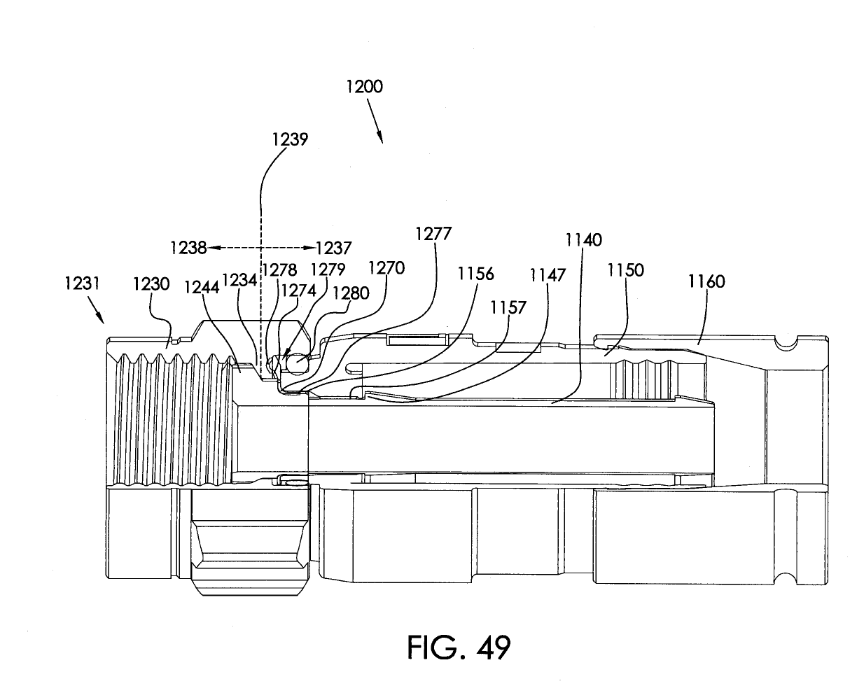

The continuity member 1270 should be configured and positioned so that, when the coaxial cable connector 1200 is assembled, the continuity member 1270 resides rearward the start of a second end portion 1237 of the nut 1230, wherein the second end portion 1237 begins at a side 1235 of the lip 1234 of the nut 1230 facing the first end 1231 of the nut 1230 and extends rearward to the second end 1232 of the nut 1230. The continuity member 1270 contacts the nut 1230 in a location relative to a second end portion 1237 of the nut 1230. The second end portion 1237 of the nut 1230 extends from the second end 1232 of the nut 1230 to the axial location of the nut 1230 that corresponds to the point of the forward facing side 1235 of the internal lip 1234 that faces the first forward end 1231 of the nut 1230 that is also nearest the second rearward end 1232 of the nut 1230. Accordingly, the first end portion 1238 of the nut 1230 extends from the first end 1231 of the nut 1230 to that same point of the side of the lip 1234 that faces the first end 1231 of the nut 1230 that is nearest the second end 1232 of the nut 1230. For convenience, dashed line 1239 (see FIGS. 49-50, and 53), depicts the axial point and a relative radial perpendicular plane defining the demarcation of the first end portion 1238 and the second end portion 1237 of embodiments of the nut 1230. As such, the continuity member 1270 does not reside between opposing complimentary surfaces 1235 and 1245 of the lip 1234 of the nut 1230 and the flange 1244 of the post 40. Rather, the continuity member 1270 contacts the nut 1230 at a location other than on the side of the lip 1234 of the nut 1230 that faces the flange 1244 of the post 1240, at a rearward location only pertinent to the second end 1237 portion of the nut 1230.

Various other component features of a coaxial cable connector 1200 may be included with a connector 1200. For example, the connector body 1250 may include an internal detent 1256 positioned to help accommodate the operable location of the electrical continuity member 1270 as located between the post 1240, the body 1250, and the nut 1230. Moreover, the connector body 1250 may include a post mounting portion 1257 proximate the first end 1251 of the body 1250, the post mounting portion 1257 configured to securely locate the body 1250 relative to a portion 1247 of the outer surface of post 1240, so that the connector body 1250 is axially secured with respect to the post 1240. Notably, the nut 1230, as located with respect to the electrical continuity member 1270 and the post 1240, does not touch the body. A body sealing member 1280 may be positioned proximate the second end portion of the nut 1230 and snugly around the connector body 1250, so as to form a seal in the space therebetween.

With respect to FIGS. 1-53, a method of obtaining electrical continuity for a coaxial cable connection is described. A first step includes providing a coaxial cable connector 100/900/1000/1100/1200 operable to obtain electrical continuity. The provided coaxial cable connector 100/900/1000/1100/1200 includes a connector body 50/950/1050/1150/1250 and a post 40/940/1040/1140/1240 operably attached to the connector body 50/950/1050/1150/1250, the post 40/940/1040/1140/1240 having a flange 44/944/1044/1144/1244. The coaxial cable connector 100/900/1000/1100/1200 also includes a nut 30/930/1030/1130/1230 axially rotatable with respect to the post 40/940/1040/1140/1240 and the connector body 50/950/1050/1150/1250, the nut 30/930/1030/1130/1230 including an inward lip 34/934/1034/1134/1234. In addition, the provided coaxial cable connector includes an electrical continuity member 70/170/270/370/470/570/670/770/870/970/1070/1170/1270 disposed axially rearward of a surface 35/935/1035/1135/1235 of the internal lip 34/934/1034/1134/1234 of the nut 30/930/1030/1130/1230 that faces the flange 44/944/1044/1144/1244 of the post 40/940/1040/1140/1240. A further method step includes securely attaching a coaxial cable 10 to the connector 100/900/1000/1100/1200 so that the grounding sheath or shield 14 of the cable electrically contacts the post 40/940/1040/1140/1240. Moreover, the methodology includes extending electrical continuity from the post 40/940/1040/1140/1240 through the continuity member 70/170/270/370/470/570/670/770/870/970/1070/1170/1270 to the nut 30/930/1030/1130/1230. A final method step includes fastening the nut 30/930/1030/1130/1230 to a conductive interface port 20 to complete the ground path and obtain electrical continuity in the cable connection, even when the nut 30/930/1030/1130/1230 is not fully tightened onto the port 20, because only a few threads of the nut onto the port are needed to extend electrical continuity through the nut 30/930/1030/1130/1230 and to the cable shielding 14 via the electrical interface of the continuity member 70/170/270/370/470/570/670/770/870/970/1070/1170/1270 and the post 40/940/1040/1140/1240.

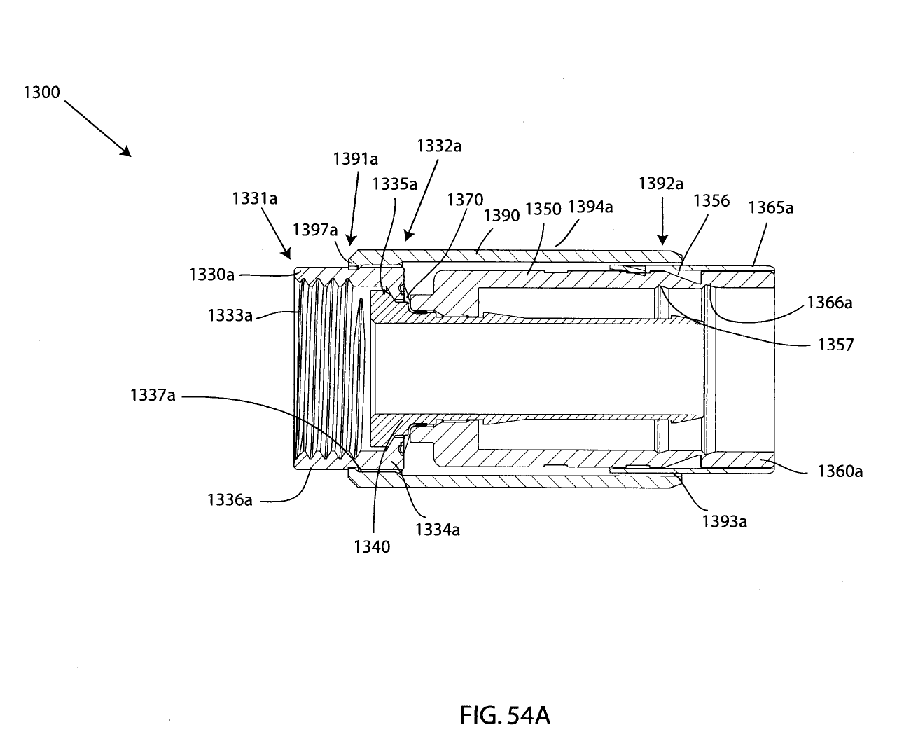

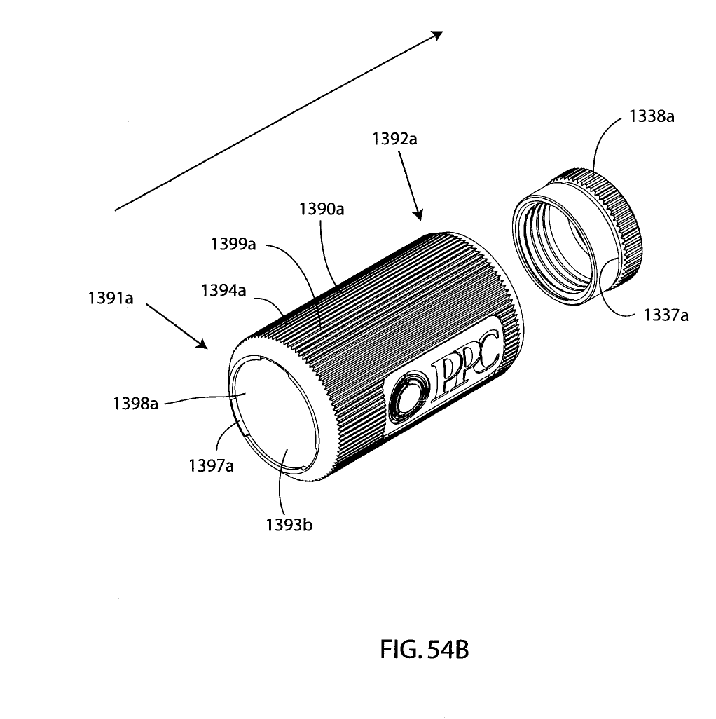

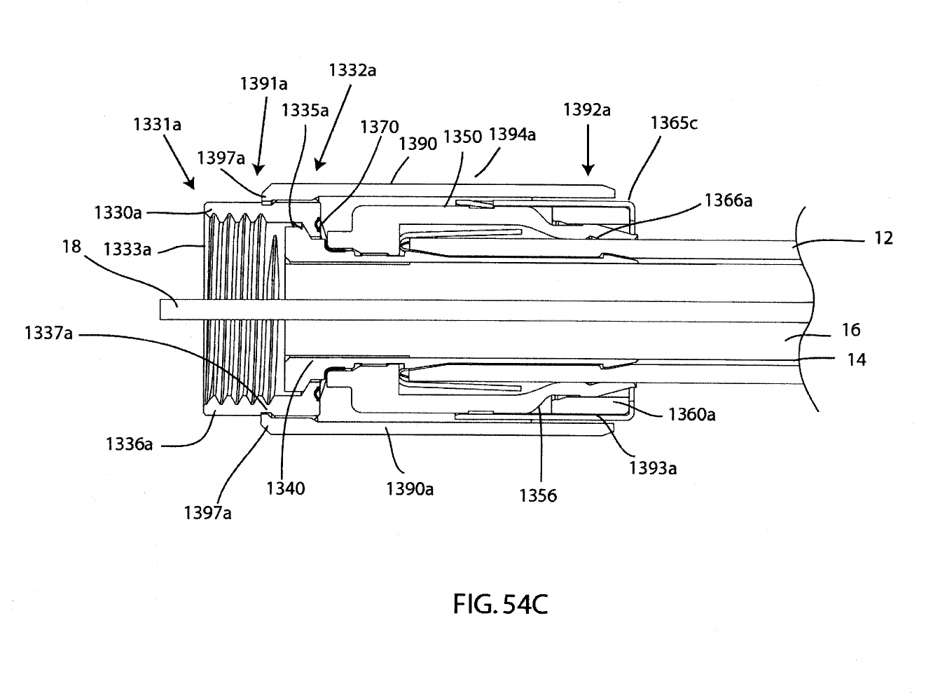

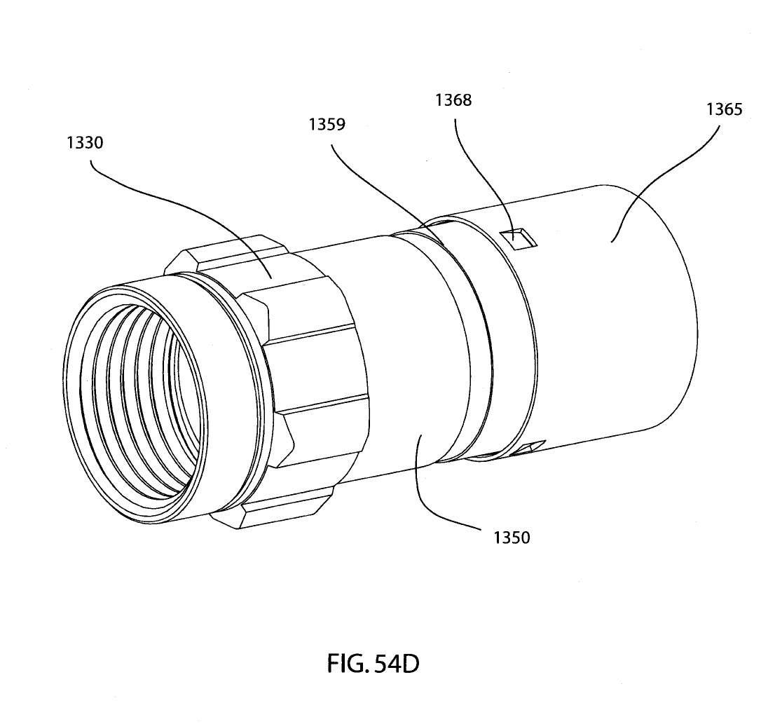

Referring now to FIGS. 54A-77, embodiments of connector 1300-1323 may include a coupling member 1330, a post 1340, a connector body 1350, a continuity member 1370, a sleeve 1390, a compression portion 1360, and a radial restriction member 1365. Embodiments of coupling member 1330 may be coupling member 1330a, 1330b, or 1330c described in further detail infra. Embodiments of sleeve 1390 may be sleeve 1390a, 1390b, 1390c, 1390d, 1390e, 1390f, 1390g, or 1390h, described in further detail infra. Similarly, embodiments of compression portion 1360 may be 1360a, described in further detail infra. Embodiments of radial restriction member 1365 may be 1365a, 1365b, or 1365c, described in further detail infra. Furthermore, embodiments of post 1340 and connector body 1350 may share the same or substantially the same structural and functional aspects of the embodiments of post 40/940/1040/1140/1240 and connector body 50/950/1050/1150/1250 described supra. Embodiments of continuity member 1370 may be disposed in the same or substantially the same location in a connector 100/900/1000/1100/1200/1300-1323 and may share the same structural and functional aspects of continuity member 70/170/270/370/470/570/670/970/1070/1170/1270, as described supra. However, continuity member 1370 may share the same structural and functional aspects of continuity member 770/870 if a connector body, such as connector body 1350, is appropriately modified to accommodate the continuity member, such as continuity member 770/870. Connectors 1300-1323 may come in a preassembled configuration or may require additional operable attachment of the sleeve 1390 to connector 1300-1323 during installation.

With reference to FIG. 54A, embodiments of connector 1300 may include a coupling member 1330a, a post 1340, a connector body 1350, a continuity member 1370, an outer sleeve 1390a, a compression portion 1360a, and a radial restriction member 1365a.

Embodiments of connector 1300 may include a coupling member 1330a. Coupling member 1330a may share some of the structural and functional aspects of nut 30/930/1030/1130/1230, such as being mated, threaded or otherwise, to a corresponding interface port 20. Further, the coupling member 1330a may include a first end 1331a, a second end 1332a, an inner surface 1333a, an outer surface 1336a, an internal lip 1334a, such as an annular protrusion, located proximate the second rearward end 1332a of the coupling member 1330a, wherein the internal lip 1334a includes a surface 1335a facing the first forward end 1331a of the coupling member 1330a. However, the internal lip 1334a of coupling member 1330a may define the second end 1332a of the coupling member 1330a, eliminating excess material from the coupling member 1330a. Located somewhere on the outer surface 1336a of the coupling member 1330a may be a retaining structure 1337a. The retaining structure 1337a of the coupling member 1330a may be an annular groove or recess that extends completely or partially around the outer surface 1336a of the coupling member 1330a to retain, accommodate, receive, or mate with an engagement member 1397 of the sleeve 1390. Alternatively, the retaining structure 1337a may be an annular protrusion that extends completely or partially around the outer surface 1336a of the coupling member 1330a to retain or mate with the engagement member 1397 of the sleeve 1390. The retaining structure 1337a may be placed at various axial positions from the first end 1331a to the 1332a, depending on the configuration of the sleeve 1390 and other design requirements of connector 1300.

Moreover, embodiments of coupling member 1330a may include an outer surface feature 1338a proximate or otherwise near the second end 1332a to improve mechanical interference or friction between the coupling member 1330a and the sleeve 1390. For instance, the outer surface feature 1338a may extend completely or partially around the outer surface 1336a proximate the second 1332a of the coupling member 1330a to increase a retention force between an inner surface 1393 of the sleeve 1390 and the outer surface 1336a of the coupling member 1330a. The outer surface feature 1338a may include a knurled surface, a slotted surface, a plurality of bumps, ridges, grooves, or any surface feature that may facilitate contact between the sleeve 1390 and the coupling member 1330a. In one embodiment, the coupling member 1330 may be referred to as a press-fit nut. Embodiments of the coupling member 1330a may be formed of conductive materials, such as copper, brass, aluminum, or other metals or metal alloys, facilitating grounding through the coupling member 1330a. Accordingly, the coupling member 1330a may be configured to extend an electromagnetic buffer by electrically contacting conductive surfaces of an interface port 20 when connector 1300 is advanced onto the port 20.

Embodiments of connector 1300 may also include an outer sleeve 1390a. The sleeve 1390a may be engageable with the coupling member 1330a. The sleeve 1390a may include a first end 1391a, a second 1391a, an inner surface 1393a, and an outer surface 1394a. The sleeve 1390a may be a generally annular member having a generally axial opening therethrough. The sleeve 1390a may be radially disposed over the coupling member 1330a, or a portion thereof, the connector body 1350, or a portion thereof, and the compression portion 1360 and radial restriction member 1365, or a portion thereof, while operably assembled and/or in a compressed position. Proximate or otherwise near the first end 1391a, the sleeve 1390a may include an engagement member 1397a configured to mate or engage with the retaining structure 1337 of the coupling member 1330. The engagement member 1397a may be an annular lip or protrusion that may enter or reside within the retaining structure 1337 of the coupling member 1330. For example, in embodiments where the retaining structure 1337 is an annular groove, the engagement member 1397a may be a protrusion or lip that may snap into the groove located on the coupling member 1330 to retain the sleeve 1390a in a single axial position. In other words, the cooperating surfaces of the groove-like retaining structure 1337 and the lip or protruding engagement member 1397a may prevent axial movement of the sleeve 1390a once the connector 1300 is in an assembled configuration. Alternatively, the engagement member 1397a may be an annular groove or recess that may receive or engage with the retaining structure 1337 of the coupling member 1330. For example, in embodiments where the retaining structure 1337 of the coupling member 1330 is an annular protrusion, the engagement member 1397a may be a groove or recess that may allow the annular protruding retaining structure 1337 of the coupling member 1330 to snap into to retain the sleeve 1390a in a single axial position. In other words, the cooperating surfaces of the protruding retaining structure 1337 and the groove-like engagement member 1397a may prevent axial movement of the sleeve 1390a once the connector 1300 is in an assembled configuration. Those having skill in the art should understand that various surface features effectuating cooperating surfaces between the coupling member 1330 and the sleeve 1390a may be implemented to retain the sleeve 1390a with respect to the rest of the connector 1300 in an axial direction. Furthermore, the engagement member 1397a of the sleeve 1390a may be segmented such that one or more gaps may separate portions of the engagement member 1397a, while still providing sufficient structural engagement with the retaining structure 1337.

An embodiment of an assembled configuration of connector 1300 with respect to the sleeve 1390a may involve sliding the sleeve 1390a over the coupling member 1330 in an axial direction starting from the first end 1331 and continuing toward the second end 1332 of the coupling member 1330 until sufficient mating and/or engagement occurs between the engagement member 1397a of the sleeve 1390a and the retaining structure 1337 of the coupling member 1330, as shown in FIG. 54B. Once in the assembled configuration, rotation of the sleeve 1390a may in turn cause the coupling member 1330 to simultaneously rotate in the same direction as the sleeve 1390a due to mechanical interference between the inner surface 1393a of the sleeve 1390a and the outer surface 1336 of the coupling member 1330. In some embodiments, the interference between the sleeve 1390a and the coupling member 1330 relies simply on a friction fit or interference fit between the components. Other embodiments include a coupling member 1330 with an outer surface feature 1338, as described supra, to improve the mechanical interference between the components. Further embodiments include a sleeve 1390a with internal surface features 1398a positioned on the inner surface 1393a to improve the contact between the components. Even further embodiments of connector 1300 may include a sleeve 1390a and a coupling member 1330a both having surface features 1398a, 1338a, respectively. Embodiments of the inner surface features 1398a of the sleeve 1390a may include a knurled surface, a slotted surface, a plurality of bumps, ridges, grooves, or any surface feature that may facilitate contact between the sleeve 1390a and the coupling member 1330. In many embodiments, the inner surface features 1398a of the sleeve 1390a and the inner surface features 1338 of the coupling member may structurally correspond with each other. For example, the inner geometry of the sleeve 1390a may reflect and/or structurally correspond with the outer geometric shape of the coupling member 1330. Due to the engagement between the sleeve 1390a and the coupling member 1330, a user may simply grip and rotate/twist the sleeve 1390a to thread the coupling element 1330 onto an interface port, such as interface port 20. Further still, embodiments of the sleeve 1390a may include outer surface features 1399a, such as annular serrations or slots, configured to enhance gripping of the sleeve 1390a while connecting the connector 1300 onto an interface port. The sleeve 1390a may be formed of materials such as plastics, polymers, bendable metals or composite materials that facilitate a rigid body. Further, the sleeve 1390a may be formed of conductive or non-conductive materials or a combination thereof. Manufacture of the sleeve 1390a may include casting, extruding, cutting, turning, drilling, knurling, injection molding, spraying, blow molding, component overmolding, combinations thereof, or other fabrication methods that may provide efficient production of the component.

Referring still to FIG. 54A, embodiments of connector 1300 may include a compression portion 1360a. Compression portion 1360a may be operably attached to the connector body 1350. For instance, the compression portion 1360a may be structurally integral with the connector body 1350, wherein the compression portion 1360a separates from the connector body 1350 upon an axial force which in turn radially compresses the second end of the connector body 1350 onto the coaxial cable 10, as shown in FIG. 54C. In other words, the compression portion 1360a may have a frangible connection with the connector body 1350. The structural connection between the connector body 1350 and the compression portion 1360a may be thin or otherwise breakable when compressive, axial force is applied (e.g. by an axial compression tool). Moreover, the structural connection or configuration between the connector body 1350 and the compression portion 1360a may be defined by an internal annular notch 1366a or groove of the compression portion 1360a and an outer ramped surface 1356 of the connector body 1350. The connector body 1350 may further include an internal annular notch 1357 or groove to structurally facilitate the deformation of the connector body 1350 proximate a rearward second end. The compression portion 1360a may be formed of the same material as connector body 1350 because they may be structurally integral with each other. For example, the compression portion 1360a may be comprised of materials such as plastics, polymers, bendable metals or composite materials that facilitate a rigid body. Further, the compression portion 1360a may be formed of conductive or non-conductive materials or a combination thereof. Manufacture of the compression member 1360a may include casting, extruding, cutting, turning, drilling, knurling, injection molding, spraying, blow molding, component overmolding, combinations thereof, or other fabrication methods that may provide efficient production of the component.

Furthermore, embodiments of connector 1300 may include a radial restriction member 1365a. The radial restriction member 1365a may be a bushing or similar annular tubular member disposed proximate the rearward second end of the connector body 1350. For instance, the radial restriction member 1365a may surround the compression portion 1360a and a portion of the connector body 1350 proximate the rearward second end. The radial restriction member 1365a may be a generally annular, hollow cylindrically-shaped sleeve-like member comprised of stainless steel or other substantially rigid materials which may structurally assist the crack and seal process of compression portion 1360a. For instance, when the compression portion 1360a is axially compressed in a direction towards the coupling member 1330, the radial restriction member 1365a may axially displace along with the compression portion 1360a and may prevent the compression portion 1360a from splintering or otherwise displacing in a direction other than substantially axial towards the coupling member 1330.

Moreover, the radial restriction member 1365a may include one or more gripping features 1368 for engagement with the connector body 1350, as shown in FIG. 54D. The gripping features 1368 may be inward protrusions configured to engage with a lip 1359 on the outer surface of the connector body 1350. For instance, the lip 1359 of the connector body 1350 may outwardly protrude a radial distance away from the outer surface of the connector body 1350, while the gripping feature 1368 of the radial restriction member 1365a may inwardly protrude from an inner surface of the radial restriction member 1365a. When the connector, such as connector 1300, is axially compressed in a direction towards the coupling member 1330, the radial restriction member 1365a may be axially displaced towards the coupling member 1330. After axially displacing a certain distance towards the coupling member 1330 upon application of an axially compressive force, the gripping features 1368 may pass the lip of the connector body 1350, and then securably engage the lip of the connector body 1350 to prevent axial displacement of the radial restriction member 1365a in a direction opposite the coupling member 1330. In some embodiments, the gripping features 1368 may be an inwardly extending ramped surface to alleviate restrictive mechanical interference between the gripping feature 1368 of the radial restriction member 1365a and the outer surface of the connector body 1350 as the connector is axially compressed, and may increase the retention force created by the securable engagement between the lip of the connector body 1350 and the radial restriction member 1365a. The gripping feature 1368, as described in association with radial restriction member 1365a, may also be present in embodiments of radial restriction member 1365c, described supra.

Embodiments of the compression portion 1360a may create an environmental seal around the coaxial cable 10 when in the fully compressed position. Specifically, when the compression portion 1360 (and potentially the radial restriction member 1365a) is axially slid towards the coupling member 1330, the structural connection between the compression portion 1360a and the connector body 1350 is severed and the compression portion 1360a comes into contact with the outer ramped surface 1356 of the connector body 1350. The severing of the structural connection between the connector body 1350 and the compression portion 1360a essentially turns the internal notch 1366a into a cooperative ramped surface with the outer ramped surface 1356 of the connector body 1350. Due to the cooperative ramped surfaces, the axial compression (displacement) of the compression portion 1360a evenly compresses the second end of the connector body 1350 onto the outer jacket 12 of the coaxial cable and deforms the outer ramped surface 1356, as shown in FIG. 54C. Accordingly, the compression portion 1360a and potentially the radial restriction member 1365a may be referred to as a crack and seal compression means with a radial restriction member 1365a. Those skilled in the requisite art should appreciate that the seal may be created by the compression portion 1360a without the radial restriction member 1365a. However, the radial restriction member 1365a significantly enhances the structural integrity and functional operability of the compression portion, for example, when it is compressed and sealed against an attached coaxial cable 10.

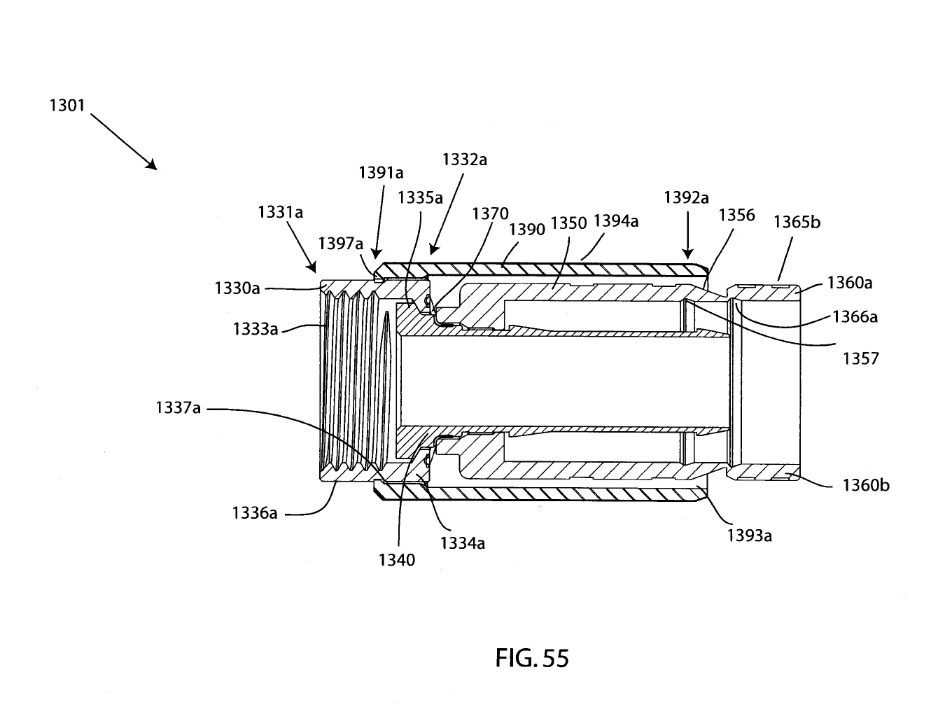

Referring now to FIG. 55, embodiments of connector 1301 may include a coupling member 1330a, a post 1340, a connector body 1350, a continuity member 1370, a sleeve 1390a, a compression portion 1360a, and a radial restriction member 1365b. Radial restriction member 1365b may share the same or substantially the same function as radial restriction member 1365a. However, radial restriction member 1365 may be one or more straps or bands that extend annularly around or partially around the compression portion 1360a. The radial restriction member 1365b may be structurally attached to the compression portion 1360a in a variety of methods, such as press-fit, adhesion, cohesion, fastened, etc. For instance, the radial restriction member 1365b may reside within annular notches or grooves in the compression portion 1360a. The notches or grooves may have various depths to allow the radial restriction member 1365b to be flush with the outer surface of the compression portion 1360a, to protrude from the outer surface of the compression portion 1360a, or to reside completely beneath the outer surface of the compression portion 1360a. Moreover, the radial restriction member 1365b may be comprised of stainless steel or other substantially rigid materials which may structurally assist the crack and seal process of compression portion 1360a. For instance, when the compression portion 1360a is axially compressed in a direction towards the coupling member 1330, the radial restriction member 1365b may prevent the compression portion 1360a from splintering or otherwise displacing in a direction other than substantially axial towards the coupling member 1330.

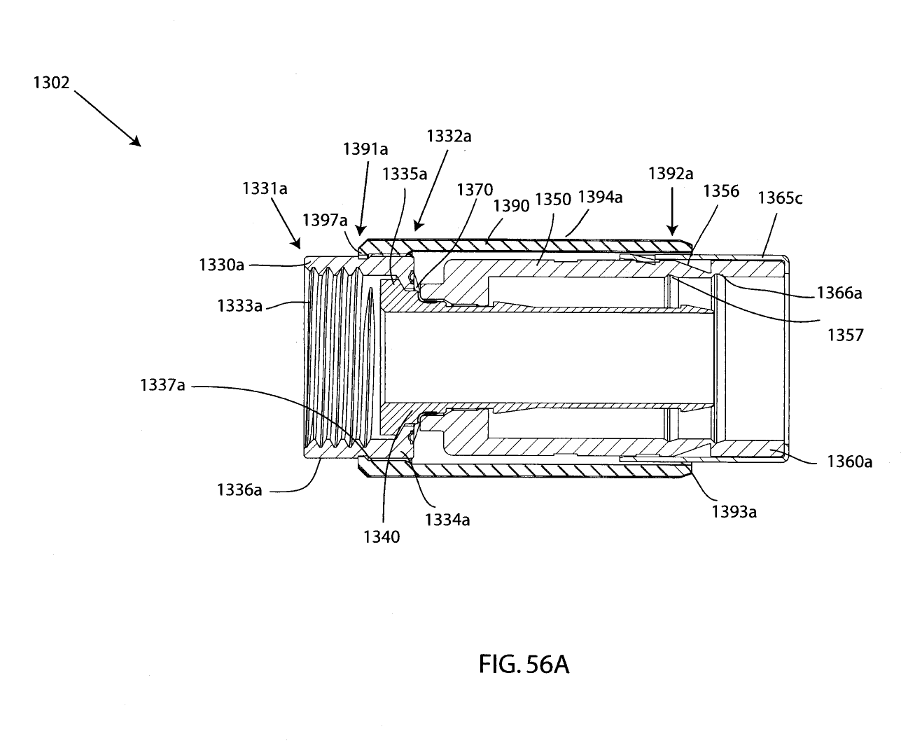

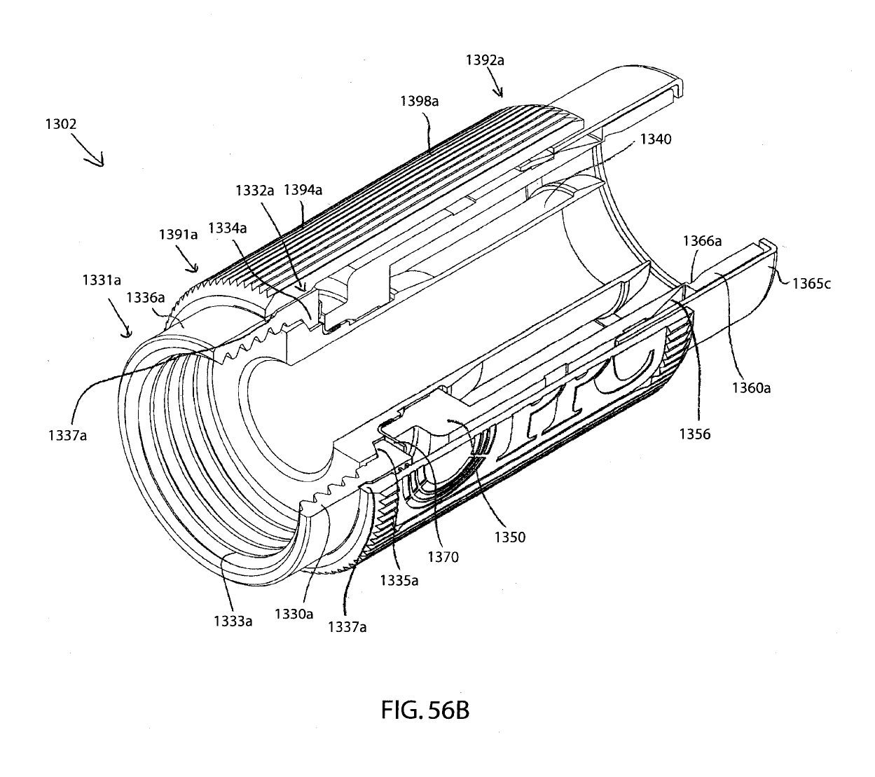

Referring now to FIGS. 56A and 56B, embodiments of connector 1302 may include a coupling member 1330a, a post 1340, a connector body 1350, a continuity member 1370, an outer sleeve 1390a, a compression portion 1360a, and a radial restriction member 1365c. Radial restriction member 1365c may share the same or substantially the same function as radial restriction member 1365a. However, radial restriction member 1365c may be a cap member, or similar generally annular, tubular member having an engagement surface for operable engagement with a compression tool. For instance, embodiments of the radial restriction member 1365c may include an internal annular lip or inwardly extending flange proximate a rearward end of the radial restriction member 1365c. The radial restriction member 1365c may surround or partially surround the compression portion 1360a and a portion of the connector body 1350 proximate the rearward second end, wherein the internal annular lip of the radial restriction member 1365c may be configured to contact the compression portion 1360a prior to or upon axial compression of the connector 1302. The radial restriction member 1365c may be comprised of stainless steel or other substantially rigid materials which may structurally assist the crack and seal process of compression portion 1360a. For instance, when the compression portion 1360a is axially compressed in a direction towards the coupling member 1330, the radial restriction member 1365c may axially displace along with the compression portion 1360a and may prevent the compression portion 1360a from splintering or otherwise displacing in a direction other than substantially axial towards the coupling member 1330. Additionally, the internal lip proximate the rearward end of the radial restriction member 1365c may provide an engagement surface for operable engagement with a compression tool, or other device/means that provides the necessary compression to compress seal connector 1302.

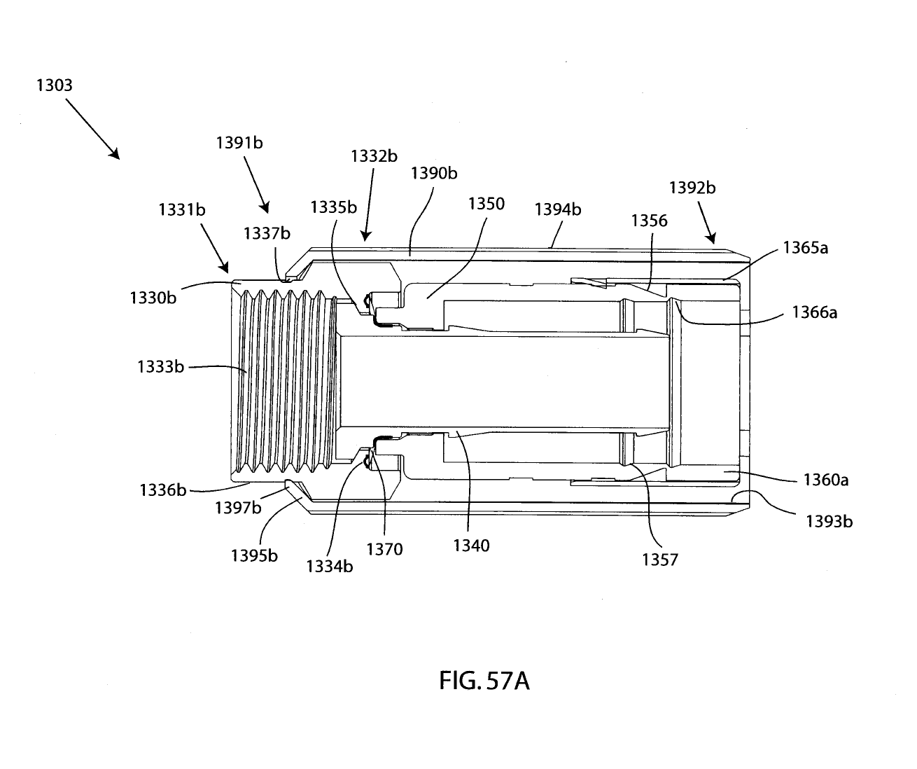

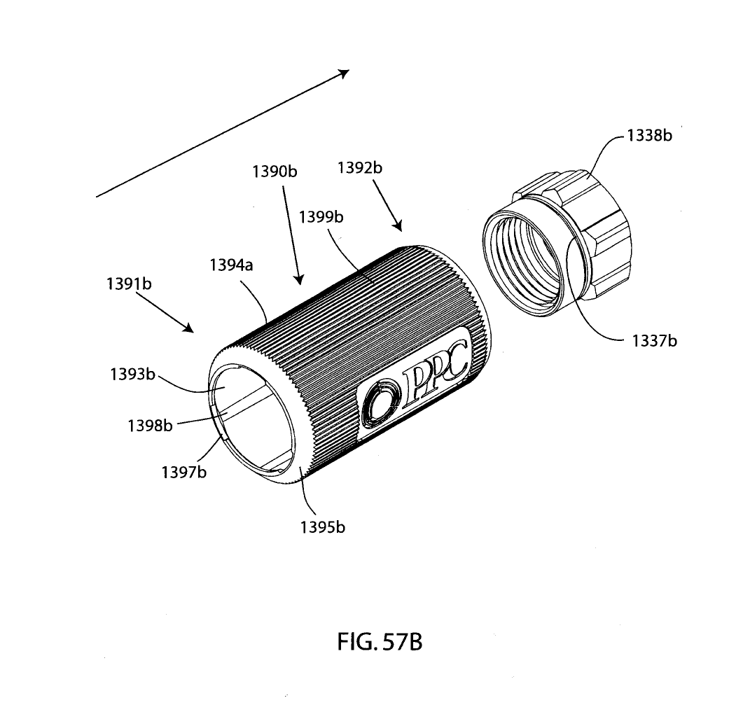

FIG. 57A depicts an embodiment of connector 1303, which includes a coupling member 1330b, a post 1340, a connector body 1350, a continuity member 1370, a sleeve 1390b, a compression portion 1360a, and a radial restriction member 1365a.

Embodiments of connector 1303 may include a coupling member 1330b. Coupling member 1330b may share the same or substantially the same structural and functional aspects of the embodiments of nut 30/930/1030/1130/1230, such as being mated, threaded or otherwise, to a corresponding interface port 20. Accordingly, coupling member 1330b may include a first end 1331b, a second end 1332b, an inner surface 1333b, an outer surface 1336b, an internal lip 1334b, such as an annular protrusion, located proximate the second rearward end 1332b of the coupling member 1330b, wherein the internal lip 1334b includes a surface 1335b facing the first forward end 1331b of the coupling member 1330b. Additionally, coupling member 1330b may include a retaining structure 1337b on the outer surface 1336b of the coupling member 1330b. The retaining structure 1337b of the coupling member 1330b may be an annular groove or recession that extends completely or partially around the outer surface 1336b of the coupling member 1330b to retain, accommodate, receive, or mate with an engagement member 1397 of the sleeve 1390. Alternatively, the retaining structure 1337b may be an annular protrusion that extends completely or partially around the outer surface 1336b of the coupling member 1330b to retain or mate with the engagement member 1397 of the sleeve 1390. The retaining structure 1337b may be placed at various axial positions from the first end 1331b to the 1332b, depending on the configuration of the sleeve 1390 and other design requirements of the connector.

Moreover, embodiments of coupling member 1330b may include an outer surface feature(s) 1338b proximate or otherwise near the second end 1332a to improve mechanical interference or friction between the coupling member 1330b and the sleeve 1390. For instance, the outer surface feature(s) 1338a may extend completely or partially around the outer surface 1336b proximate the second 1332b of the coupling member 1330b to increase a retention force between an inner surface 1393 of the sleeve 1390b and the outer surface 1336b of the coupling member 1330b. The outer surface feature 1338b may include a plurality of planar surfaces that may facilitate contact between the sleeve 1390 and the coupling member 1330b. Embodiments of the coupling member 1330b may be formed of conductive materials, such as copper, brass, aluminum, or other metals or metal alloys, facilitating grounding through the coupling member 1330b. Accordingly, the coupling member 1330b may be configured to extend an electromagnetic buffer by electrically contacting conductive surfaces of an interface port 20 when the coaxial cable connector is advanced onto the port 20.

Embodiments of connector 1303 may also include a sleeve 1390b. Sleeve 1390b may share the same structural and functional aspects of sleeve 1390a described in association with, for example, connector 1300. Accordingly, sleeve 1390b may include an engagement member 1397b that is configured to mate or engage with a retaining structure 1337b of the coupling member 1330b. For example, the sleeve 1390b may include a first end 1391b, a second end 1392b, an inner surface 1393b, and an outer surface 1394b, and may be a generally annular member having a generally axial opening therethrough. However, the sleeve 1390b may be radially disposed over the coupling member 1330b, or a portion thereof, the connector body 1350, or a portion thereof, the compression portion 1360, or a portion thereof, and the radial restriction member 1365 while operably assembled and/or in a compressed position. Additionally, the sleeve 1390b may include an annular ramped surface 1395b or chamfer proximate or otherwise near the first end 1391b to accommodate an increased diameter or general size of the coupling member 1330b proximate a second, rearward end 1332b of the coupling member 1330b. Embodiments of the ramped surface 1395b may be structurally integral with the engagement member 1397b and the body of the sleeve 1390b. Furthermore, embodiments of an assembled configuration of connector 1303 with respect to the sleeve 1390b may involve sliding the sleeve 1390b over the coupling member 1330b in an axial direction starting from the first end 1331b and continuing toward the second end 1332b of the coupling member 1330 until sufficient mating and/or engagement occurs between the engagement member 1397b of the sleeve 1390b and the retaining structure 1337 of the coupling member 1330, as shown in FIG. 57B. Sleeve 1390b may also include outer surface feature(s) 1399b, such as annular serrations or slots, configured to enhance gripping of the sleeve 1690 while connecting the coaxial cable connector onto an interface port.

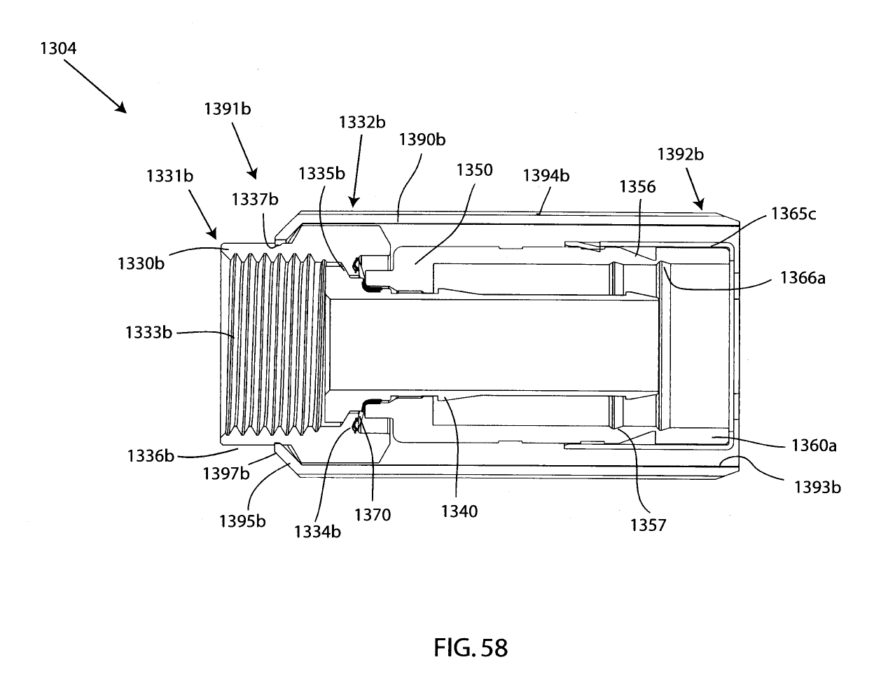

FIG. 58 depicts an embodiment of connector 1304. Embodiments of connector 1304 may include a coupling member 1330b, a post 1340, a connector body 1350, a continuity member 1370, an outer sleeve 1390b, a compression portion 1360a, and a radial restriction member 1365c.

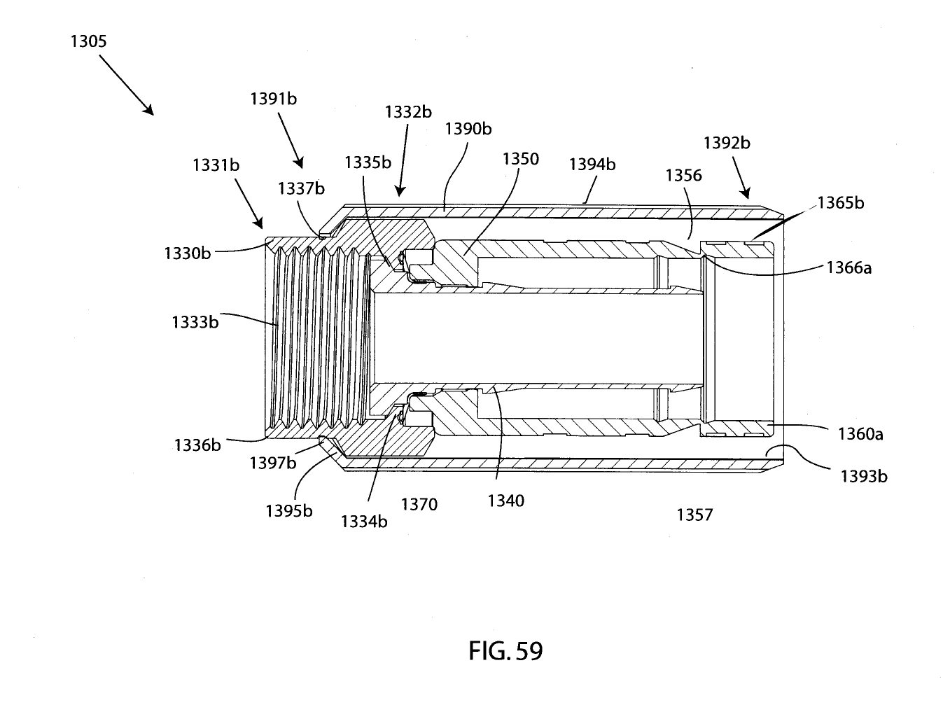

FIG. 59 depicts an embodiment of connector 1305. Embodiments of connector 1305 may include a coupling member 1330b, a post 1340, a connector body 1350, a continuity member 1370, a sleeve 1390b, a compression portion 1360a, and a radial restriction member 1365b.

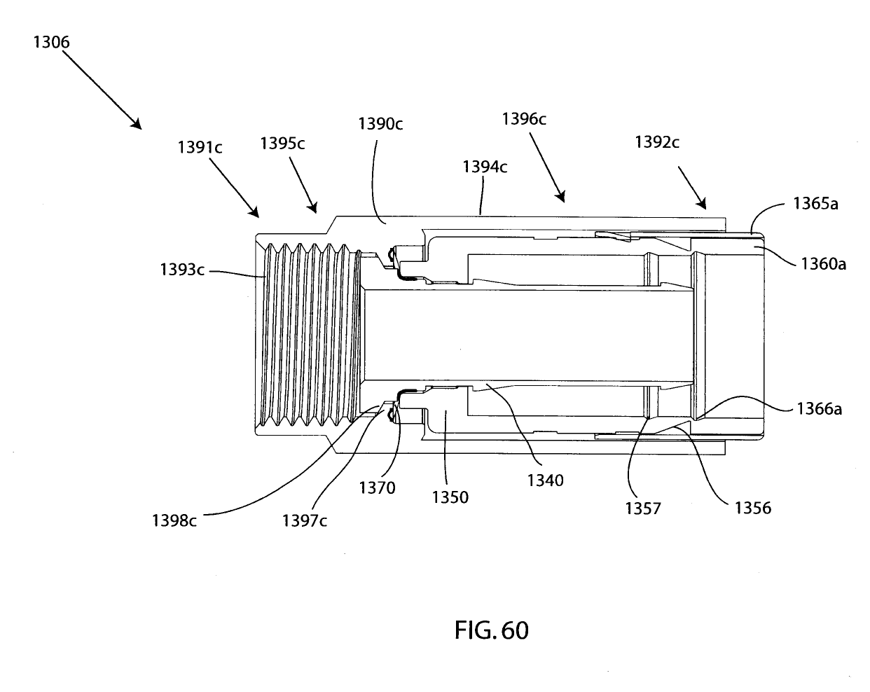

Referring still to the drawings, FIG. 60 depicts an embodiment of connector 1306. Embodiments of connector 1306 may include an integral sleeve 1390c, a post 1340, a connector body 1350, a continuity member 1370, a compression portion 1360a, and a radial restriction member 1365a.

Embodiments of connector 1306 may include an integral sleeve 1390c. An integral sleeve 1390c may be a generally annular member having a generally axial opening therethrough. The integral sleeve 1390c may include a first end 1391c, a second end 1392c, an outer surface 1393c, and an outer surface 1394c. Furthermore, the integral sleeve 1390c may include a coupling portion 1395c proximate the first end 1391c and a body portion 1396c structurally integral with the coupling portion 1395c. The coupling portion 1395c may include internal threads for operable engagement with an interface port, such as interface port 20. For instance, the internal threads of the coupling portion 1395c of the integral sleeve 1390c may correspond to threads on the outer surface of an interface port. The coupling portion 1395c may also include an internal lip 1397c, such as an annular protrusion. The internal lip 1397c includes a surface 1398c facing the first forward end 1391c of the integral sleeve 1390c. The forward facing surface 1398c of the lip 1397c may be a tapered surface that corresponds to a tapered surface of the post 1340. The forward facing surface 1398c of the coupling portion 1395c faces the flange of the post 1340 when operably assembled in a connector 1306, so as to allow the integral sleeve 1390c to rotate with respect to the other component elements, such as the post 1340 and the connector body 1350. The structural configuration of the coupling portion 1395c of integral sleeve 1390c may vary according to differing connector design parameters to accommodate different functionality of a coaxial cable connector. For instance, the first forward end 1391c of the integral sleeve 1390c may include internal and/or external structures such as ridges, grooves, curves, detents, slots, openings, chamfers, or other structural features, etc., which may facilitate the operable joining of an environmental sealing member, such a water-tight seal or other attachable component element, that may help prevent ingress of environmental contaminants, such as moisture, oils, and dirt, at the first forward end 1391c of the integral sleeve 1390c, when mated with an interface port 20. Those in the art should appreciate that the coupling portion 1395c need not be threaded.

Moreover, the integral sleeve 1390c includes a body portion 1396c that may be structurally integral with the coupling portion 1395c to form an outer sleeve that may surround the continuity member 1370, the post 1340, the connector body 1350, the compression portion 1360, or a portion thereof, and the radial restriction member 1365, or a portion thereof when in an assembled and/or compressed position. Because the body portion 1396c may be structurally integral with the coupling portion 1395c, rotation or twisting of the body portion 1396c can cause rotation or twisting of the coupling portion 1395c to operably mate a coaxial cable connector, such as connector 1306 onto an interface port. Thus, the integral sleeve 1390c includes a larger surface area to grip and twist the integral sleeve 1390c to thread the coupling portion 1395c fully onto the interface port, such as interface port 20. Embodiments of the body portion 1396c of the integral sleeve 1390c may include outer surface features, such as annular serrations or slots, configured to enhance gripping of the integral sleeve 1390c while connecting the coaxial cable connector onto an interface port. The body portion 1396c of the sleeve 1390c may be formed of materials such as plastics, polymers, bendable metals or composite materials that facilitate a rigid body, while the coupling portion 1395c may be formed of conductive materials, such as copper, brass, aluminum, or other metals or metal alloys, facilitating grounding through the connector 1306. In other words, the integral sleeve 1390c may be formed of both conductive and non-conductive materials. For example, the external surface of the coupling portion 1395c of the integral sleeve 1390c may be formed of a polymer, while the remainder of the coupling portion 1395c may be comprised of a metal or other conductive material. Alternatively, the coupling portion 1395c and the body portion 1396c of the integral sleeve 1390c may be formed of conductive materials such as metals or metal alloys, or may both be formed of polymers or other materials that would facilitate a rigidly formed component. Manufacture of the integral sleeve 1390c may include casting, extruding, cutting, knurling, turning, tapping, drilling, injection molding, blow molding, combinations thereof, or other fabrication methods that may provide efficient production of the component.

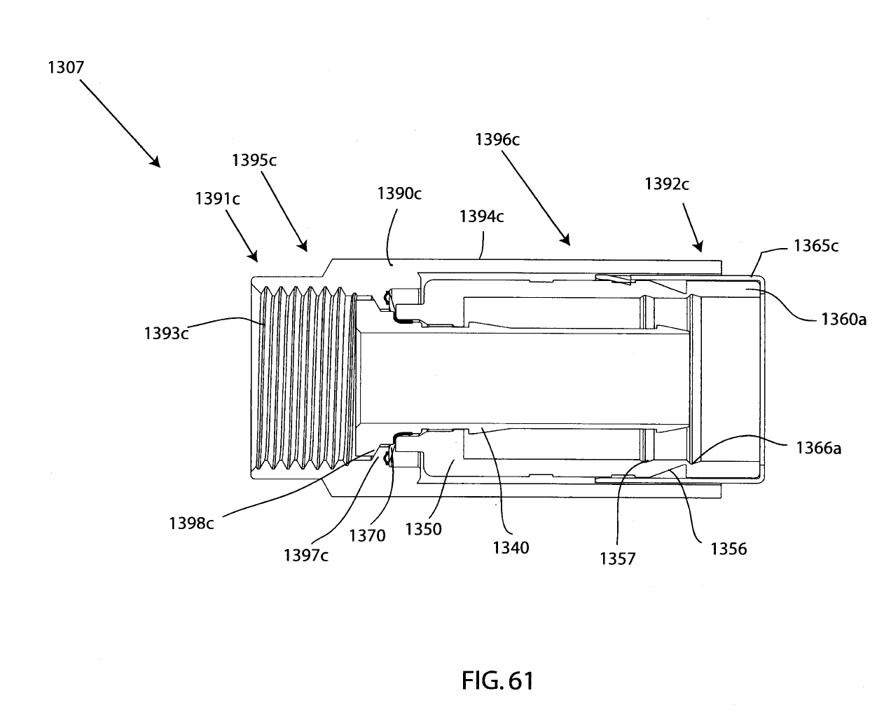

Referring now to FIG. 61, an embodiment of connector 1307 is shown. Embodiments of connector 1307 may include an integral sleeve 1390c, a post 1340, a connector body 1350, a continuity member 1370, a compression portion 1360a, and a radial restriction member 1365c.

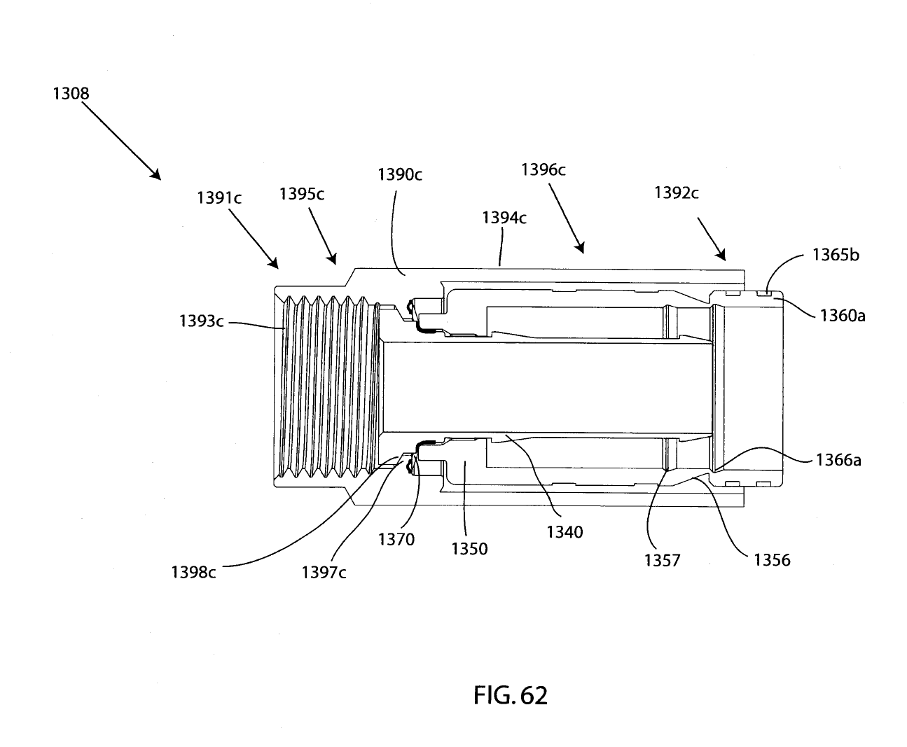

FIG. 62 depicts an embodiment of connector 1308. Embodiments of connector 1308 may include an integral sleeve 1390c, a post 1340, a continuity member 1370, a connector body 1350, a compression portion 1360a, and a radial restriction member 1360b.

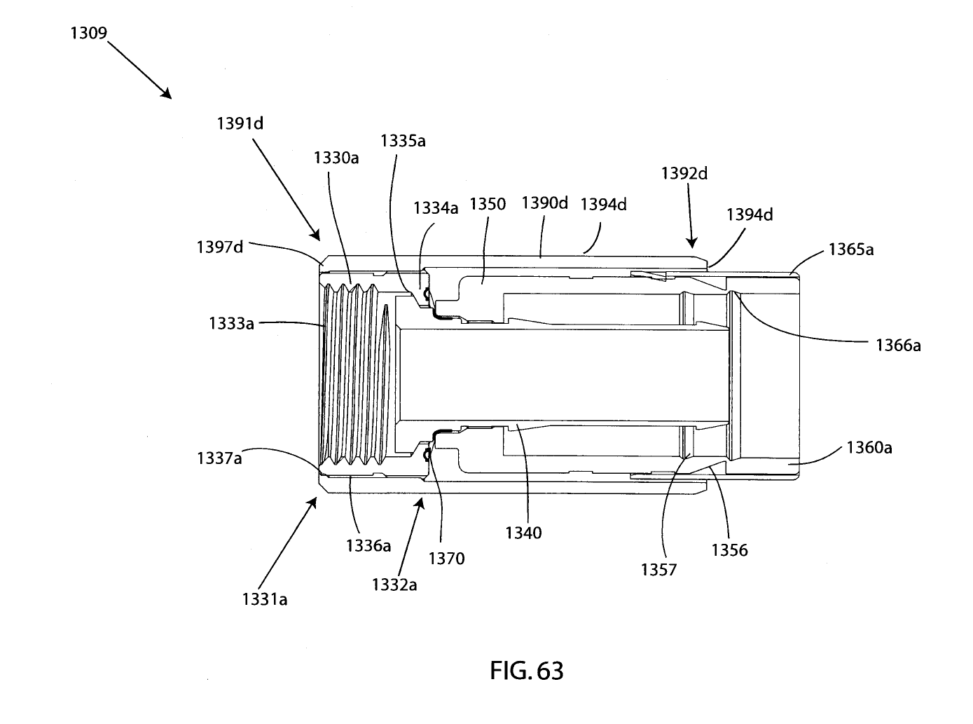

With reference now to FIG. 63, embodiments of connector 1309 may include a coupling member 1330a, a post 1340, a continuity member 1370, a connector body 1350, an outer sleeve 1390d, a compression portion 1360a, and a radial restriction member 1365a.

Embodiments of connector 1309 may include a sleeve 1390d. The sleeve 1390d may be engageable with the coupling member 1330a. Sleeve 1390d may share the same or substantially the same structural and functional aspects of sleeve 1390a. Accordingly, sleeve 1390d may include an engagement member 1397d that is configured to mate or engage with a retaining structure 1337 of the coupling member 1330a. Additionally, the sleeve 1390d may include a first end 1391d, a second end 1392d, an inner surface 1393d, and an outer surface 1394d, and may be a generally annular member having a generally axial opening therethrough. Additionally, sleeve 1390d may surround the coupling member 1330a, the post 1340, the connector body 1350, or a portion thereof, the compression portion 1360, and a radial restriction member 65, or a portion thereof when in an assembled and/or compressed position. However, the sleeve 1390d may extend towards the first end 1331a of coupling member 1330a. In one embodiment, the first end 1391d of the sleeve 1390d may be flush or substantially flush with an edge of the coupling member 1330a proximate or otherwise near the first end 1331a of the coupling member 1330a. Moreover, the engagement member 1397d may be located proximate or otherwise near the edge of the first end 1391d of the sleeve 1390d. The engagement member 1397d may be configured to mate or engage a retaining structure 1337a of the coupling member 1330a that is correspondingly located proximate or otherwise near the first end 1331a of the coupling member 1330a.

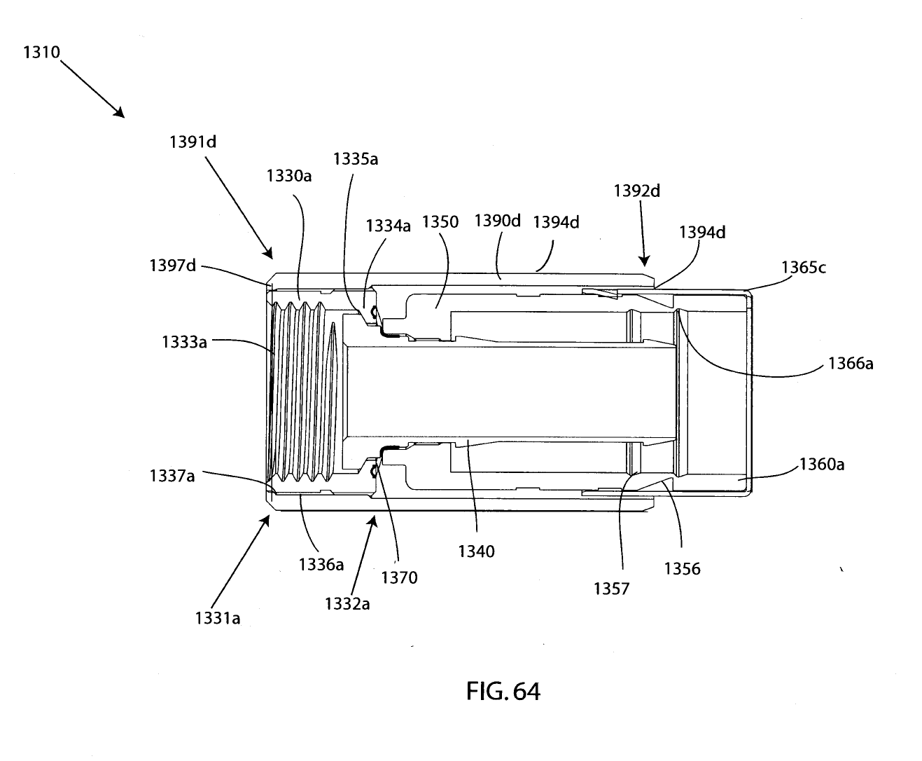

FIG. 64 depicts an embodiment of connector 1310. Embodiments of connector 1310 may include a coupling member 1330a, a post 1340, a connector body 1350, a continuity member 1370, a sleeve 1390d, a compression portion 1360a, and a radial restriction member 1365c.

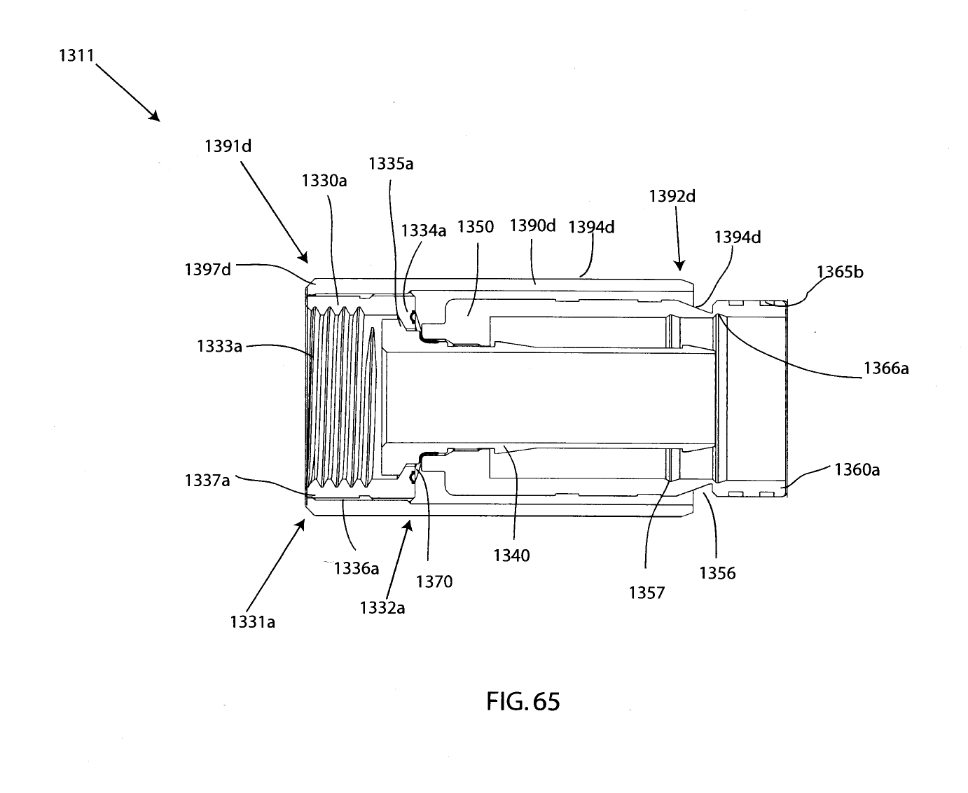

FIG. 65 depicts an embodiment of connector 1311. Embodiments of connector 1311 may include a coupling member 1330a, a post 1340, a connector body 1350, a continuity member 1370, a sleeve 1390d, a compression portion 1360a, and a radial restriction member 1365b.

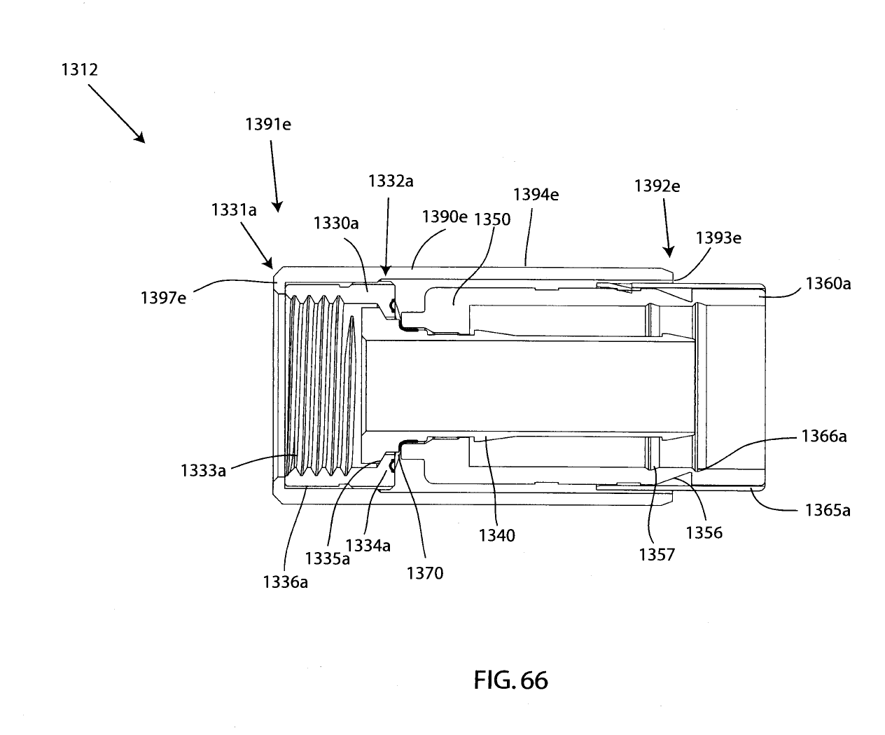

Referring now to FIG. 66, embodiments of connector 1312 may include a coupling member 1330a, a post 1340, a connector body 1350, a continuity member 1370, a sleeve 1390e, a compression portion 1360a, and a radial restriction member 1365a.

Embodiments of connector 1312 may include a sleeve 1390e. The outer sleeve 1390e may be engageable with the coupling member 1330a. Sleeve 1390e may share the same or substantially the same function as sleeve 1390a and sleeve 1390d. Accordingly, the sleeve 1390e may include a first end 1391e, a second end 1392e, an inner surface 1393e, and an outer surface 1394e, and may be a generally annular member having a generally axial opening therethrough. Sleeve 1390e may surround the coupling member 1330a, the post 1340, the connector body 1350, or a portion thereof, the compression portion 1360, and a radial restriction member 1365, or a portion thereof when in an assembled and/or compressed position. Moreover, the sleeve 1390e may extend towards the first end 1331a of coupling member 1330a. However, sleeve 1390e may include an inwardly extending lip 1397e proximate or otherwise near the first end 1391e of the sleeve 1390e, which can help guide the coupling member 1330a onto a corresponding interface port. The lip 1397e may share the same functional aspects of the engagement member 1397a, 1397d of sleeve 1390a, 1390d, respectively. For instance, the lip 1397e may radially inwardly extend a distance sufficient to prevent axial movement of the sleeve 1390e in a direction towards the second end 1332a of the coupling member 1330a when operably assembled and/or in a compressed position. An embodiment of an assembled configuration of connector 1312 with respect to the sleeve 1390e may involve sliding the sleeve 1390e over the coupling member 1330a in an axial direction starting from the first end 1331a and continuing toward the second end 1332a of the coupling member 1330a until sufficient mechanical interference and/or engagement occurs between the lip 1397e of the sleeve 1390e and frontal edge or mating surface of the coupling member 1330a. The simultaneous rotation/twisting of the sleeve 1390e and the coupling member 1330a may be effectuated in the same or similar manner as described between the sleeve 1390a and the coupling member 1330a.

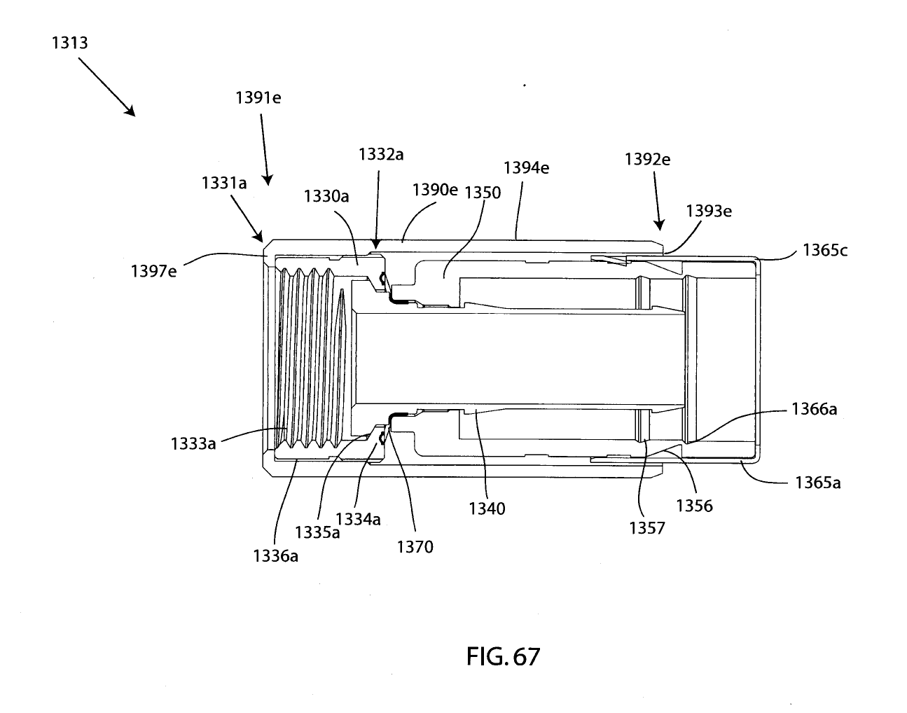

FIG. 67 depicts an embodiment of connector 1313. Embodiments of connector 1313 may include a coupling member 1330a, a post 1340, a connector body 1350, a continuity member 1370, a sleeve 1390e, a compression portion 1360a, and a radial restriction member 1365c.

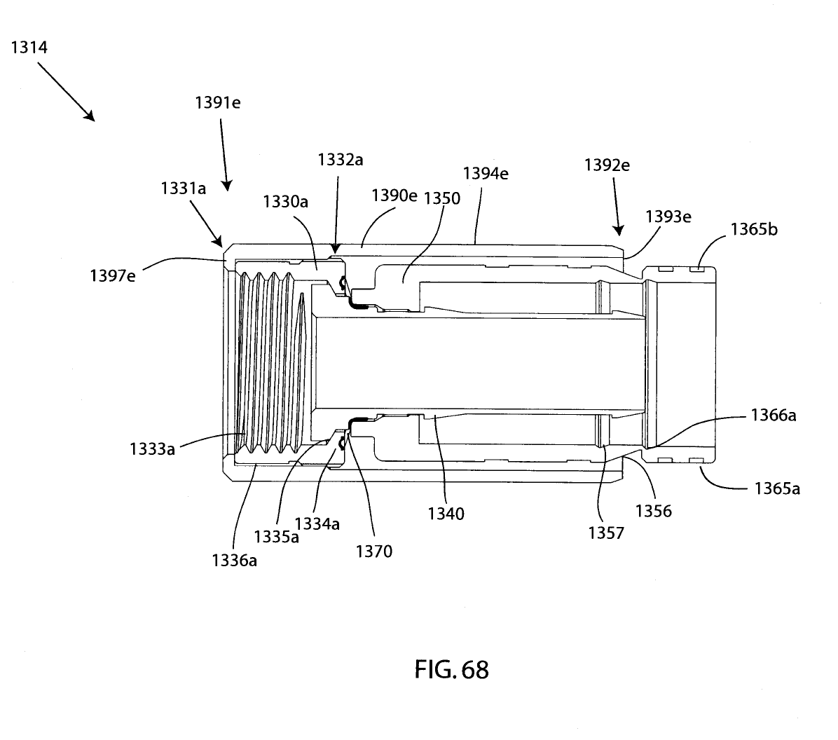

FIG. 68 depicts an embodiment of connector 1314. Embodiments of connector 1314 may include a coupling member 1330a, a post 1340, a connector body 1350, a continuity member 1370, a sleeve 1390e, a compression portion 1360a, and a radial restriction member 1365b.

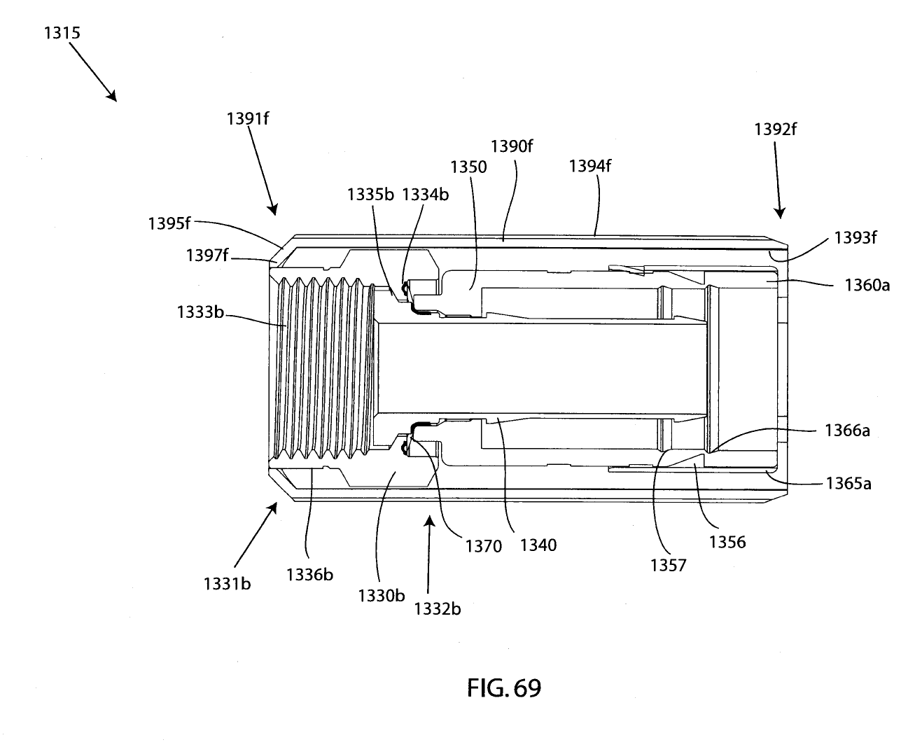

With reference now to FIG. 69, embodiments of connector 1315 may include a coupling member 1330b, a post 1340, a connector body 1350, a continuity member 1370, a sleeve 1390f, a compression portion 1360a, and a radial restriction member 1365a.

Embodiments of connector 1315 may include sleeve 1390f. Sleeve 1390f may share the same or substantially the same structural and functional aspects of sleeve 1390b. Accordingly, sleeve 1390f may include an engagement member 1397f that is configured to mate or engage with a retaining structure 1337b of the coupling member 1330b. For example, the sleeve 1390f may include a first end 1391f, a second end 1392f, an inner surface 1393f, and an outer surface 1394f, and may be a generally annular member having a generally axial opening therethrough. Additionally, sleeve 1390f may surround the coupling member 1330b, the post 1340, the connector body 1350, or a portion thereof, the compression portion 1360, and a radial restriction member 1365, or a portion thereof when in an assembled and/or compressed position. However, the sleeve 1390f may extend towards the first end 1331b of coupling member 1330b. In one embodiment, the first end 1391f of the sleeve 1390f may be flush or substantially flush with an edge of the coupling member 1330b proximate or otherwise near the first end 1331b of the coupling member 1330b. Moreover, the engagement member 1397f may be located proximate or otherwise near the edge of the first end 1391f of the sleeve 1390f. The engagement member 1397f may be configured to mate or engage a retaining structure 1337b of the coupling member 1330b that is correspondingly located proximate or otherwise near the first end 1331b of the coupling member 1330b.

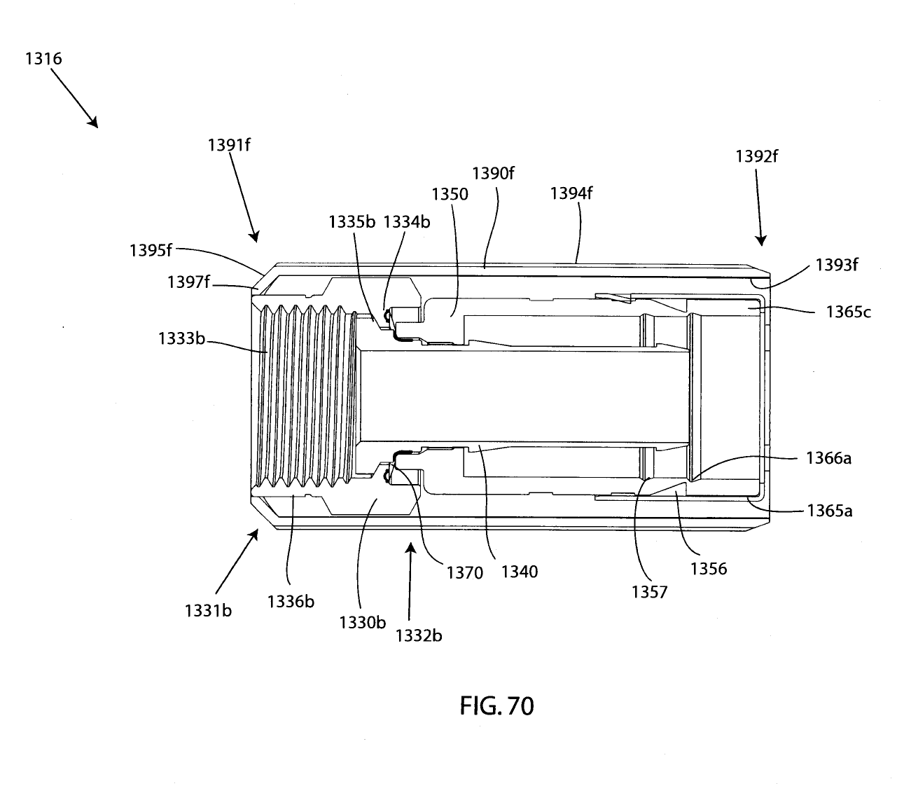

FIG. 70 depicts an embodiment of connector 1316. Embodiments of connector 1316 may include a coupling member 1330b, a post 1340, a connector body 1350, a continuity member 1370, a sleeve 1390f, a compression portion 1360a, and a radial restriction member 1365c.

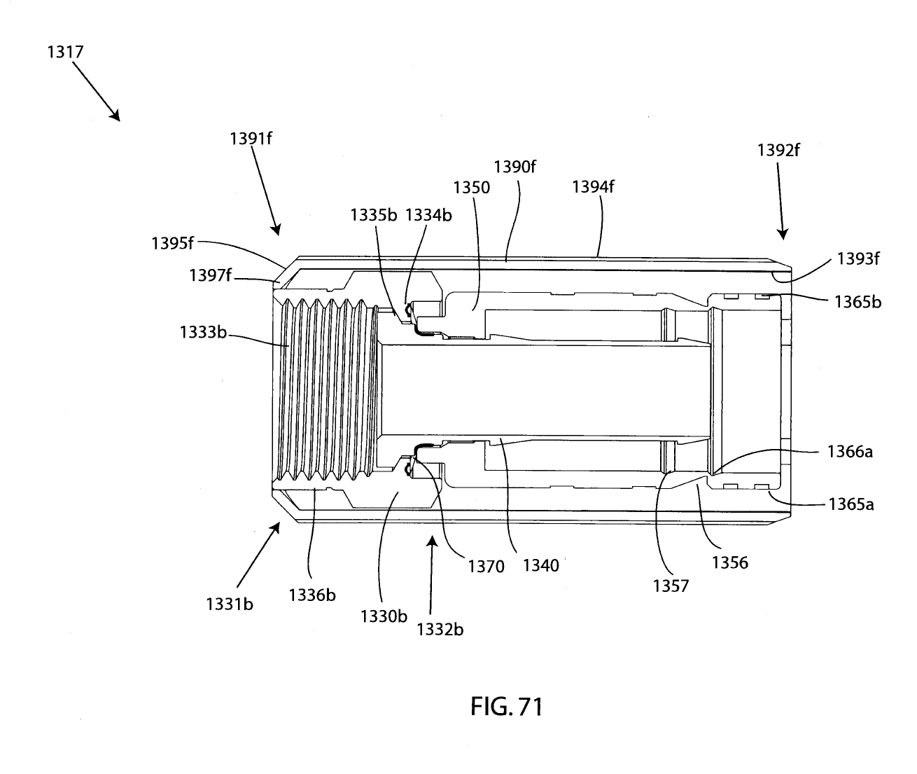

FIG. 71 depicts an embodiment of connector 1317. Embodiments of connector 1317 may include a coupling member 1330b, a post 1340, a connector body 1350, a continuity member 1370, a sleeve 1390f, a compression portion 1360a, and a radial restriction member 1365b.

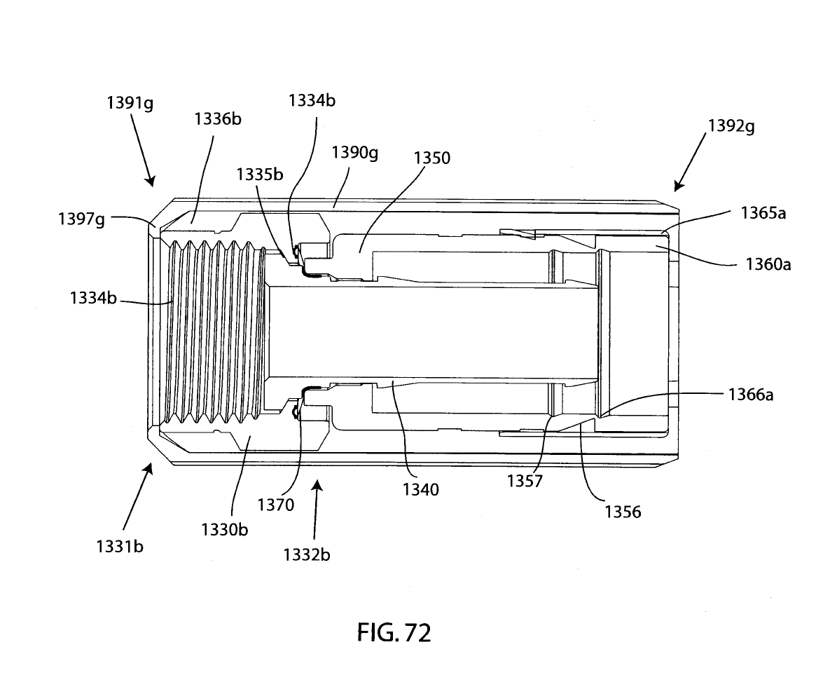

With reference to FIG. 72, embodiments of connector 1318 may include a coupling member 1330b, a post 1340, a connector body 1350, a continuity member 1370, a sleeve 1390g, a compression portion 1360a, and a radial restriction member 1365a.

Embodiments of connector 1318 may include a sleeve 1390g. The sleeve 1390b may be engageable with the coupling member 1330b. Sleeve 1390g may share the same or substantially the same function as sleeve 1390b and sleeve 1390f. Accordingly, the sleeve 1390g may include a first end 1391g, a second end 1392g, an inner surface 1393g, and an outer surface 1394g, and may be a generally annular member having a generally axial opening therethrough. Sleeve 1390g may surround the coupling member 1330b, the post 1340, the connector body 1350, or a portion thereof, the compression portion 1360, and a radial restriction member 1365, or a portion thereof, when in an assembled and/or compressed position. Moreover, the sleeve 1390g may extend towards the first end 1331b of coupling member 1330b. However, sleeve 1390g may include an inwardly extending lip 1397g proximate or otherwise near the first end 1391g of the sleeve 1390g, which can help guide the coupling member 1330b onto a corresponding interface port. The lip 1397g may share the same structural and functional aspects of the engagement member 1397b, 1397f of sleeve 1390b, 1390f, respectively. For instance, the lip 1397g may radially inwardly extend a distance sufficient to prevent axial movement of the sleeve 1390g in a direction towards the second end 1332b of the coupling member 1330b when operably assembled and/or in a compressed position. An embodiment of an assembled configuration of connector 1318 with respect to the sleeve 1390g may involve sliding the sleeve 1390g over the coupling member 1330b in an axial direction starting from the first end 1331b and continuing toward the second end 1332b of the coupling member 1330b until sufficient mechanical interference and/or engagement occurs between the lip 1397g of the sleeve 1390g and frontal edge or mating surface of the coupling member 1330b. The simultaneous rotation/twisting of the sleeve 1390g and the coupling member 1330b may be effectuated in the same or similar manner as described between the sleeve 1390b and the coupling member 1330b.

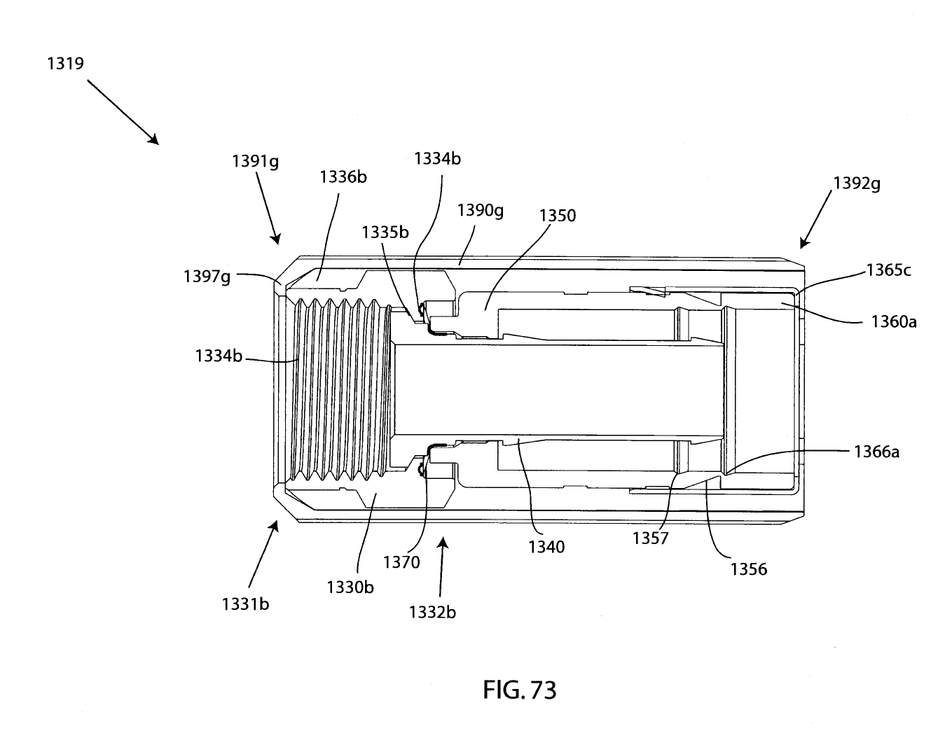

FIG. 73 depicts an embodiment of connector 1319. Embodiments of connector 1319 may include a coupling member 1330b, a post 1340, a connector body 1350, a continuity member 1370, a sleeve 1390g, a compression portion 1365a, and a radial restriction member 1365c.

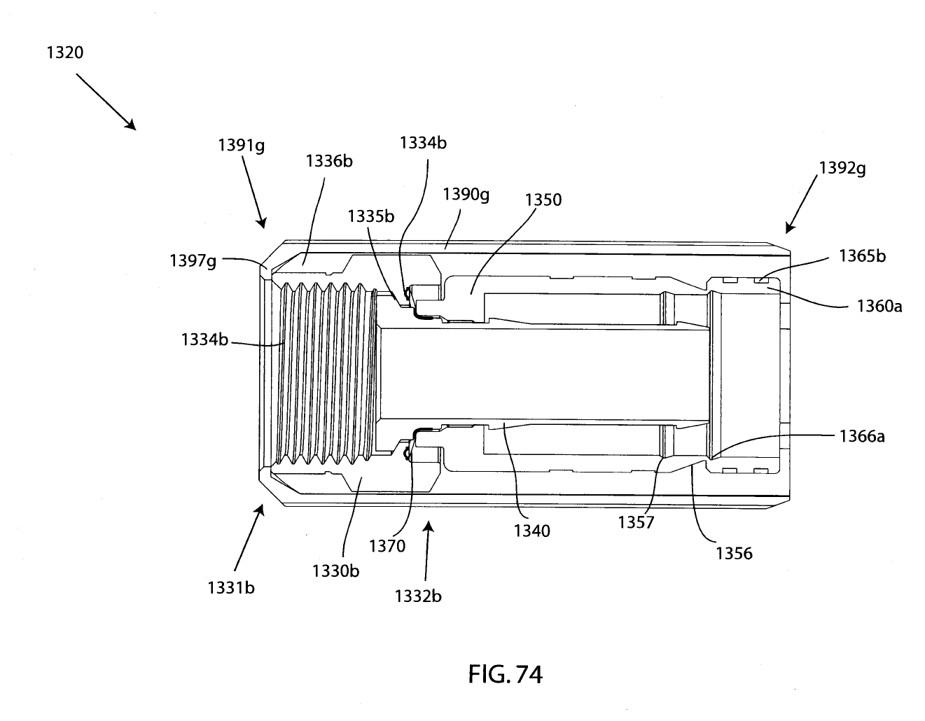

FIG. 74 depicts an embodiment of connector 1320. Embodiments of connector 1320 may include a coupling member 1330b, a post 1340, a connector body 1350, a continuity member 1370, a sleeve 1390g, a compression portion 1365a, and a radial restriction member 1365b.

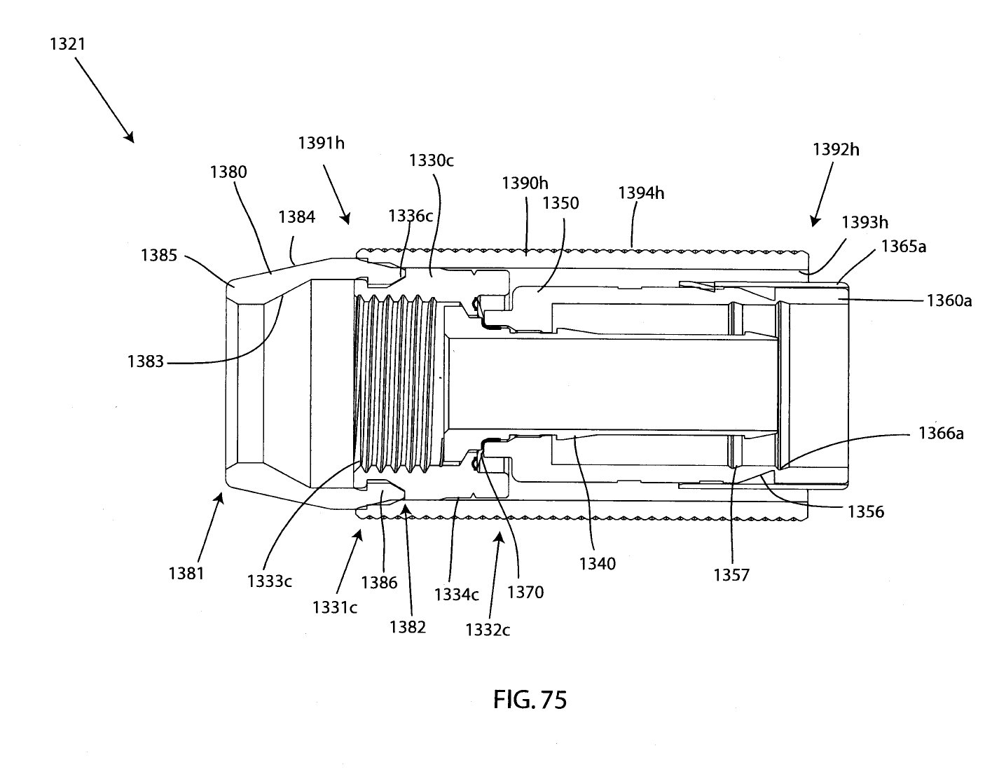

With reference now to FIG. 75, embodiments of connector 1321 may include a coupling member 1330c, a sealing member 1380, a post 1340, a connector body 1350, a continuity member 1370, a sleeve 1390h, a compression portion 1360a, and a radial restriction member 1365a.

Embodiments of connector 1321 may include a coupling member 1330c. Coupling member 1330c may share some of the structural and functional aspects of embodiments of nut 30/930/1030/1130/1230, such as being mated, threaded or otherwise, to a corresponding interface port 20. Coupling member 1330c may include a first end 1331c, a second end 1332c, an inner surface 1333c, at least a portion of which is threaded, a connector-grasping portion 1339c, and an outer surface 1334c, including a seal-grasping surface portion 1336c. The seal-grasping surface portion 1336c may be a flat, smooth surface or a flat, roughened surface suitable to frictionally and/or adhesively engage an interior sealing surface 1383 of the sealing member 1380. Embodiments of the seal-grasping surface portion 1336c may also contain a ridge that together with the seal grasping surface portion 1336c forms a groove or shoulder that is suitably sized and shaped to correspondingly engage an internal shoulder 1387 of the sealing member 1380 adjacent the interior sealing surface 1383 in a locking-type interference fit between the coupling member 1330c and the sealing member 1380.

Moreover, the coupling member 1330c may further include a coupling member-turning surface portion on an outer surface 1384 of the sealing member 1380. The coupling member-turning surface portion may have at least two flat surface regions that allow engagement with the surfaces of a tool such as a wrench. In one embodiment, the coupling member-turning surface is hexagonal. Alternatively, the coupling member-turning surface may be a knurled surface to facilitate hand-turning of the nut component. Furthermore, upon engagement of the sealing member 1380 with the coupling member 1330c, a rear sealing surface 1386 of the sealing member 1380 abuts a side/edge surface of the coupling member 1330c to form a sealing relationship in that region. In one embodiment, the connector-grasping portion 1336c of the coupling member 1330c is an internally-projecting shoulder that engages a flange of the post 1340 in such a manner that the coupling member 1330c can be freely rotated as it is held in place as part of the connector.

With continued reference to FIG. 75, connector 1321 may include a sealing member 1380. The sealing member may include a first end 1381, a second end 1382, an inner surface 1383, and an outer surface 1384. The sealing member 1380 may have a generally tubular body that is elastically deformable by nature of its material characteristics and design. In most embodiments, the seal member 1380 is a one-piece element made of a compression molded, elastomer material having suitable chemical resistance and material stability (i.e., elasticity) over a temperature range between about −40° C. to +40° C. For example, the sealing member 1380 may be made of silicone rubber. Alternatively, the material may be propylene, a typical O-ring material. Other materials known in the art may also be suitable. Furthermore, the first end 1381 of sealing member 1380 may be a free end for ultimate engagement with a port, while the second end 1382 may be for ultimate connection to the coupling member 1330c. The seal may have a forward sealing surface 1385, a rear sealing portion 1386 including an interior sealing surface 1383 that integrally engages the coupling member 1330c, and an integral joint-section 1837 intermediate the first and second end 1381, 1382 of the tubular body of the sealing member 1380. The forward sealing surface 1385 at the first end 1381 of the sealing member 1380 may include annular facets to assist in forming a seal with the port, such as interface port 20. Alternatively, forward sealing surface 1385 may be a continuous rounded annular surface that forms effective seals through the elastic deformation of the inner surface 1383 and end of the sealing member 1380 compressed against the port. The integral joint-section includes a portion of the length of the sealing member 1380 which is relatively thinner in radial cross-section to encourage an outward expansion or bowing of the seal upon its axial compression. In an exemplary embodiment, the coupling member grasping surface includes an interior sealing surface which forms an annular surface on the inside of the tubular body, and an internal shoulder 1387 of the tubular body adjacent the second end 1382. Accordingly, compressive axial force may be applied against one or both ends of the seal depending upon the length of the port intended to be sealed. The force will act to axially compress the seal whereupon it will expand radially in the vicinity of the integral joint-section. In one embodiment, the integral joint-section is located axially asymmetrically intermediate the first end 1381 and the second end 1382 of the tubular body, and adjacent an anterior end of the interior sealing surface 1383. Embodiments of the sealing member 1380 may have an interior diameter at the integral joint-section equal to about 0.44 inches in an uncompressed state; the tubular body of the sealing member 1380 may have a length from the first end 1381 to the second end 1382 of about 0.36 inches in an uncompressed state. However, it is contemplated that the joint-section can be designed to be inserted anywhere between she sealing surface and the first end 1381. The sealing member 1380 may prevent the ingress of corrosive elements when the seal is used for its intended function.

Referring still to FIG. 75, embodiments of connector 1321 may include a sleeve 1390h. The outer sleeve 1390h may be engageable with coupling member 1330c. Sleeve 1390 h may share the same or substantially the same structural and functional aspects of sleeve 1390a, 1390d, 1390f. Accordingly, the sleeve 1390h may include a first end 1391h, a second end 1392h, an inner surface 1393h, and an outer surface 1394h. However, the sleeve 1390h need not include an engagement member, such as an embodiment of engagement member 1397a. The mechanical interference to effectuate simultaneous rotation/twisting of the sleeve 1390h and the coupling member 1330cbetween coupling member 1330c and sleeve 1390h may rely on a press-fit or interference fit between the components. Alternatively, the sleeve 1390h may and coupling member 1330c may include corresponding internal (sleeve 1390h) and external (coupling member 1330c) surface features to facilitate mechanical interference between the components. Internal and external surface features of sleeve 1390h and coupling member 1330c may share the structural and functional aspects as surface features 1398a and 1338a, as described in association with, for example, connector 1300.

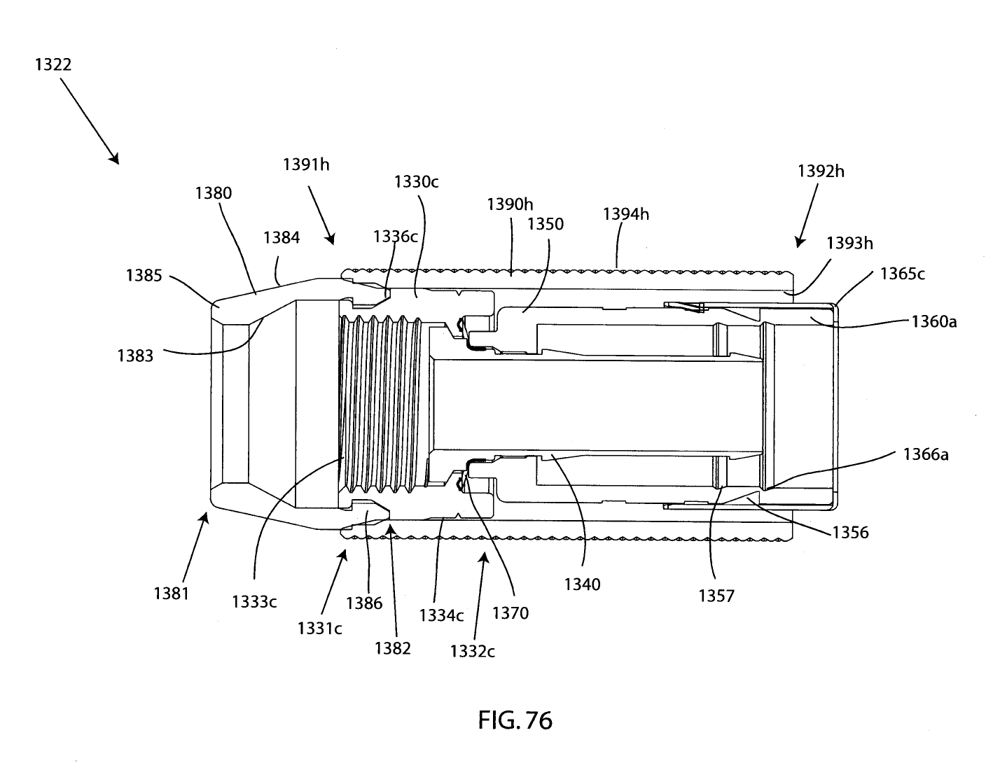

FIG. 76 depicts an embodiment of connector 1322. Embodiments of connector 1322 may include a coupling member 1330c, a sealing member 1380, a post 1340, a connector body 1350, a continuity member 1370, a sleeve 1390h, a compression portion 1360a, and a radial restriction member 1365c.

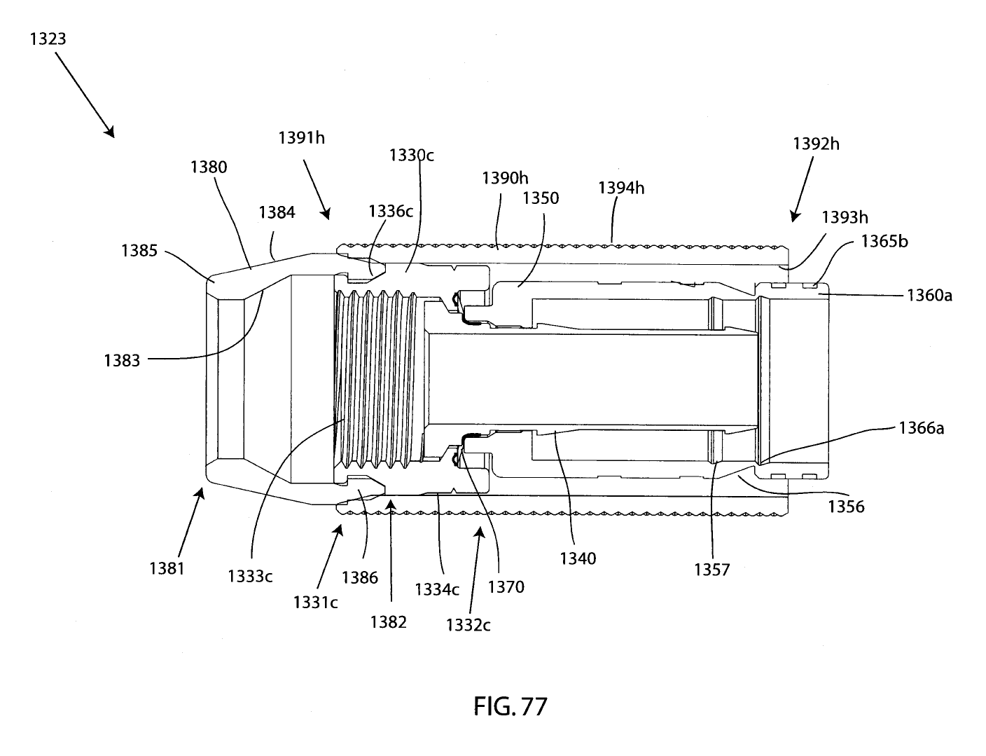

FIG. 77 depicts an embodiment of connector 1323. Embodiments of connector 1323 may include a coupling member 1330c, a sealing member 1380, a post 1340, a connector body 1350, a continuity member 1370, a sleeve 1390h, a compression portion 1360a, and a radial restriction member 1365b.

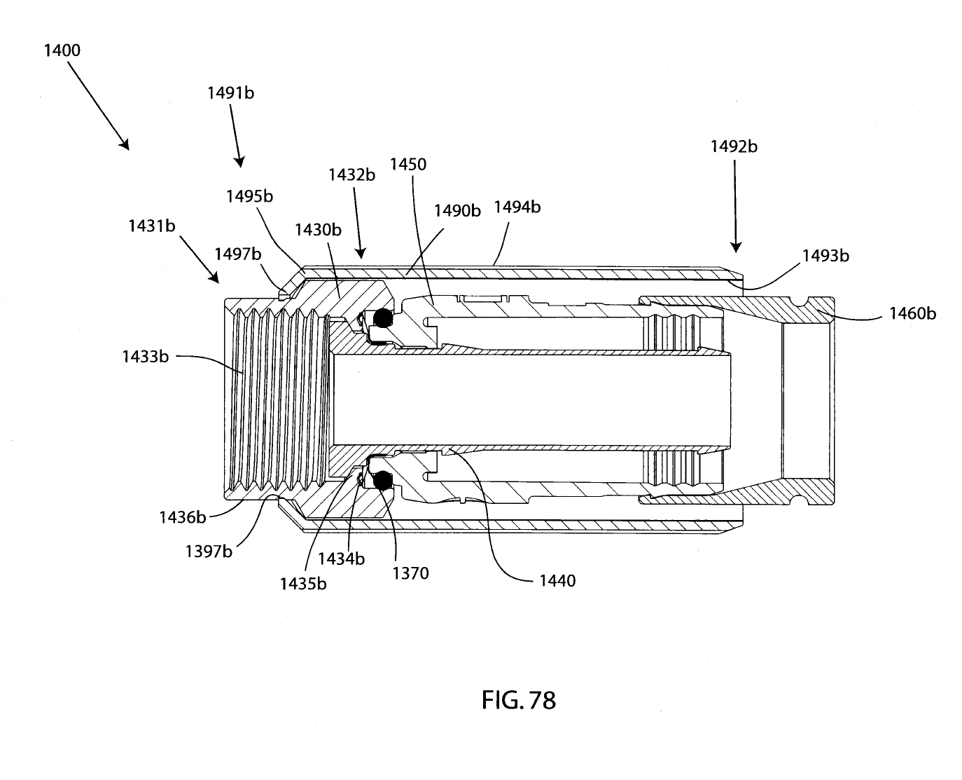

Referring now to FIGS. 78-93, embodiments of connector 1400-1415 may include a coupling member 1430, a post 1440, a connector body 1450, a continuity member 1470, a sleeve 1490, and a compression portion 1460. Embodiments of coupling member 1430 may be coupling member 1430a, 1430b, or 1430c, described in further detail infra. Embodiments of sleeve 1490 may be sleeve 1490a, 1490b, 1490c, 1490d, 1490e, 1490f, 1490g, or 1490h, described in further detail infra. Similarly, embodiments of compression portion 1460 may be 1460b or 1460c, described in further detail infra. Furthermore, embodiments of post 1440 and connector body 1450 may share the same or substantially the same structural and functional aspects of the embodiments of post 40/940/1040/1140/1240/1340 and connector body 50/950/1050/1150/1250/1350 described supra. Embodiments of continuity member 1470 may be disposed in the same or substantially the same location in a connector 100/900/1000/1100/1200/1300-1323/1400-1415 and may share the same structural and functional aspects of continuity member 70/170/270/370/470/570/670/970/1070/1170/1270/1370, as described supra. However, continuity member 1470 may share the same structural and functional aspects of continuity member 770/870 if a connector body, such as connector body 1450, is appropriately modified to accommodate the continuity member, such as continuity member 770/870. Connectors 1400-1415 may come in a preassembled configuration or may require additional operable attachment of the sleeve 1490 to connector 1400-1415 during installation.

Referring to FIG. 78, an embodiment of connector 1400 may include a coupling member 1430b, a post 1440, a connector body 1450, a continuity member 1470, a sleeve 1490b, and a compression portion 1360.

Embodiments of connector 1400 may include a coupling member 1430b. Coupling member 1430b may share the same or substantially the same structural and functional aspects of the embodiments of nut 30/930/1030/1130/1230/1330b, such as being mated, threaded or otherwise, to a corresponding interface port 20. Accordingly, coupling member 1430b may include a first end 1431b, a second end 1432b, an inner surface 1433b, an outer surface 1436b, an internal lip 1434b, such as an annular protrusion, located proximate the second rearward end 1432b of the coupling member 1430b, wherein the internal lip 1434b includes a surface 1435b facing the first forward end 1431b of the coupling member 1430b. Additionally, coupling member 1430b may include a retaining structure 1437b on the outer surface 1436b of the coupling member 1430b. The retaining structure 1437b of the coupling member 1430b may be an annular groove or recession that extends completely or partially around the outer surface 1436b of the coupling member 1430b to retain, accommodate, receive, or mate with an engagement member 1497 of the sleeve 1490. Alternatively, the retaining structure 1437b may be an annular protrusion that extends completely or partially around the outer surface 1436b of the coupling member 1430b to retain or mate with the engagement member 1497 of the sleeve 1490. The retaining structure 1437b may be placed at various axial positions from the first end 1431b to the 1432b, depending on the configuration of the sleeve 1490 and other design requirements of a coaxial cable connector.

Moreover, embodiments of coupling member 1430b may include an outer surface feature(s) 1438b proximate or otherwise near the second end 1432a to improve mechanical interference or friction between the coupling member 1430b and the sleeve 1490. For instance, the outer surface feature(s) 1438a may extend completely or partially around the outer surface 1436b proximate the second 1432b of the coupling member 1430b to increase a retention force between an inner surface of the sleeve 1490 and the outer surface 1436b of the coupling member 4330b. The outer surface feature 1438b may include a plurality of planar surfaces that may facilitate contact between the sleeve 1490 and the coupling member 1430b.

Embodiments of connector 1400 may also include a sleeve 1490b. Sleeve 1490b may share the same structural and functional aspects of sleeve 1390b described in association with, for example, connector 1303. Accordingly, sleeve 1490b may include an engagement member 1497b that is configured to mate or engage with a retaining structure 1437b of the coupling member 1430b. For example, the sleeve 1490b may include a first end 1491b, a second end 1492b, an inner surface 1493b, and an outer surface 1494b, and may be a generally annular member having a generally axial opening therethrough. However, the sleeve 1490b may be radially disposed over the coupling member 1430b, or a portion thereof, the post 1440, the connector body 1450, or a portion thereof, and the compression portion 1460, or a portion thereof, while operably assembled and/or in a compressed position. Additionally, the sleeve 1490b may include an annular ramped surface 1495b or chamfer proximate or otherwise near the first end 1491b to accommodate an increased diameter or general size of the coupling member 1430b proximate a second, rearward end 1432b of the coupling member 1430b. Embodiments of the ramped surface 1495b may be structurally integral with the engagement member 1497b and the body of the sleeve 1490b.

Referring still to FIG. 78, embodiments of connector 1400 may include a compression portion 1460b. Compression portion 1460b may share the same or substantially the same structural and functional aspects of fastener member 60, as described supra. Accordingly, compression portion 1460b may have a first end 1461b and opposing second end 1462b, and a ramped surface 1466b which may be positioned between a first opening or inner bore having a first diameter positioned proximate with the first end 1461b of the compression portion 1460b and a second opening or inner bore having a second diameter positioned proximate with the second end 1462b of the compression portion 1460b to deformably compress the outer surface of a connector body 1450 when the compression portion 1460b is operated to secure a coaxial cable 10. Furthermore, the compression portion 1460b may be manufactured via casting, extruding, cutting, turning, drilling, knurling, injection molding, spraying, blow molding, component overmolding, combinations thereof, or other fabrication methods that may provide efficient production of the component.

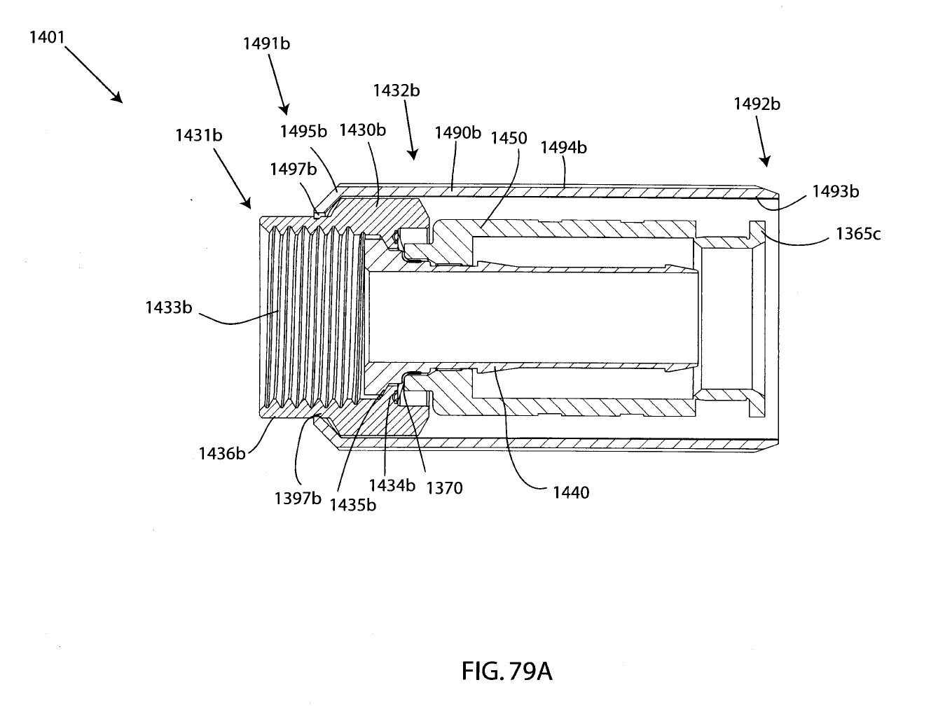

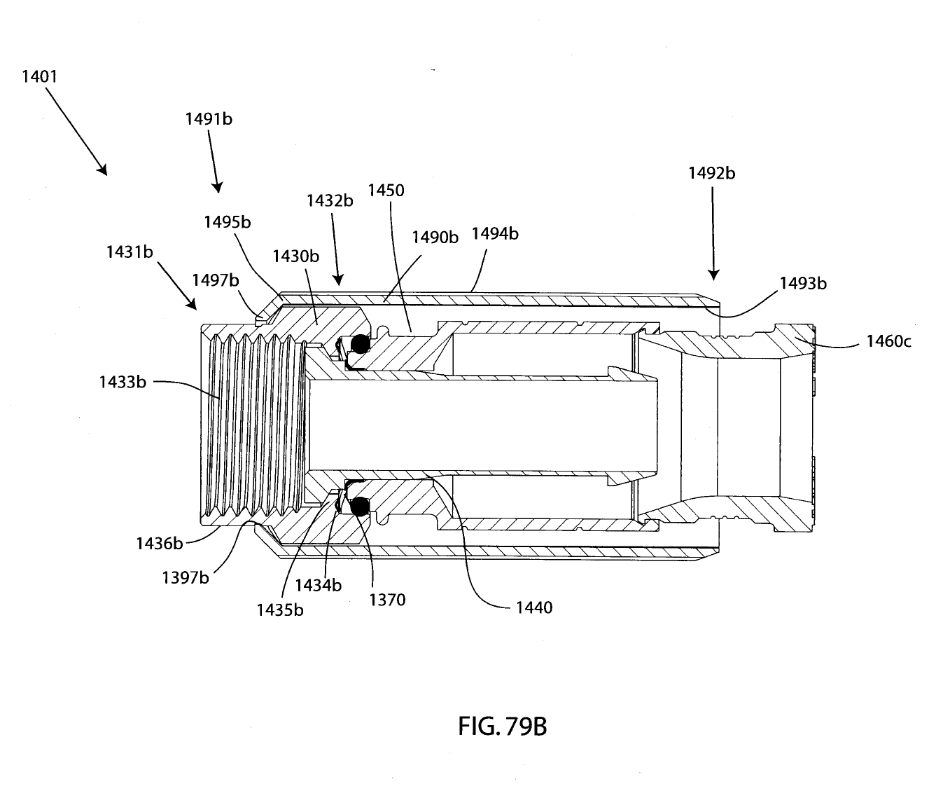

With reference now to FIGS. 79A and 79B, embodiments of connector 1401 may include a coupling member 1430b, a post 1440, a connector body 1450, a continuity member 1470, a sleeve 1490b, and a compression portion 1460c.

Embodiments of connector 1401 may include a compression portion 1460c. Compression portion 1460c may be an insertable compression sleeve or tubular locking compression member that resides internally with respect to the connector body 1450 in the compressed position, as described in further detail supra. The compression portion 1460c may include a first end 1461c, a second end 1462c, an inner surface 1463, and an outer surface 1464c. The compression portion 1460c may be pushed into the connector body 1450 to squeeze against and secure the cable 10. For instance, the compression portion 1460c may protrude axially into an annular chamber through the rear opening, and may be slidably coupled or otherwise movably affixed to the connector body 1450 to compress into the connector body 1450 and retain the cable 10. The compression portion 1460c may be displaceable or movable axially or in the general direction of the axis of the connector between a first open position (accommodating insertion of the tubular inner post 1440 into a prepared cable 10 end to contact the grounding shield 14), and a second clamped position compressibly fixing the cable 10 within the chamber of the connector because the compression portion 1460c is squeezed into retraining contact with the cable 10 within the connector body 1450. An alternative embodiment of compression portion 1460c may be shown in FIG. 79A, which includes an internal annular groove in the connector body 1450 and a lip 1465c proximate the first end 1461c of the compression position 1460c, wherein the internal groove of the connector body 1450 mates with the lip 1465c of the compression portion 1460c.

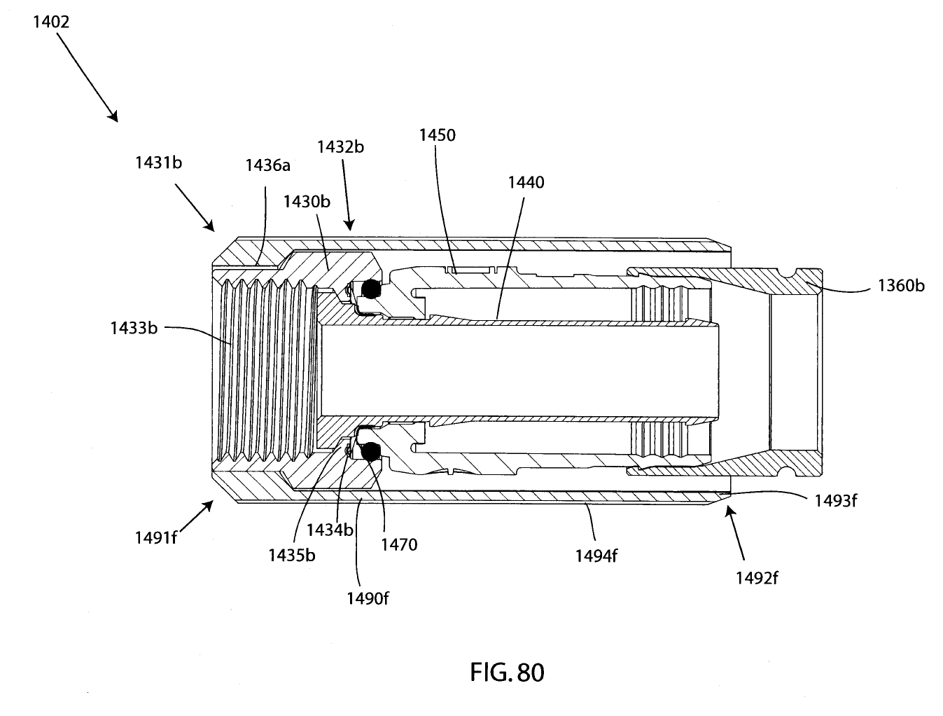

With reference now to FIG. 80, embodiments of connector 1402 may include a coupling member 1440b, a post 1440, a connector body 1450, a continuity member 1470, a sleeve 1490f, and a compression portion 1460b.

Embodiments of connector 1402 may include a sleeve 1490f. Sleeve 1490f may share the same or substantially the same structural and functional aspects of sleeve 1390f. Accordingly, sleeve 1490f may include an engagement member 1497f that is configured to mate or engage with a retaining structure 1437b of the coupling member 1430b. For example, the sleeve 1490f may include a first end 1491f, a second end 1492f, an inner surface 1493f, and an outer surface 1494f, and may be a generally annular member having a generally axial opening therethrough. Additionally, sleeve 1490f may surround the coupling member 1430b, the post 1440, the connector body 1450, or a portion thereof, and the compression portion 1460 when in an assembled and/or compressed position. However, the sleeve 1490f may extend towards the first end 1431b of coupling member 1430b. In one embodiment, the first end 1491f of the sleeve 1490f may be flush or substantially flush with an edge of the coupling member 1430b proximate or otherwise near the first end 1431b of the coupling member 1430b.

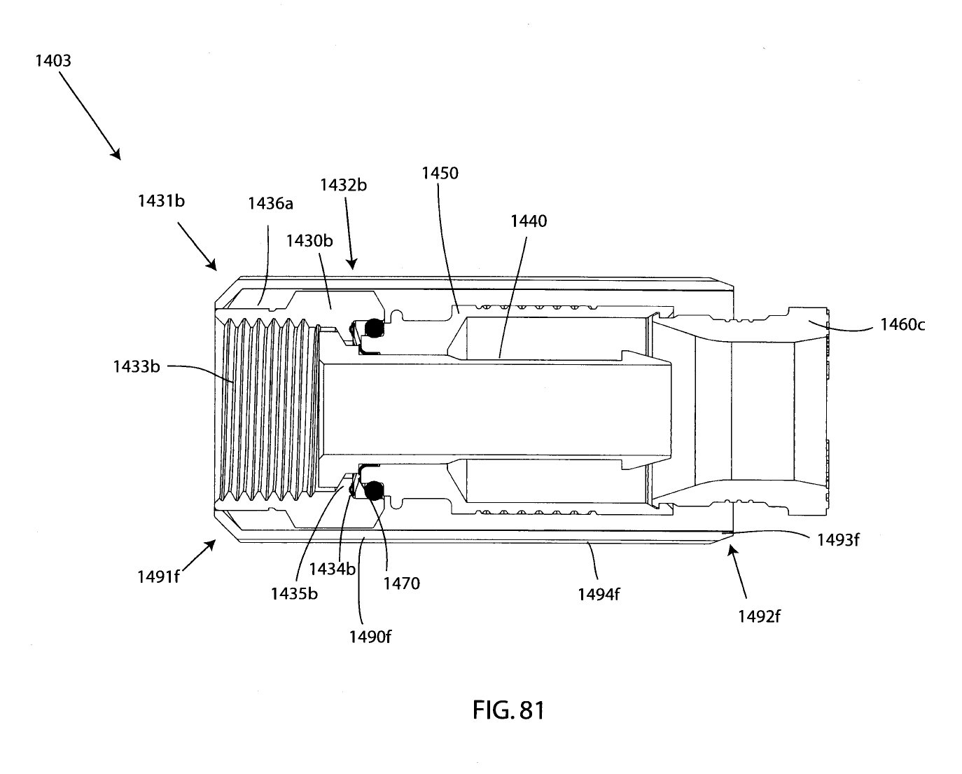

FIG. 81 depicts an embodiment of connector 1403. Embodiments of connector 1403 may include a coupling member 1430b, a post 1440, a connector body 1450, a continuity member 1470, a sleeve 1490f, and a compression portion 1460c.

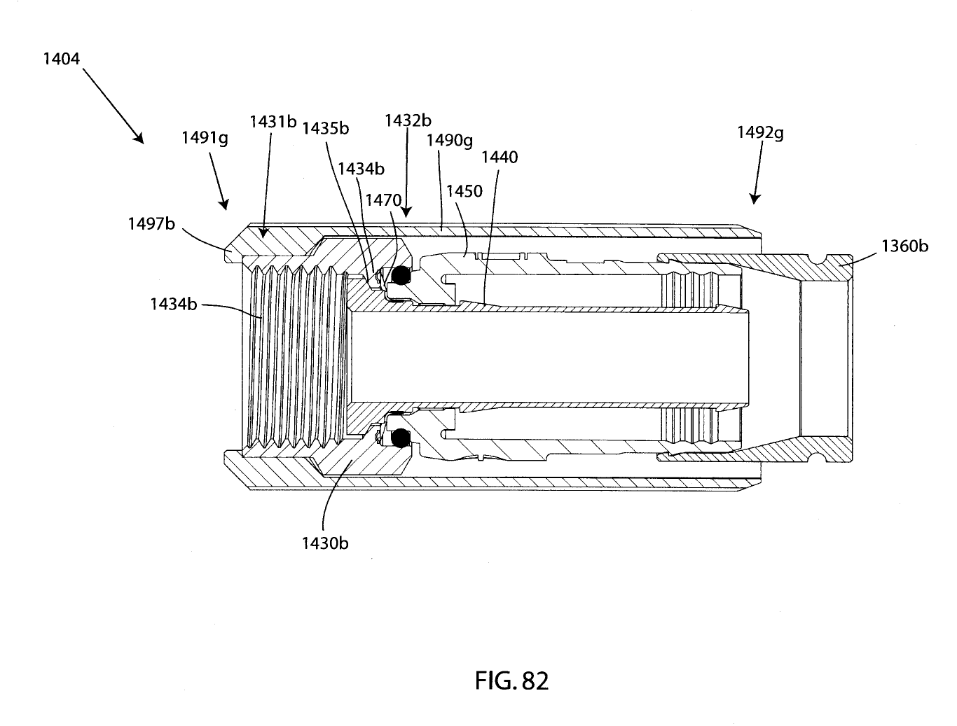

With reference now to FIG. 82, embodiments of connector 1404 may include a coupling member 1440b, a post 1440, a connector body 1450, a continuity member 1470, a sleeve 1490g, and a compression portion 1460b.

Embodiments of connector 1404 may include a sleeve 1490g. Sleeve 1490g may share the same or substantially the same function as sleeve 1390g. Accordingly, the sleeve 1490g may include a first end 1491g, a second end 1492g, an inner surface 1493g, and an outer surface 1494g, and may be a generally annular member having a generally axial opening therethrough. Sleeve 1490g may surround the coupling member 1430b, the post 1440, the connector body 1450, or a portion thereof, and the compression portion 1360 when in an assembled and/or compressed position. Moreover, the sleeve 1490g may extend towards the first end 1431b of coupling member 1430b. However, sleeve 1490g may include an inwardly extending lip 1497g proximate or otherwise near the first end 1491g of the sleeve 1490g, which can help guide the coupling member 1430b onto a corresponding interface port. The lip 1497g may share the same functional aspects of the engagement member 1397f of sleeve 1390f.

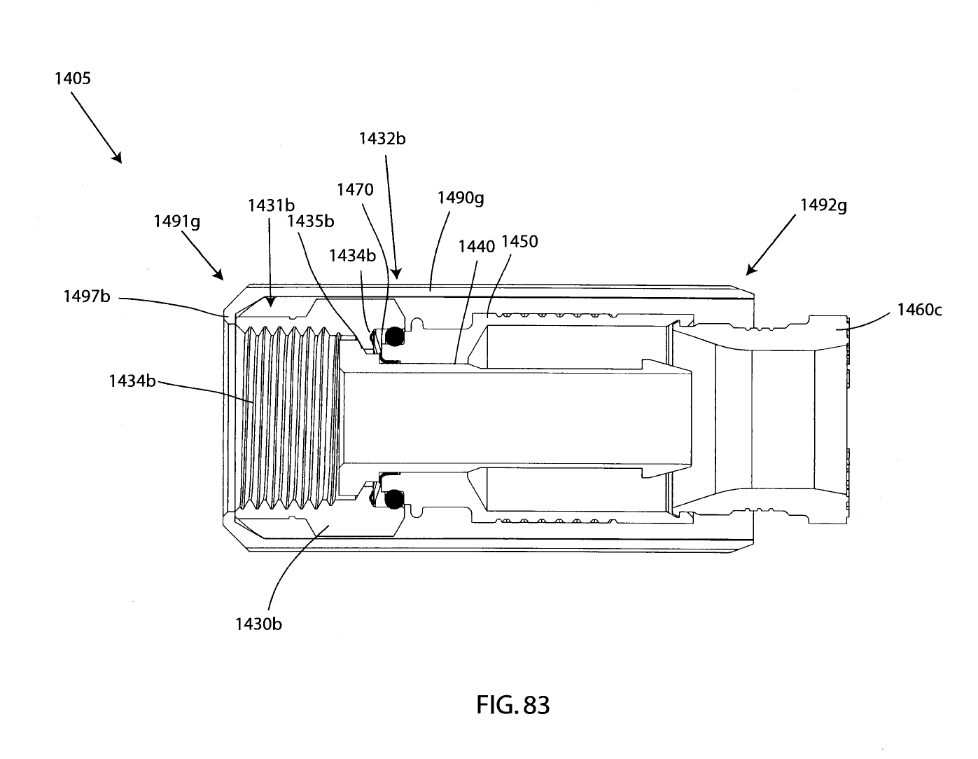

FIG. 83 depicts an embodiment of connector 1405. Embodiments of connector 1405 may include a coupling member 1440b, a post 1440b, a connector body 1450, a continuity member 1470, a sleeve 1490f, and a compression portion 1460c.

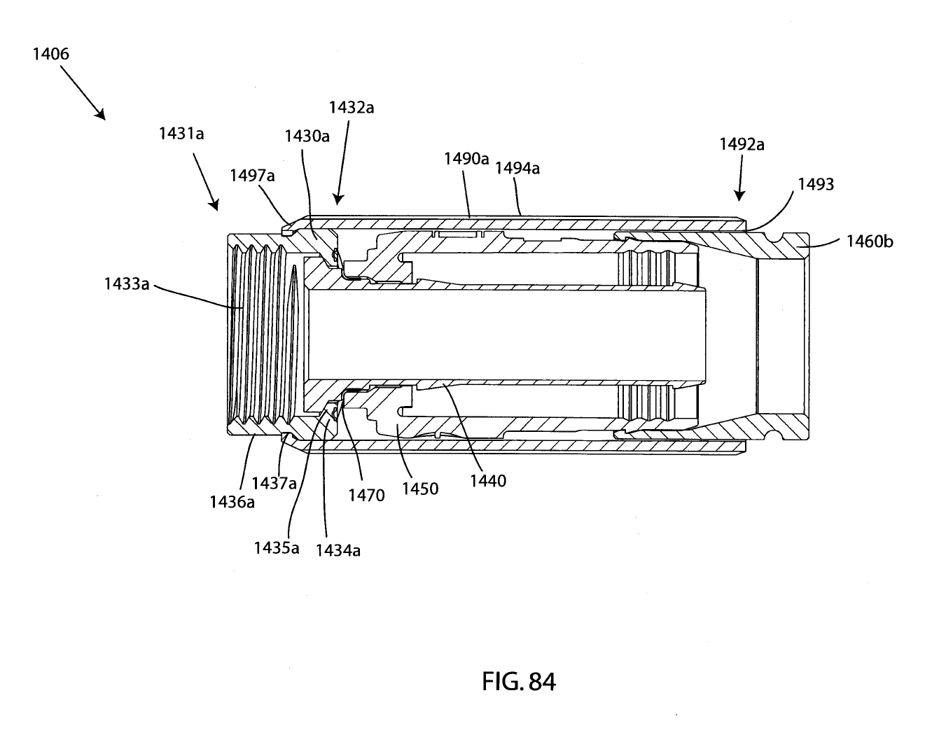

Referring to FIG. 84, an embodiment of connector 1406 may include a coupling member 1430a, a post 1440, a connector body 1450, a continuity member 1470, a sleeve 1490a, and a compression portion 1460.

Embodiments of connector 1406 may include a coupling member 1430a. Coupling member 1430a may share the same or substantially the same structural and functional aspects of coupling member 1330a. Accordingly, coupling member 1430a may include a first end 1431a, a second end 1432a, an inner surface 1433a, an outer surface 1436a, an internal lip 1434a, such as an annular protrusion, located proximate the second rearward end 1432a of the coupling member 1430a, wherein the internal lip 1434a includes a surface 1435a facing the first forward end 1431a of the coupling member 1430a. Moreover, coupling member 1430a may include an engagement member 1497a configured to retain, accommodate, receive, or mate with an engagement member 1497a of the sleeve 1490a, and an outer surface feature 1438a proximate or otherwise near the second end 1432a to improve mechanical interference or friction between the coupling member 1330a and the sleeve 1390.

Embodiments of connector 1406 may also include a sleeve 1490a. Sleeve 1490a may share the same or substantially the same structural and functional aspects of sleeve 1390a described supra. Accordingly, the sleeve 1490a may include a first end 1491a, a second 1491a, an inner surface 1493a, and an outer surface 1494a, and may be a generally annular member having a generally axial opening therethrough. Moreover, the sleeve 1390a may also include an engagement member 1497a configured to mate or engage with the retaining structure 1337 of the coupling member 1330a, and internal surface features 1498a to improve the contact between the coupling member 1430a and sleeve 1490a.

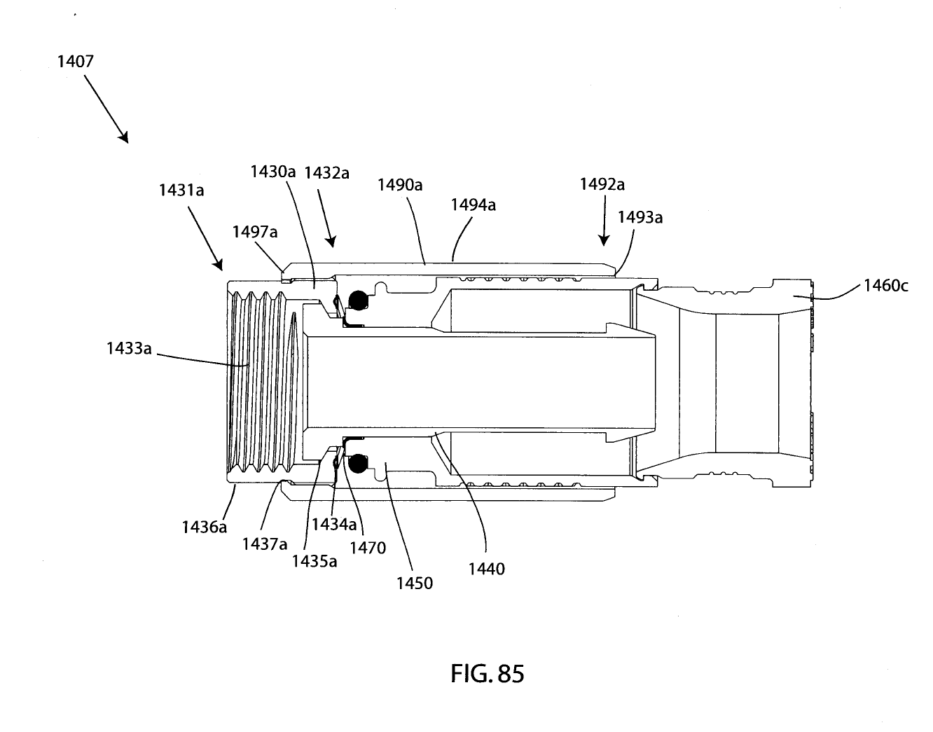

FIG. 85 depicts an embodiment of connector 1407. Embodiments of connector 1407 may include a coupling member 1430a, a post 1440, a connector body 1450, a continuity member 1470, a sleeve 1490a, and a compression portion 1360c.

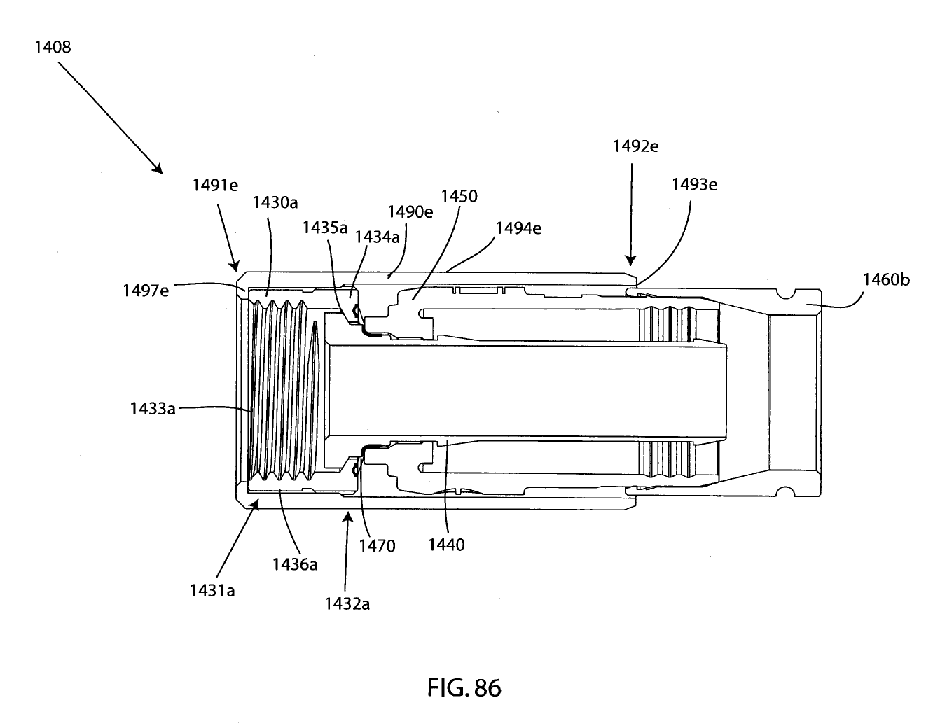

Referring now to FIG. 86, embodiments of connector 1408 may include a coupling member 1430a, a post 1440, a connector body 1450, a continuity member 1470, a sleeve 1490e, and a compression portion 1360b.

Embodiments of connector 1408 may include a sleeve 1490e. Sleeve 1490e may share the same or substantially the same function as sleeve 1390e. Accordingly, the sleeve 1490e may include a first end 1491e, a second end 1492e, an inner surface 1493e, and an outer surface 1494e, and may be a generally annular member having a generally axial opening therethrough. Sleeve 1490e may surround the coupling member 1430a, the post 1440, the connector body 1450, or a portion thereof, and the compression portion 1360 when in an assembled and/or compressed position. Moreover, the sleeve 1490e may extend towards the first end 1431a of coupling member 1430a. Sleeve 1490e may further include an inwardly extending lip 1497e proximate or otherwise near the first end 1491e of the sleeve 1490e, which can help guide the coupling member 1430a onto a corresponding interface port. The lip 1497e may share the same functional aspects of the engagement member 1397e of sleeve 1390e.

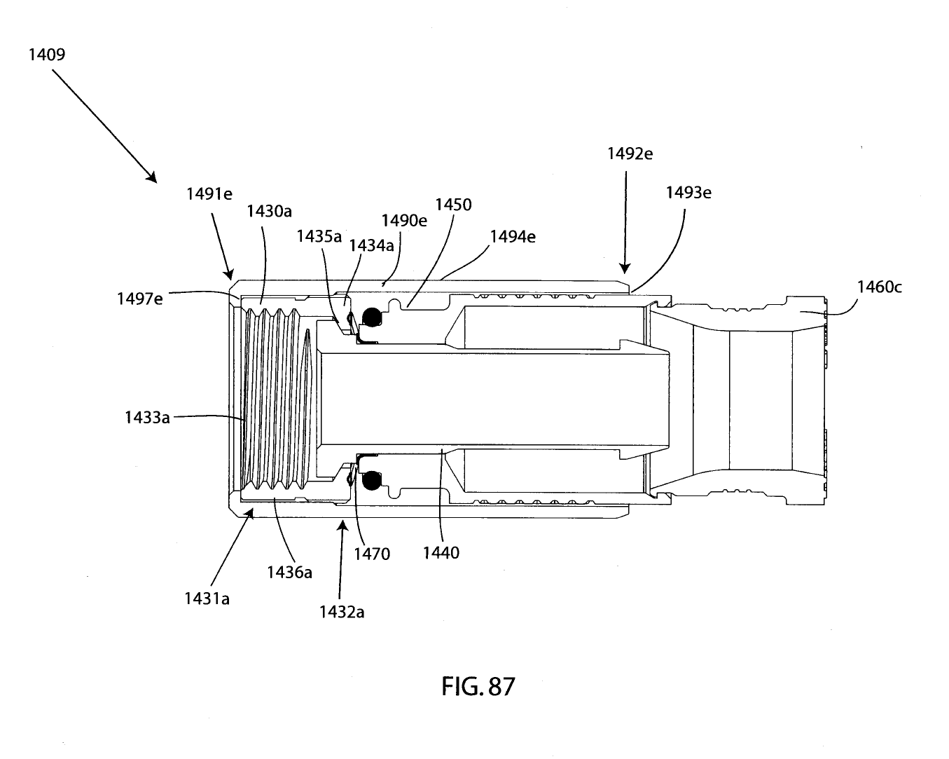

FIG. 87 depicts an embodiment of connector 1409. Embodiments of connector 1409 may include a coupling member 1430a, a post 1440, a connector body 1450, a continuity member 1470, an outer sleeve 1490e, and compression portion 1460c.

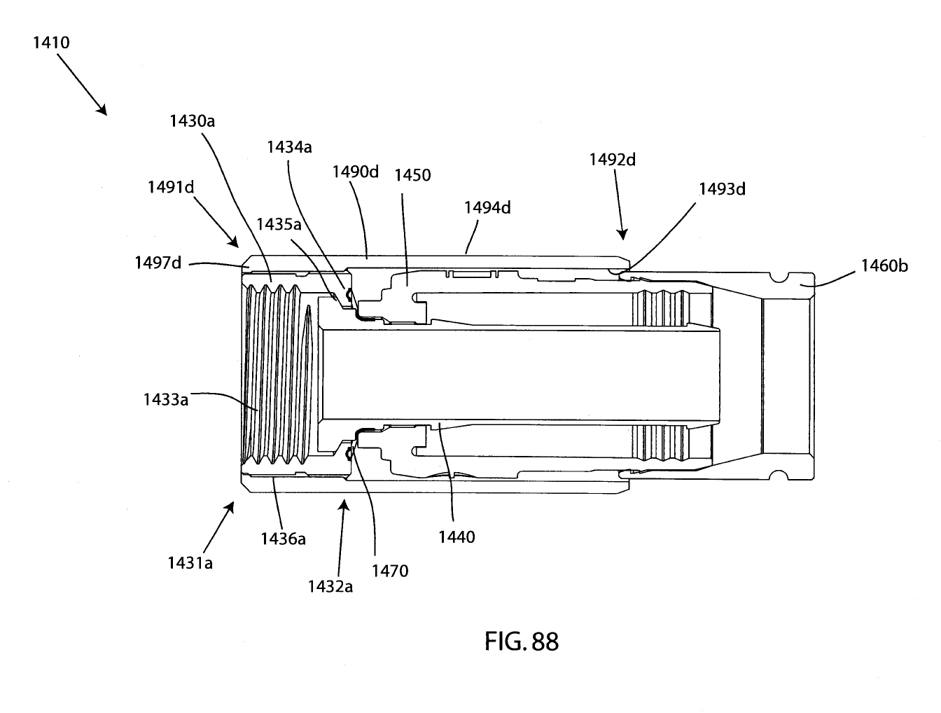

With reference now to FIG. 88, embodiments of connector 1410 may include a coupling member 1430a, a post 1440, a connector body 1450, a continuity member 1470, a sleeve 1490d, and a compression portion 1460b.

Embodiments of connector 1410 may include a sleeve 1410. Sleeve 1410 may share the same or substantially the same structural and functional aspects of sleeve 1390d. Accordingly, the sleeve 1490d may include a first end 1491d, a second end 1492d, an inner surface 1493d, and an outer surface 1494d, and may be a generally annular member having a generally axial opening therethrough. Additionally, sleeve 1490d may extend towards the first end 1431a of coupling member 1430a. The sleeve 1490d may include an engagement member 1497d that may share the same or substantially the same structural or functional aspects as engagement member 1397d. For instance, the engagement member 1497d may be configured to mate or engage with a correspondingly located retaining structure 1337 of the coupling member 1330a.

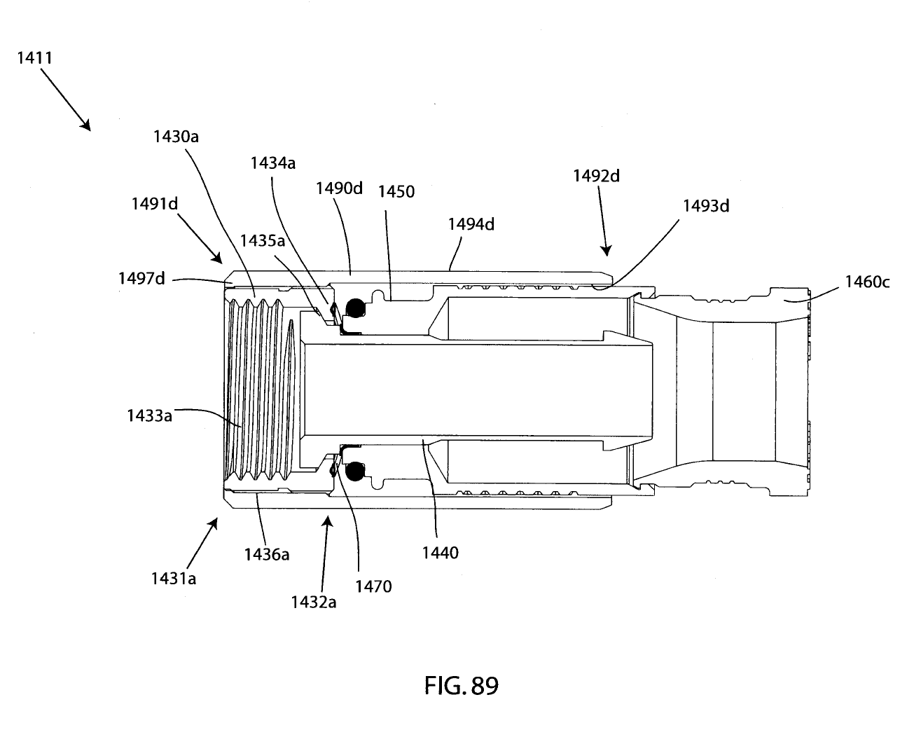

FIG. 89 depicts an embodiment of connector 1411. Embodiments of connector 1411 may include a coupling member 1430a, a post 1440, a connector body 1450, a continuity member 1470, a sleeve 1490d, and a compression portion 1360c.

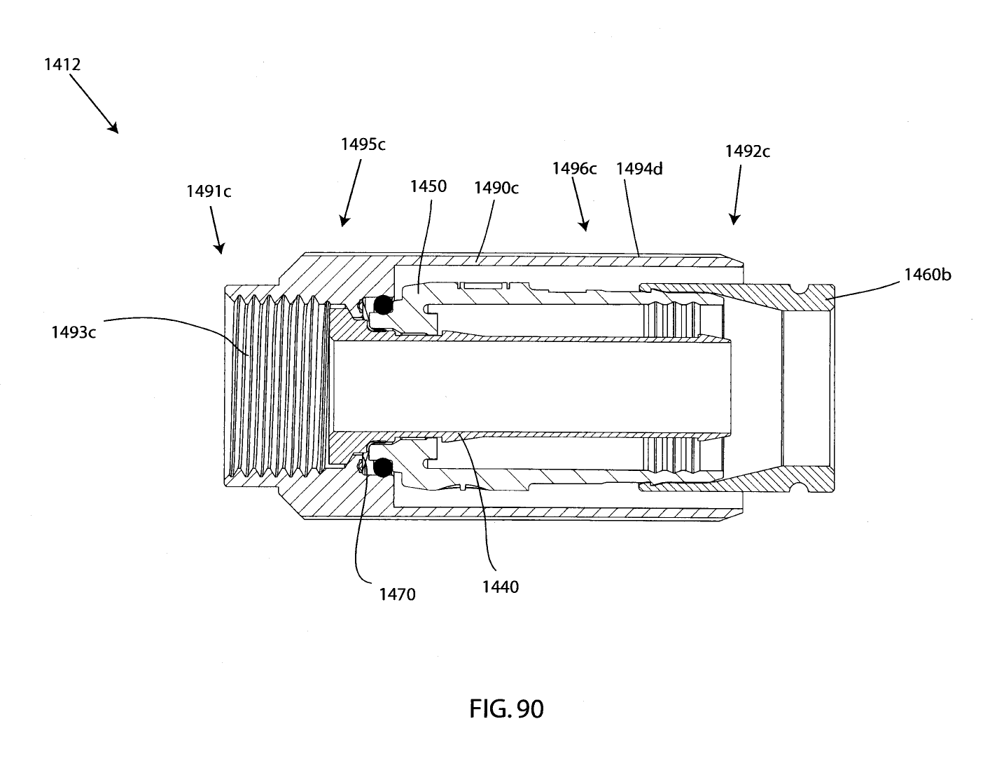

With reference now to FIG. 90, embodiments of connector 1412 may include an integral sleeve 1490c, a post 1440, a connector body 1450, a continuity member 1370, and a compression portion 1360b.

Embodiments of connector 1412 may include an integral sleeve 1490c. Integral sleeve 1490c may share the same structural and functional aspects of integral sleeve 1390c. Accordingly, integral sleeve 1390c may include a first end 1491c, a second end 1492c, an outer surface 1493c, and an outer surface 1494c, and may be a generally annular member having a generally axial opening therethrough. Moreover, the integral sleeve 1490c may include a coupling portion 1495c proximate the first end 1491c and a body portion 1496c structurally integral with the coupling portion 1495c.

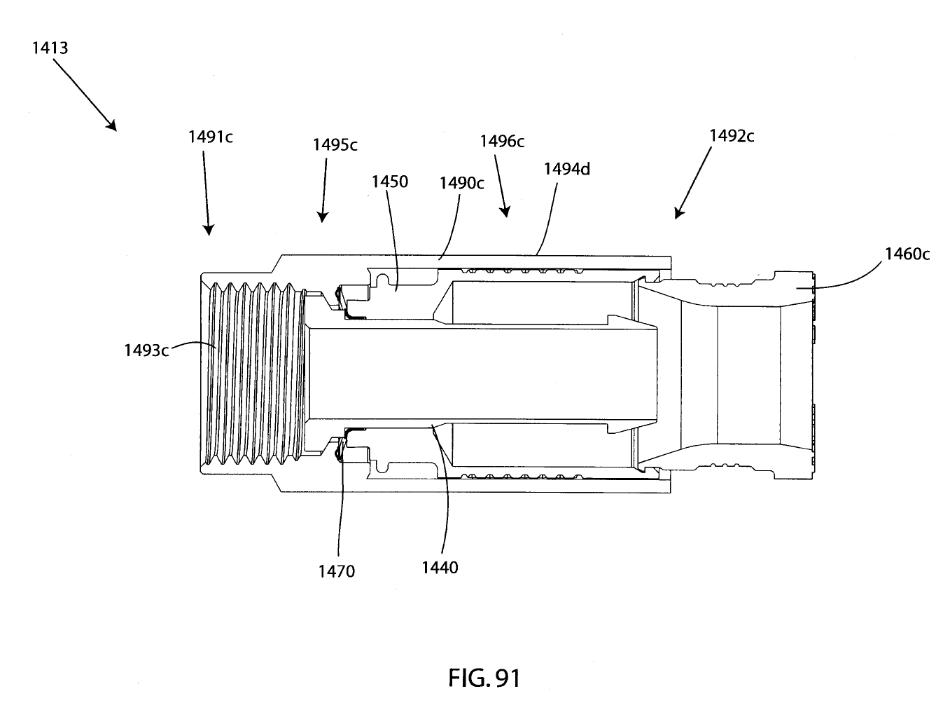

FIG. 91 depicts and embodiment of connector 1413. Embodiments of connector 1413 may include an integral sleeve 1490c, a post 1440, a connector body 1450, a continuity member 1470, and a compression portion 1460c.

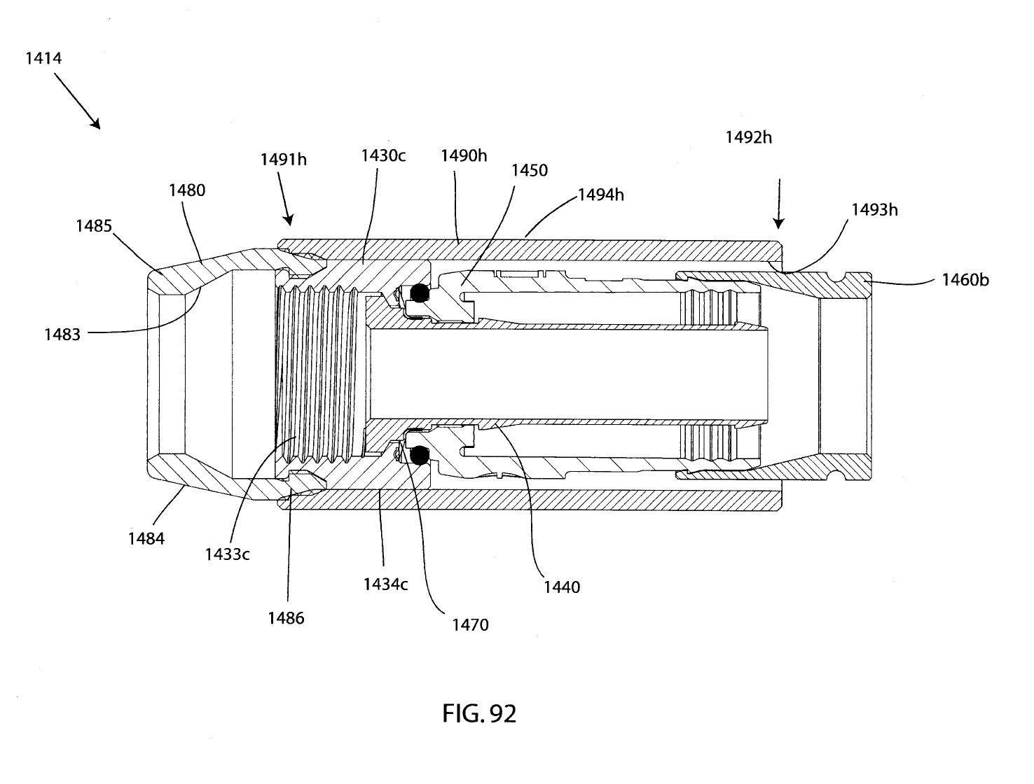

Referring now to FIG. 92, embodiments of connector 1414 may include a coupling member 1430c, a sealing member 1480, a post 1440, a connector body 1450, a continuity member 1470, a sleeve 1490h, and a compression portion 1360b. Embodiments of coupling member 1430c may share the same or substantially the same structural and functional aspects as coupling member 1330c, described supra. Embodiments of sleeve 1490h may share the same or substantially the same structural and functional aspects of sleeve 1390h, described supra. Similarly, embodiments of sealing member 1480 may share the same or substantially the same structural and functional aspects as sealing member 1380, described supra.

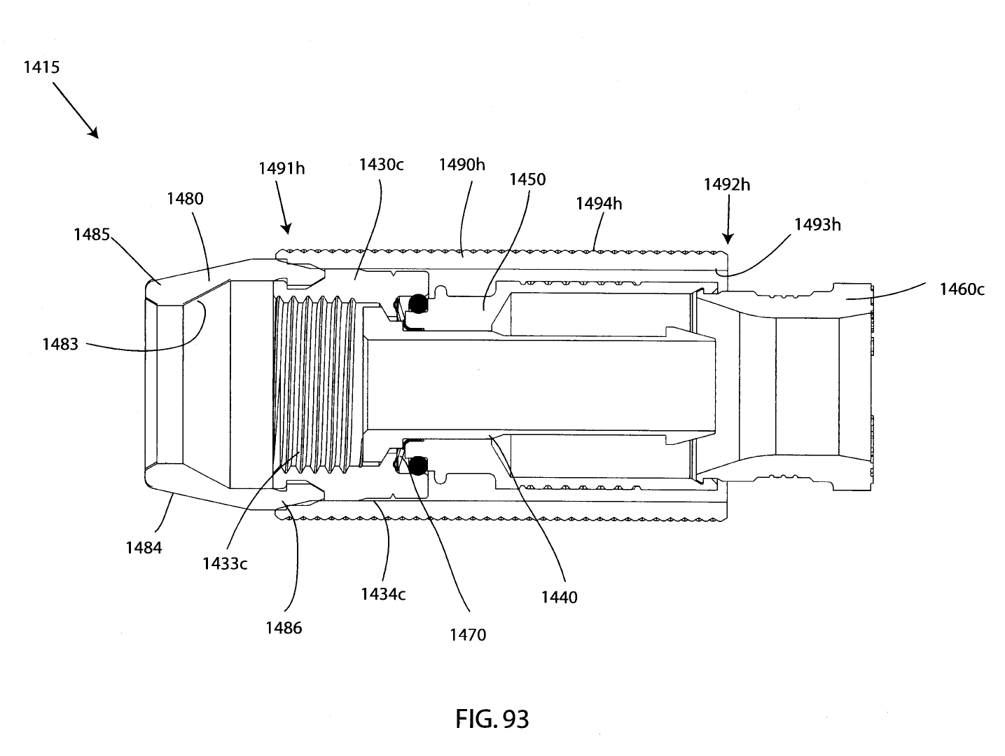

FIG. 93 depicts an embodiment of connector 1415. Embodiments of connector 1415 may include a coupling member 1430c, a sealing member 1480, a post 1440, a connector body 1450, a continuity member 1470, a sleeve 1490h, and a compression portion 1460c.

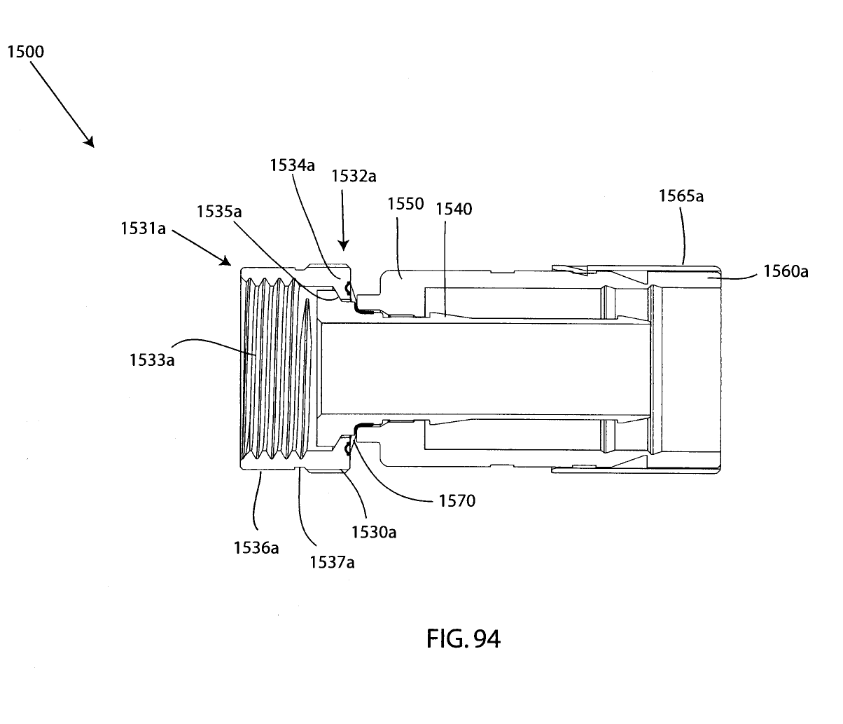

With continued reference to the drawings, FIGS. 94-102, embodiments of connector 1500-1508 may include a coupling member 1530, a post 1540, a connector body 1550, a continuity member 1570, a compression portion 1560a, and a radial restriction member 1565. Embodiments of coupling member 1530 may be coupling member 1530a or 1530b, described in further detail infra. Similarly, embodiments of radial restriction member 1565 may be 1565a, 1565b or 1565c, described in further detail infra. Furthermore, embodiments of post 1540 and connector body 1550 may share the same or substantially the same structural and functional aspects of the embodiments of post 40/940/1040/1140/1240/1340/1440 and connector body 50/950/1050/1150/1250/1350/1450 described supra. Embodiments of continuity element 1570 may be disposed in the same or substantially the same location in connector 1500-1508 and may share the same structural and functional aspects as continuity member 70/170/270/370/470/570/670/970/1070/1170/1270/1370/1470, as described supra. However, continuity member 1570 may share the same structural and functional aspects of continuity member 770/870 if connector body 1550 is appropriately modified to accommodate continuity member 770/870. Connectors 1500-1508 may come in a preassembled configuration or may require additional operable attachment of connector components during installation.

Referring to FIG. 94, embodiments of connector 1500 may include a coupling member 1530a, a post 1540, a connector body 1550, a continuity member 1570, compression portion 1560a, and a radial restriction member 1565a.

Embodiments of connector 1500 may include a coupling member 1530a. Coupling member 1530a may share the same or substantially the same structural and functional aspects of coupling member 1330a/1430a. Accordingly, coupling member 1530a may include a first end 1531a, a second end 1532a, an inner surface 1533a, an outer surface 1536a, an internal lip 1534a, such as an annular protrusion, located proximate the second rearward end 1532a of the coupling member 1530a, wherein the internal lip 1534a includes a surface 1535a facing the first forward end 1531a of the coupling member 1530a. However, coupling member 1530a need not include an engagement member 1597a, as described in association with coupling member 1330a/1430a.

Embodiments of connector 1500 may also include a compression portion 1560a. Compression portion 1560a may share the same or substantially the same structural and functional aspects of compression portion 1360a. Accordingly, compression portion 1560a may be operably attached to the connector body 1550. For instance, the compression portion 1560a may be structurally integral with the connector body 1550, wherein the compression portion 1560a separates from the connector body 1550 upon an axial force which in turn radially compresses the second end of the connector body 1550 onto the coaxial cable 10. Moreover, the structural connection or configuration between the connector body 1550 and the compression portion 1560a may be defined by an internal annular notch 1566a or groove of the compression portion 1565a and an outer ramped surface 1556 of the connector body 1550.

Furthermore, embodiments of connector 1500 may include a radial restriction member 1565a. Radial restriction member 1565a may share the same structural and functional aspects of radial restriction member 1365a. Accordingly, the radial restriction member 1565a may be a bushing or similar annular tubular member disposed proximate the rearward second end of the connector body 1550 that may prevent the compression portion 1560a from splintering or otherwise displacing in a direction other than substantially axial towards the coupling member 1530. Embodiments of the compression portion 1560a may create an environmental seal around the coaxial cable 10 when in the fully compressed position. Those skilled in the requisite art should appreciate that the seal may be created by the compression portion 1560a without the radial restriction member 1565a. However, the radial restriction member 1565a significantly enhances the structural integrity and functional operability of the compression portion, for example, when it is compressed and sealed against an attached coaxial cable 10.

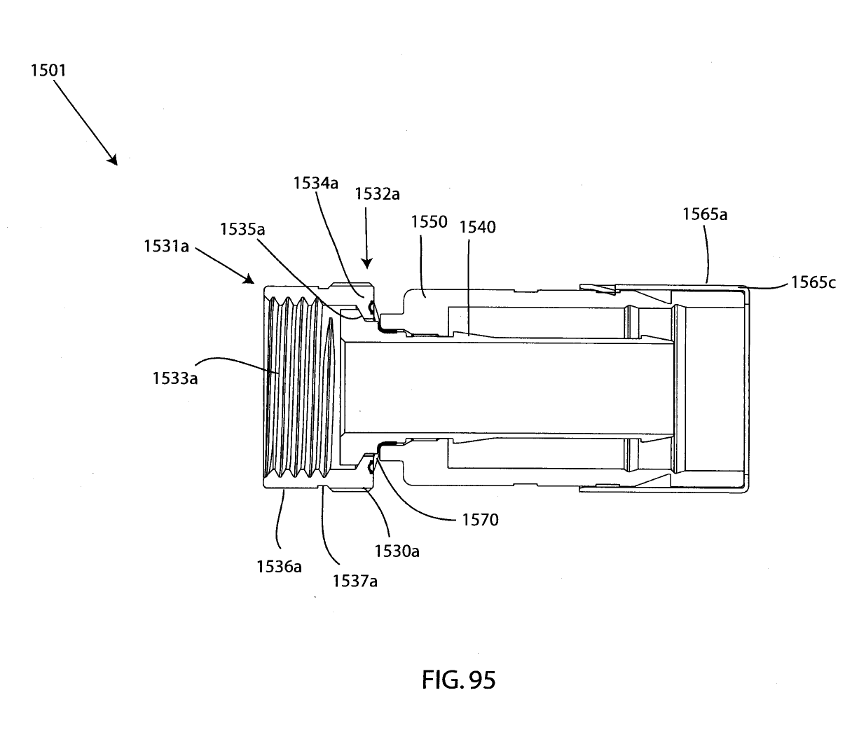

Referring now to FIG. 95, embodiments of connector 1501 may include a coupling member 1530a, a post 1540, a connector body 1550, a continuity member 1570, a compression portion 1560a, and a radial restriction member 1565c. Embodiments of radial restriction member 1565c may share the same or substantially the same structural and functional aspects of radial restriction member 1365c, as described supra. For example, radial restriction member 1565c may be a cap member, or similar generally annular, tubular member having an engagement surface for operable engagement with a compression tool, wherein radial restriction member 1565c may prevent the compression portion 1560a from splintering or otherwise displacing in a direction other than substantially axial towards the coupling member 1530.

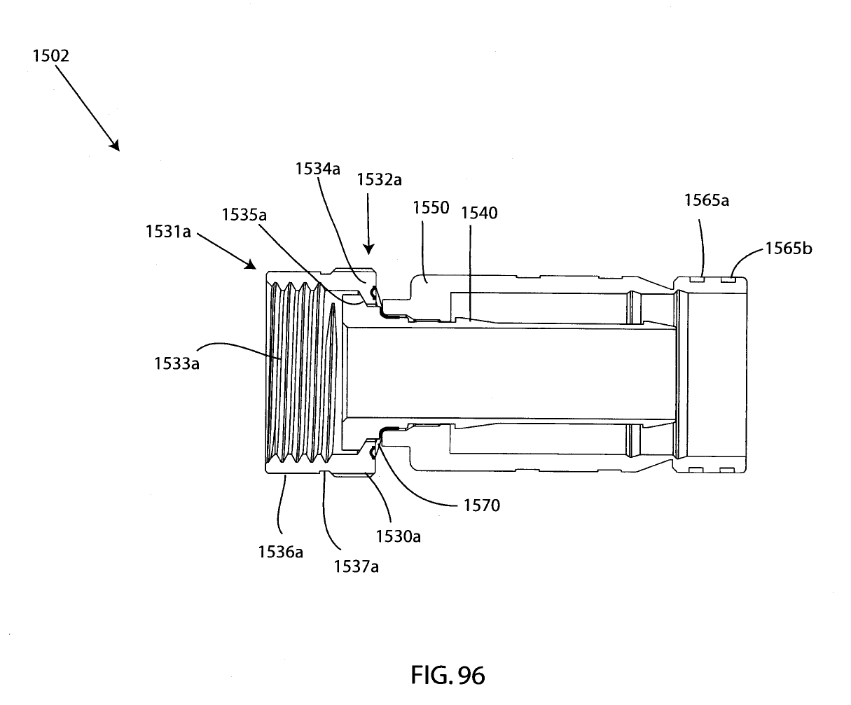

With reference to FIG. 96, embodiments of connector 1502 may include a coupling member 1530a, a post 1540, a connector body 1550, a continuity member 1570, a compression portion 1560a, and a radial restriction member 1565b. Embodiments of radial restriction member 1565b may share the same or substantially the same structural and functional aspects of radial restriction member 1365b, as described supra. For example, radial restriction member 1565b may be one or more straps or bands that extend annularly around or partially around the compression portion 1560a that may prevent the compression portion 1560a from splintering or otherwise displacing in a direction other than substantially axial towards the coupling member 1530.

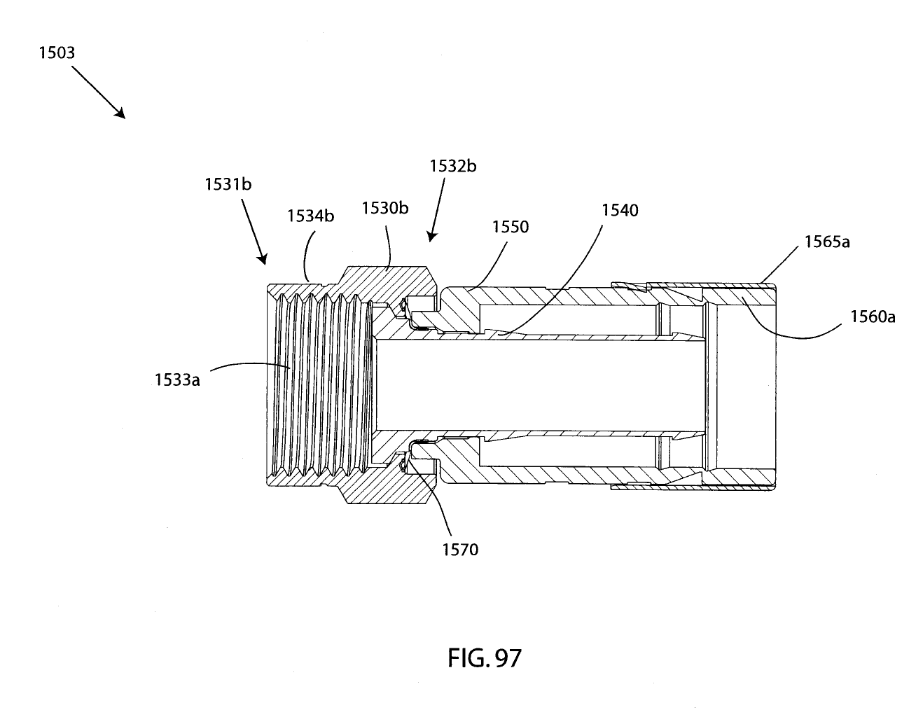

Referring now to FIG. 97, embodiments of connector 1503 may include a coupling member 1530b, a post 1540, a connector body 1550, a continuity member 1570, a compression portion 1560a, and a radial restriction member 1565a. Embodiments of connector 1503 may include a coupling member 1530b. Coupling member 1530b may share the same or substantially the same structural and functional aspects of the embodiments of nut 30/930/1030/1130/1230/1330b/1430b, such as being mated, threaded or otherwise, to a corresponding interface port 20. Accordingly, coupling member 1530b may include a first end 1531b, a second end 1532b, an inner surface 1533b, an outer surface 1536b, an internal lip 1534b, such as an annular protrusion, located proximate the second rearward end 1532b of the coupling member 1530b, wherein the internal lip 1534b includes a surface 1535b facing the first forward end 1531b of the coupling member 1530b. However, coupling member 1530b need not include an engagement member 1597b, as described in association with coupling member 1330b/1430b.

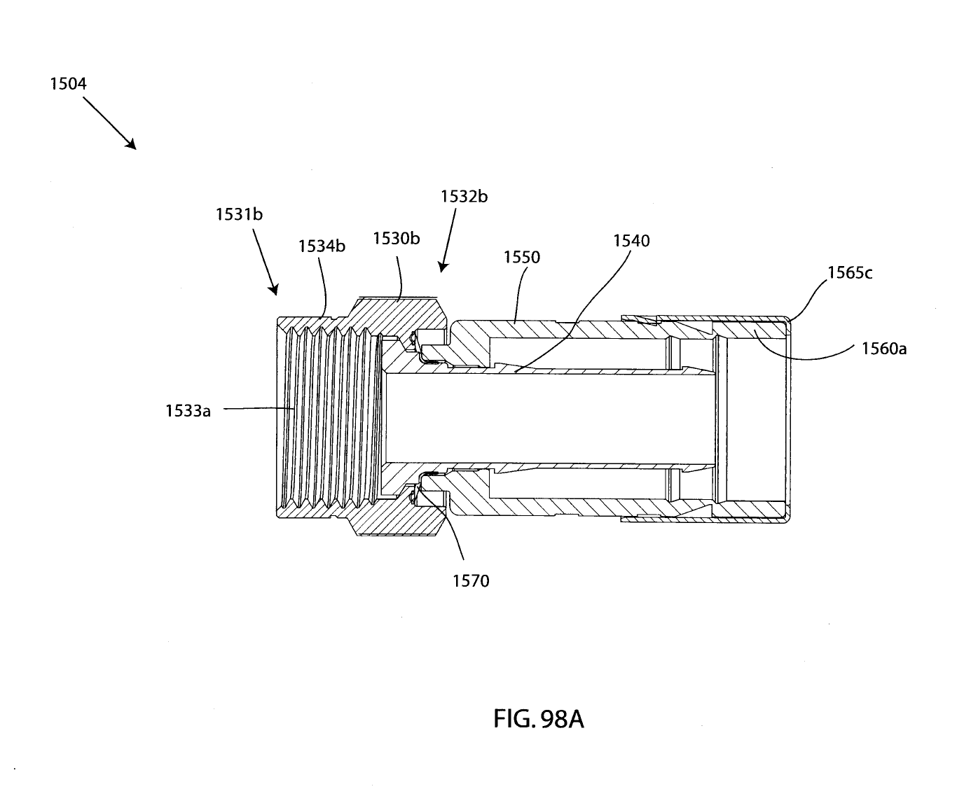

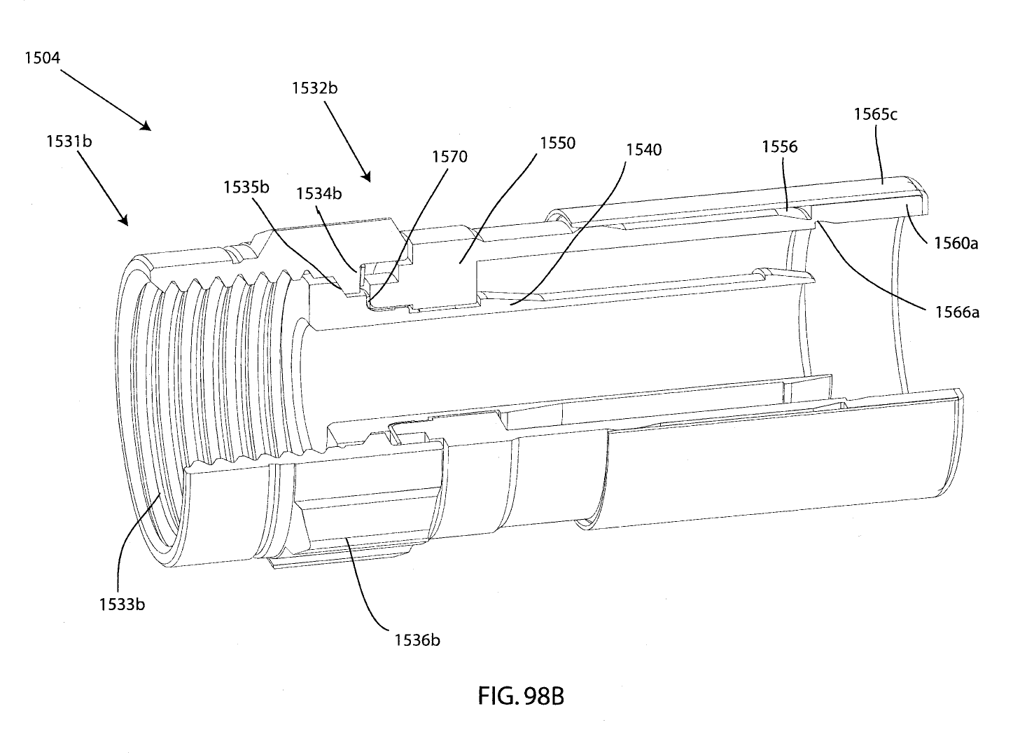

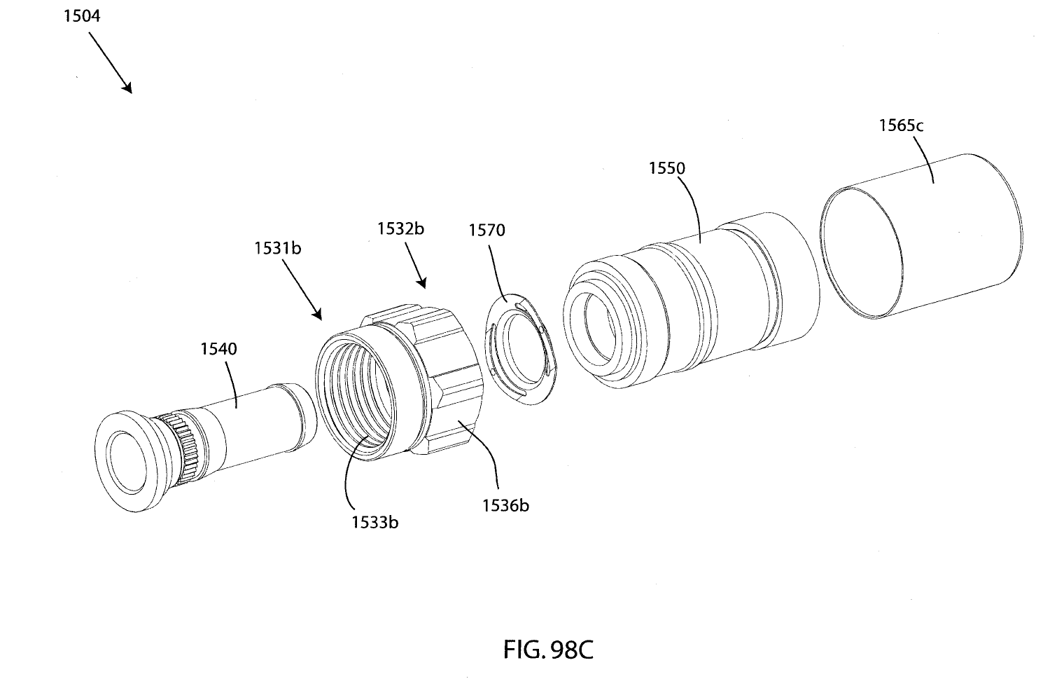

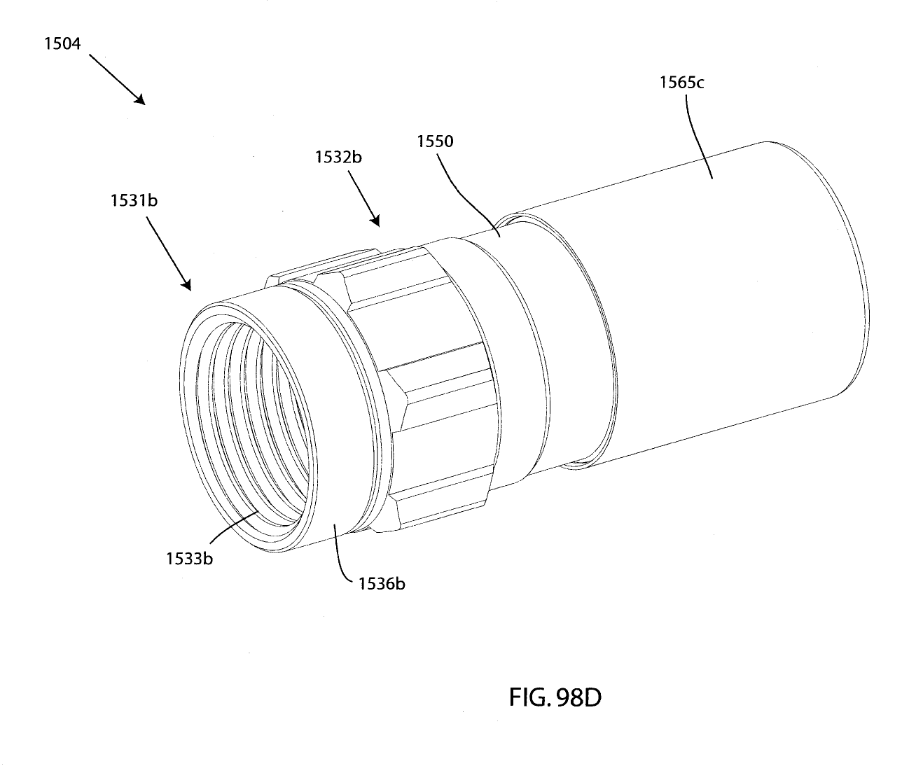

FIGS. 98A-98D depict an embodiment of connector 1504. Embodiments of connector 1504 may include a coupling member 1530b, a post 1540, a connector body 1550, a continuity member 1570, a compression portion 1560a, and a radial restriction member 1365c.

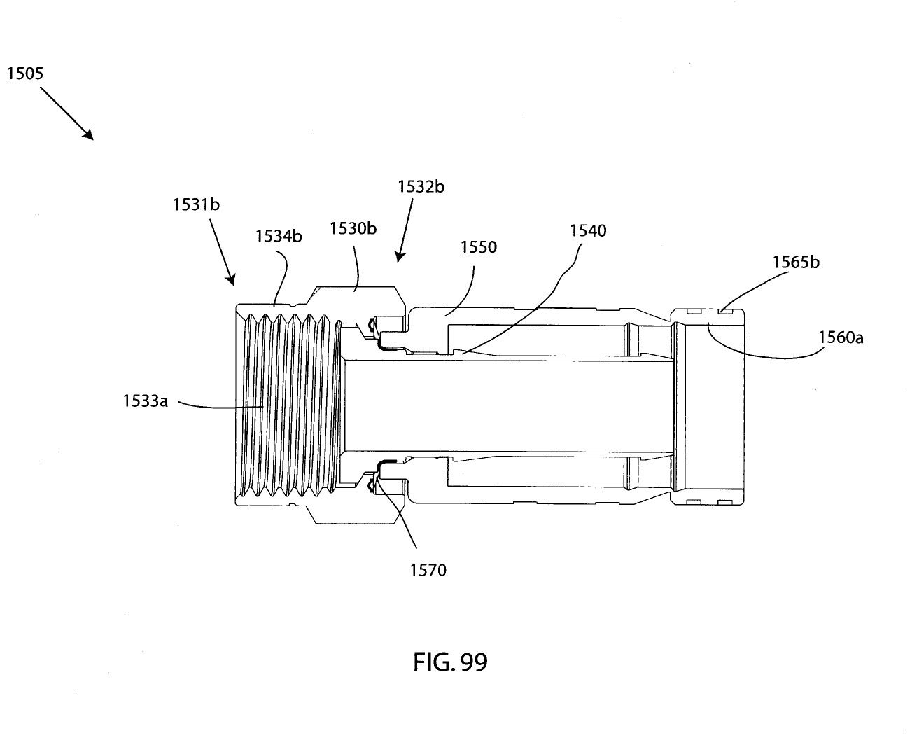

FIG. 99 depicts an embodiment of connector 1505. Embodiments of connector 1505 may include a coupling member 1530b, a post 1540, a connector body 1550, a continuity member 1570, a compression portion 1560a, and a radial restriction member 1365b.

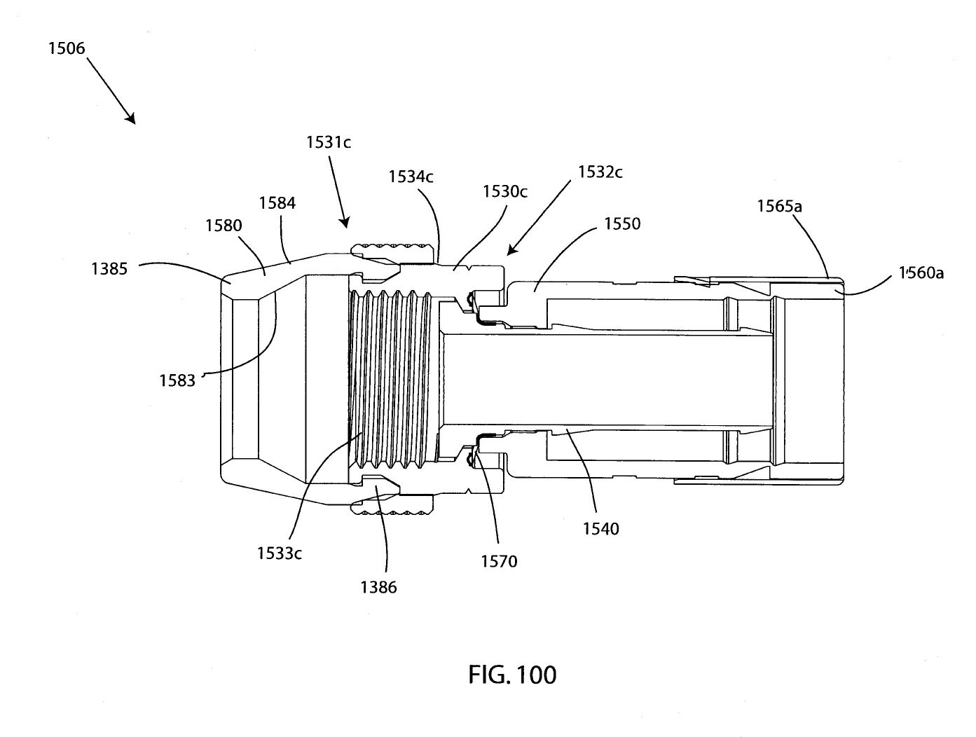

With reference now to FIG. 100, embodiments of connector 1506 may include a coupling member 1530c, a sealing member 1580, a post 1540, a connector body 1570, compression portion 1560a, and a radial restriction member 1365a. Embodiments of coupling member 1530c may share the same or substantially the same structural and functional aspects as coupling member 1330c/1430c, described supra. Embodiments of sleeve 1590h may share the same or substantially the same structural and functional aspects of sleeve 1390h/1490h, described supra. Similarly, embodiments of sealing member 1580 may share the same or substantially the same structural and functional aspects as sealing member 1380/1480, described supra.

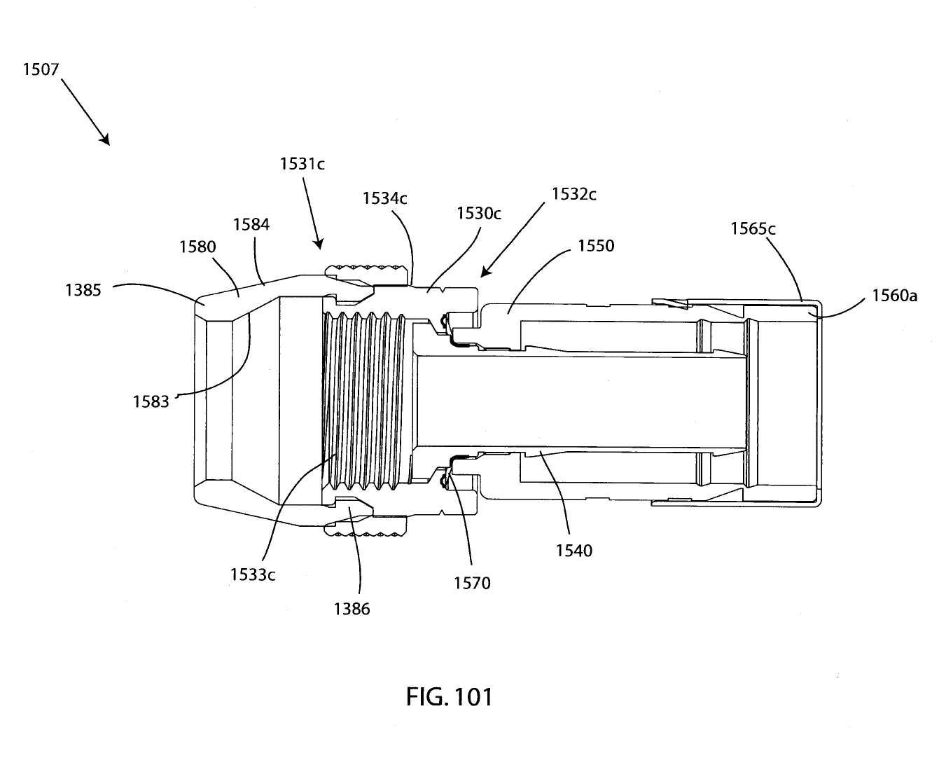

FIG. 101 depicts an embodiment of connector 1507. Embodiments of connector 1507 may include a coupling member 1530c, a sealing member 1580, a post 1540, a connector body 1570, compression portion 1560a, and a radial restriction member 1365c.

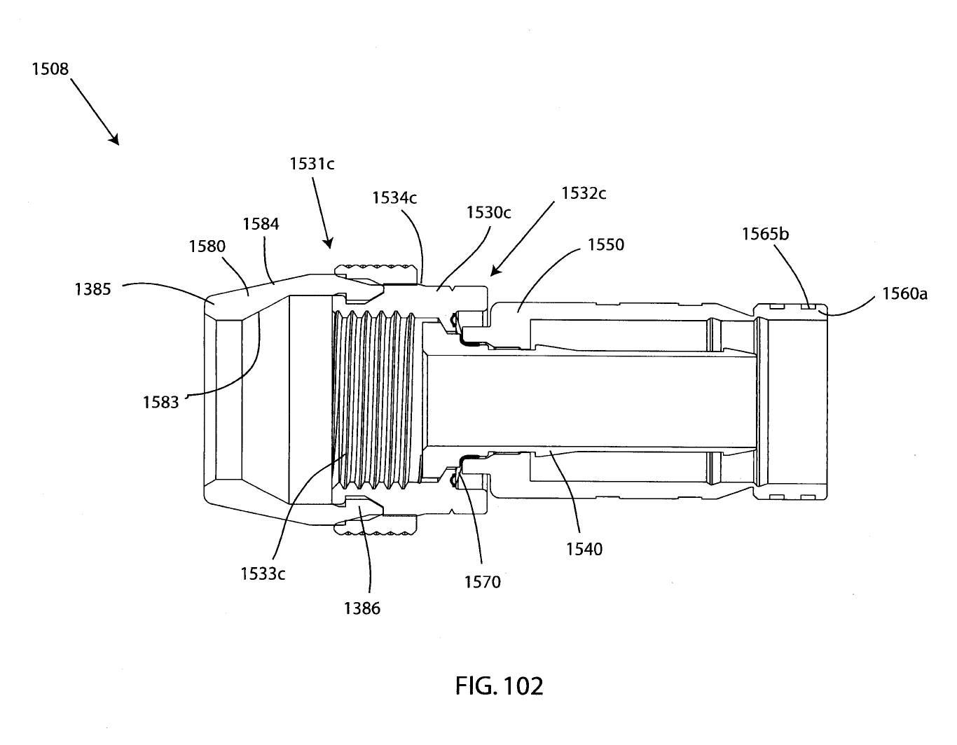

FIG. 102 depicts an embodiment of connector 1508. Embodiments of connector 1508 may include a coupling member 1530c, a sealing member 1580, a post 1540, a connector body 1570, compression portion 1560a, and a radial restriction member 1365b.

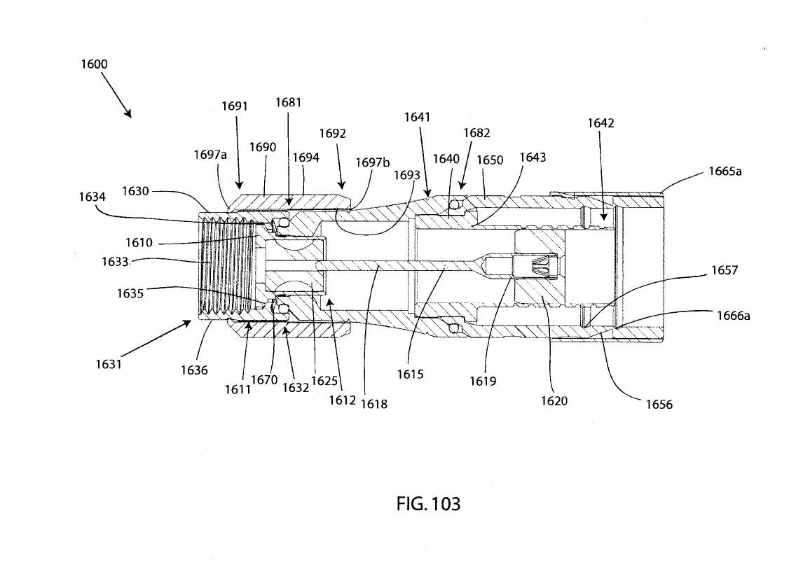

Referring still to the drawings, FIGS. 103-107 depict embodiments of connectors 1600-1605. Embodiments of connector 1600-1605 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, and a compression portion 1660. Embodiments of a compression portion 1660 may be compression portion 1660a, compression portion 1660b, or compression portion 1660c. Embodiments of connector 1600-1602 may further include a radial restriction member 1650, wherein radial restriction member 1650 may include radial restriction member 1650a, radial restriction member 1650b, or radial restriction member 1650c. Furthermore, embodiments of continuity member 1670 share the same structural and functional aspects as continuity member 70/170/270/370/470/570/670/970/1070/1170/1270/1370/1470/1570, as described supra. However, continuity member 1670 may share the same structural and functional aspects of continuity member 770/870 if connector body 1650 is appropriately modified to accommodate continuity member 770/870. Connectors 1600-1604 may come in a preassembled configuration or may require additional operable attachment of connector components during installation.

FIG. 103 depicts an embodiment of connector 1600. Embodiments of connector 1600 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, a compression portion 1660a, and a radial restriction member 1650a.

Embodiments of connector 1600 may include a coupling member 1630. Coupling member 1630 may share the same or substantially the same structural and functional aspects of coupling member 1330/1430/1530. Accordingly, coupling member 1630 may include a first end 1631, a second end 1632, an inner surface 1633, an outer surface 1636, an internal lip 1634, such as an annular protrusion, located proximate the second rearward end 1632 of the coupling member 1630, wherein the internal lip 1634 includes a surface 1635 facing the first forward end 1631 of the coupling member 1630. Moreover, coupling member 1630a may include an retaining structure 1637 configured to retain, accommodate, receive, or mate with an engagement member 1697a of the sleeve 1690, and an outer surface feature(s) 1638 proximate or otherwise near the second end 1668 to improve mechanical interference or friction between the coupling member 1630 and the sleeve 1690. Retaining structure 1637 may share the same structural and functional aspects of retaining structure 1337a/1337b, described supra. However, coupling member 1630 may be axially rotatable with respect to a port face engagement member 1610 such that the coupling member 1630 may freely rotate about the port face engagement member 1610 and the connector body 1650.

Embodiments of the connector 1600 may include a port face engagement member 1610. Port face engagement member 1610 may be disposed within a portion of the generally axial opening of the coupling member 1630 and a portion of the generally axially opening of an extension member 1680. Embodiments of the port face engagement member 1610 may include a first end 1611, an opposing second 1612, and a flange 1613 proximate the first end 1611. The flange 1613 may include an outwardly extending portion with a tapered surface, wherein the tapered surface of the flange 1613 opposingly corresponds to the tapered surface of the lip 1634 of the coupling member 1630 for operable engagement with the coupling member 1630. The flange 1613 may also include an inwardly extending portion that is configured to engage an insulator body 1625 disposed within the tubular opening of the post face engagement member 1610. The engagement between the inwardly extending portion of the flange 1613 and the insulator body 1625 may prevent or hinder axial movement of the insulator body 1625 when accepting the center conductor pin portion 1618 of the center conductor clamp 1615 and engaging a driver member 1620. While the insulator body 1610 should be formed of materials having insulating properties, the port face engagement member 1610 should be formed of conductive materials to extend a grounding path through the coaxial cable connector to an interface port, such as interface port 20.

With continued reference to FIG. 103, embodiments of connector 1600 may include an extension member 1680. The extension member may be operably attached or engageable with the port face engagement member 1610. The extension member 1680 may include a first end 1681, a second end 1682, an inner surface 1683, and an outer surface 1684. The extension member 1680 may be disposed between the coupling member 1630 and the connector body 1650. Moreover, the extension member 1680 may include a retaining structure 1687 on the outer surface 1684 to help engage, retain, accommodate, etc., the sleeve 1690, in particular, an engagement member 1697b of the sleeve 1690b. However, the sleeve 1690 should be able to freely rotate about the extension member 1680. For instance, the retaining structure 1687 of the extension member 1680 may be sized and dimensioned so as to not overly restrict rotational movement of the sleeve 1690, and some clearance between the outer surface 1684 and the sleeve 1690 may be maintained to allow for free rotational movement of the sleeve 1690. The extension member 1680 can be formed of conductive materials. Manufacture of the extension member 1680 may include casting, extruding, cutting, turning, drilling, knurling, injection molding, spraying, blow molding, component overmolding, combinations thereof, or other fabrication methods that may provide efficient production of the component.

Embodiments of connector 1600 may further include an outer sleeve 1690. The outer sleeve 1690 may be disposed over the coupling element, or a portion thereof, and the extension member 1680, or a portion thereof. Sleeve 1690 may share the same or substantially the same structural and functional aspects of sleeve 1390a described supra. Accordingly, the sleeve 1690 may include a first end 1691, a second 1692, an inner surface 1693, and an outer surface 1694, and may be a generally annular member having a generally axial opening therethrough. Moreover, the sleeve 1690 may also include at least one engagement member 1697a, 1697b configured to mate or engage with at least one of (or both) the retaining structure 1637 of the coupling member 1680 and the retaining structure 1687 of the extension member 1680. The sleeve 1690 may further include internal surface features 1698 to improve the contact between the coupling member 1630 and sleeve 1690, and may include an outer surface feature(s) 1698. For example, embodiments of the sleeve 1690 may include outer surface features 1699, such as annular serrations or slots, configured to enhance gripping of the sleeve 1690 while connecting the coaxial cable connector onto an interface port.

Embodiments of connector 1600 may include a connector body 1650. Connector body 1650 may connector body 1650 may share the same or substantially the same structural and functional aspects of the embodiments connector body 50/950/1050/1150/1250/1350/1450 described supra. The connector body 1650 may be operably attached or engageable with the post 1640, and may also physically communicate with the extension member 1680 proximate the second end 1682 of the extension member 1680.

Referring still to FIG. 103, embodiments of connector 1600 may include a post 1640. Embodiments of post 1640 may share the same structural and functional aspects of post 40/940/1040/1140/1240/1340/1440 described supra. Accordingly, the post 1640 may include a first end 1641, a second end 1642, an inner surface 1643, and an outer surface 1633. The post 1640 may include a thicker portion 1643 proximate or otherwise near the first end 1641 of the post 1640 for operable engagement with the extension member 1680 and the connector body 1650.

Embodiments of connector 1600 may include a center conductor clamp 1615. Center conductor clamp 1618 may include a center conductor pin portion 1618 and a socket portion 1618. Center conductor clamp 1615 may be a conductive element that may extend or carry an electrical current and/or signal from a first point to a second point. For example, center conductor clamp 1615 may be a terminal, a pin, a conductor, an electrical contact, and the like, and should be formed of conductive materials. Furthermore, embodiments of center conductor clamp 1615 may include a socket portion 1619. Embodiments of the socket portion 1619 may include a socket that may be a clamp or basket that clamps, grips, collects, or is configured to mechanically communicate with the center conductive strand 18 of a coaxial cable 10. The socket portion 1619 may reside within an opening of a driving member 1620.

Furthermore, embodiments of connector 1600 may include a driver member 1620. The driver member 1620 may be disposed within the tubular opening of the post 1640. Embodiments of the driver member 1620 may include a first end 1621 and an opposing second 1622, and may further include a central opening to accommodate the socket portion 1619 of a center conductor clamp 1615. The end face/surface of the driver member 1620 proximate the second end 1622 may be configured to engage the dielectric 16 of the coaxial cable 10 as the cable is axially inserted into the connector. As the cable 10 is further axially inserted into the connector, the center conductor 18 enters the socket portion 1619 of the center conductor clamp 1615, and the dielectric 16 engages the driver member 1620, and the driver member 1620 moves axially along with the center conductor clamp 1615 until the driver member 1620 physically engages the insulator body 1610 disposed within the post face engagement feature 1610. Once engagement occurs with between the first end 1621 of the driver member 1620 and the insulator body 1610, the center conductor clamp 1615 may be axially stationary and the center conductor pin portion 1318 may be disposed within the general axial opening of the coupling member 1630.

Additionally, embodiments of connector 1600 may include a compression portion 1660a. Compression portion 1660a may share the same or substantially the same structural and functional aspects of compression portion 1360a/1560a. Accordingly, compression portion 1660a may be operably attached to the connector body 1650. For instance, the compression portion 1660a may be structurally integral with the connector body 1650, wherein the compression portion 1660a separates from the connector body 1650 upon an axial force which in turn radially compresses the second end of the connector body 1650 onto the coaxial cable 10. Moreover, the structural connection or configuration between the connector body 1650 and the compression portion 1660a may be defined by an internal annular notch 1666a or groove of the compression portion 1660a and an outer ramped surface 1656 of the connector body 1650.

Embodiments of connector 1600 may further include a radial restriction member 1650a. Radial restriction member 1665a may share the same structural and functional aspects of radial restriction member 1365a/1565a. Accordingly, the radial restriction member 1665a may be a bushing or similar annular tubular member disposed proximate the rearward second end of the connector body 1650 that may prevent the compression portion 1660a from splintering or otherwise displacing in a direction other than substantially axial towards the coupling member 1630. Embodiments of the compression portion 1660a may create an environmental seal around the coaxial cable 10 when in the fully compressed position. Those skilled in the requisite art should appreciate that the seal may be created by the compression portion 1660a without the radial restriction member 1665a. However, the radial restriction member 1665a significantly enhances the structural integrity and functional operability of the compression portion, for example, when it is compressed and sealed against an attached coaxial cable 10.

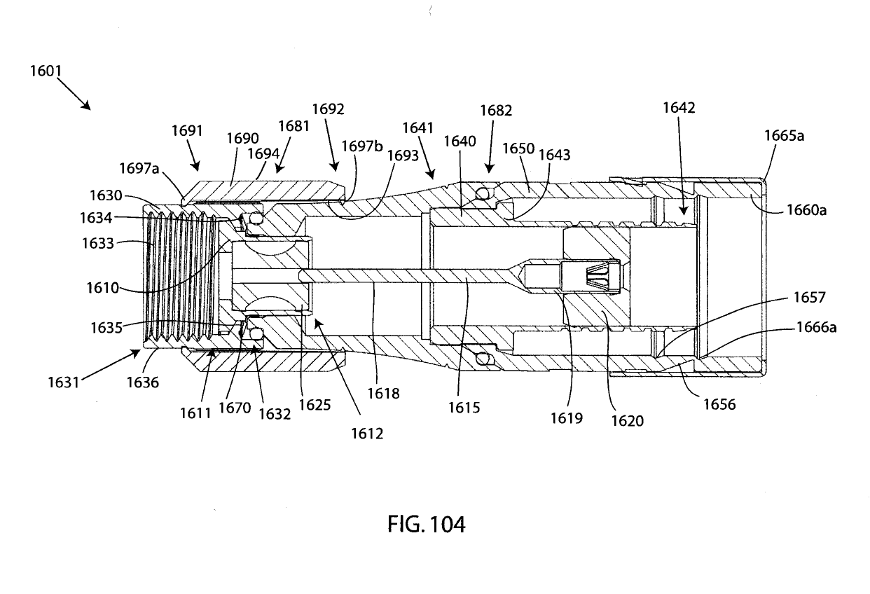

FIG. 104 depicts an embodiment of connector 1601. Embodiments of connector 1601 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, a compression portion 1660a, and a radial restriction member 1650c. Embodiments of radial restriction member 1665c may share the same or substantially the same structural and functional aspects of radial restriction member 1365c/1565c, as described supra. For example, radial restriction member 1665c may be a cap member, or similar generally annular, tubular member having an engagement surface for operable engagement with a compression tool, wherein radial restriction member 1665c may prevent the compression portion 1660a from splintering or otherwise displacing in a direction other than substantially axial towards the coupling member 1630.

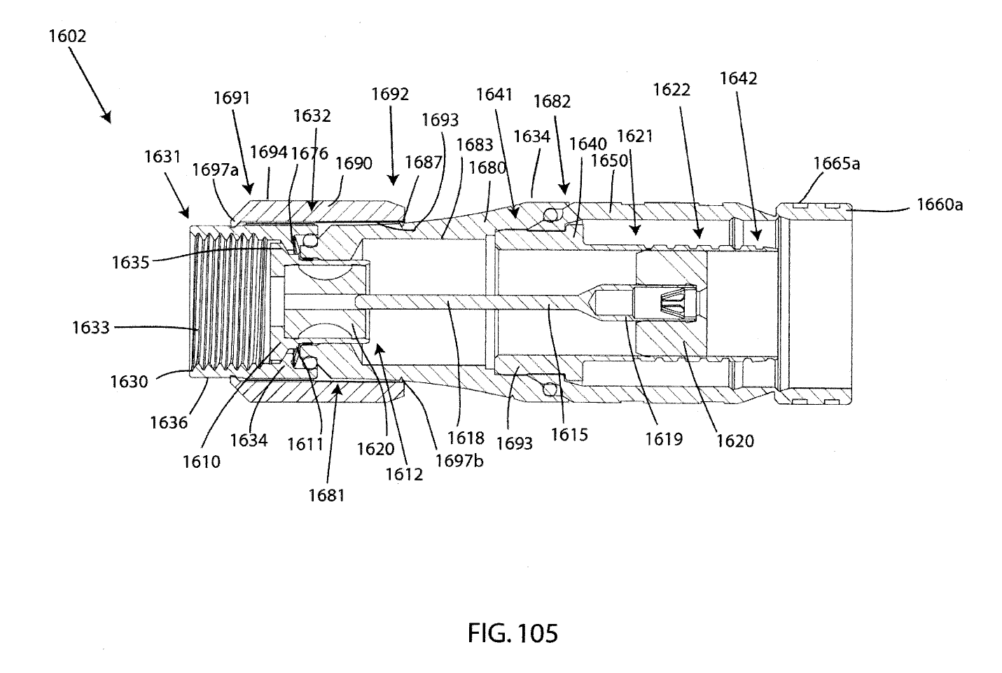

FIG. 105 depicts an embodiment of connector 1602. Embodiments of connector 1602 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, a compression portion 1660, and a radial restriction member 1650b. Embodiments of radial restriction member 1665b may share the same or substantially the same structural and functional aspects of radial restriction member 1365b/1565b, as described supra. For example, radial restriction member 1665b may be one or more straps or bands that extend annularly around or partially around the compression portion 1660a that may prevent the compression portion 1660a from splintering or otherwise displacing in a direction other than substantially axial towards the coupling member 1630.

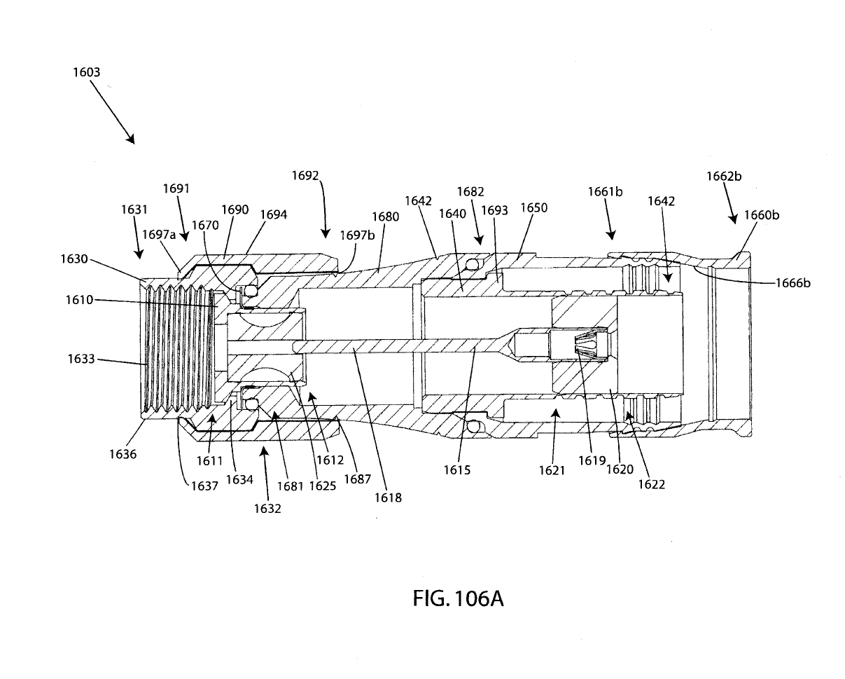

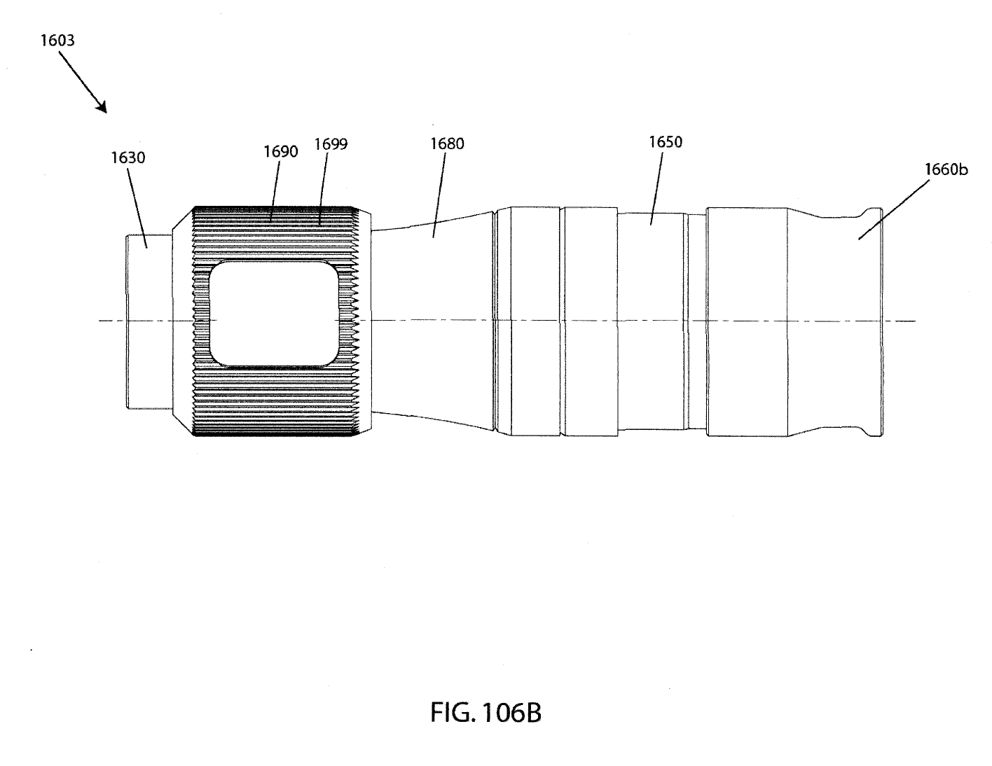

FIGS. 106A-106B depict an embodiment of connector 1603. Embodiments of connector 1603 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, and a compression portion 1660b.

Embodiments of connector 1603 may include a compression portion 1660b. Compression portion 1660b may share the same or substantially the same structural and functional aspects of fastener member 60 and compression portion 1460b, as described supra. Accordingly, compression portion 1660b may have a first end 1661b and opposing second end 1662b, and a ramped surface 1666b which may be positioned between a first opening or inner bore having a first diameter positioned proximate with the first end 1661b of the compression portion 1660b and a second opening or inner bore having a second diameter positioned proximate with the second end 1662b of the compression portion 1460b to deformably compress the outer surface of a connector body 1650 when the compression portion 1660b is operated to secure a coaxial cable 10.

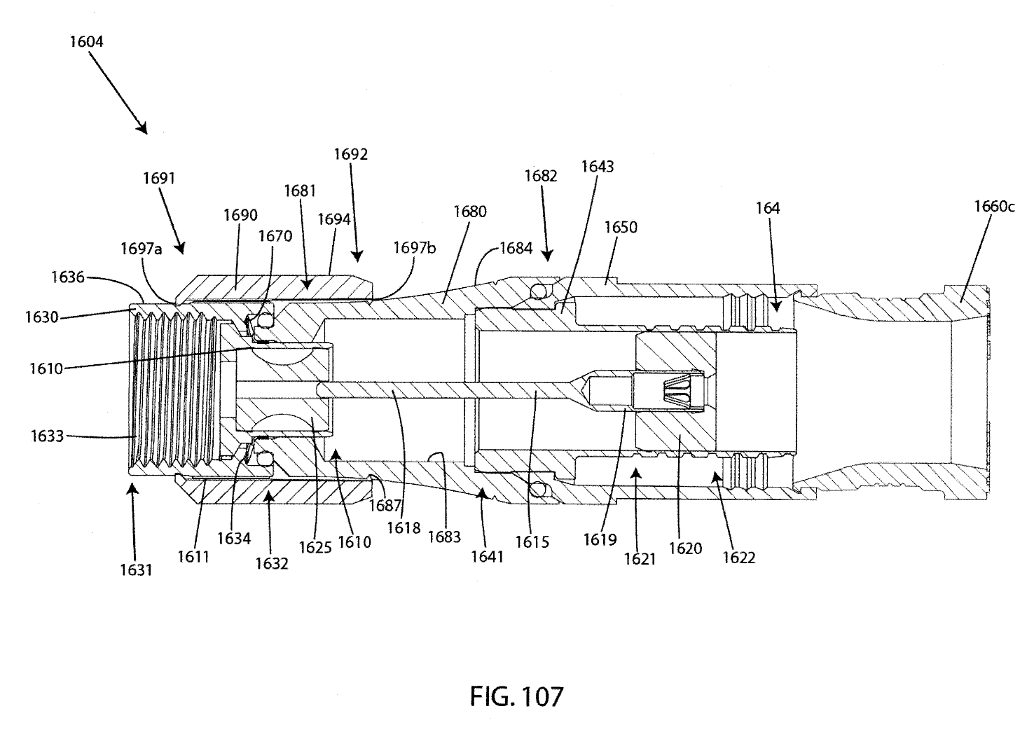

FIG. 107 depicts an embodiment of connector 1604. Embodiments of connector 1604 may include a coupling member 1630, a port face engagement member 1610, an insulator body 1625, a continuity member 1670, an extension member 1680, a sleeve 1690, a connector body 1650, a post 1640, a center conductor clamp 1615, a driver member 1620, and a compression portion 1660c.

Embodiments of connector 1604 may include a compression portion 1660c. Compression portion 1660c may share the same structural and functional aspects of compression portion 1460c. For example, compression portion 1660c may be an insertable compression sleeve or tubular locking compression member that may reside internally with respect to the connector body 1450 when in the compressed position, as described in further detail supra. The compression portion 1660c may include a first end 1661c, a second end 1662c, an inner surface 1663c, and an outer surface 1664c, and may include a lip 1465c proximate the first end 1661c of the compression position 1660c, wherein an internal groove of the connector body 1650 mates with the lip 1665c of the compression portion 1460c.

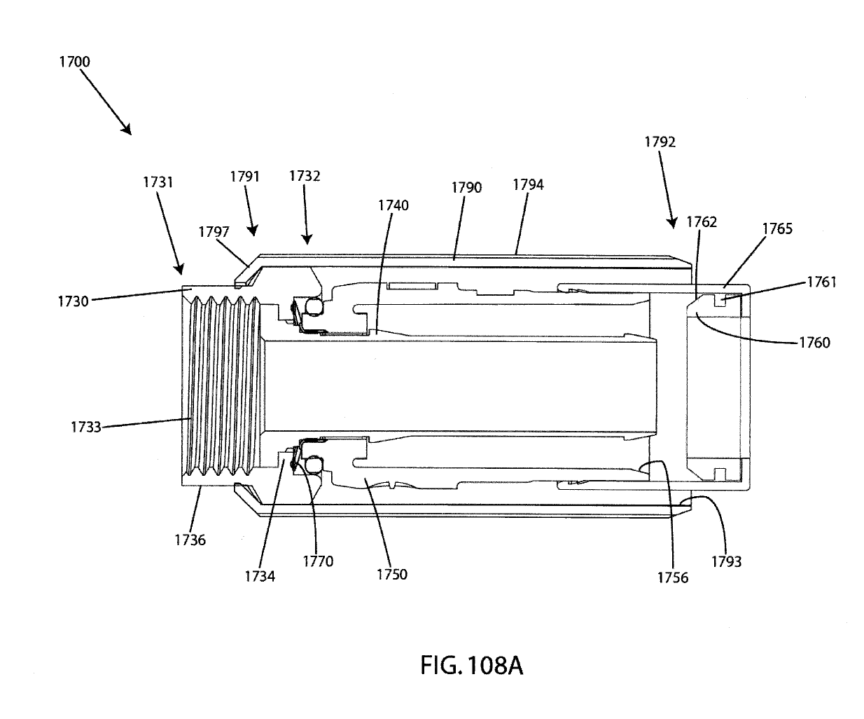

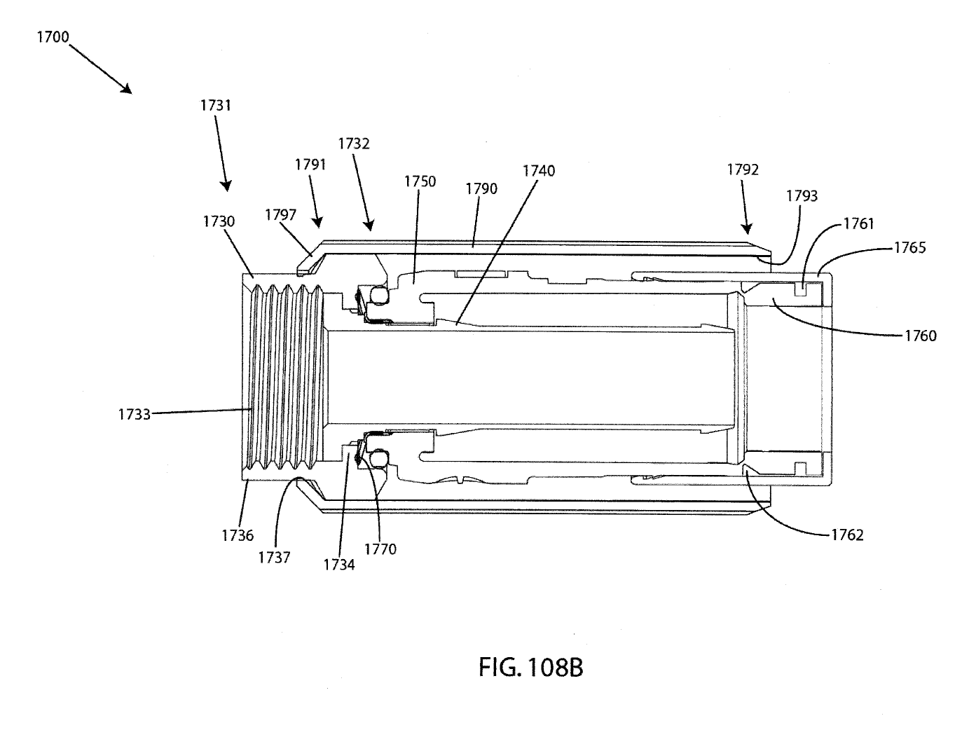

With continued reference to the drawings, FIGS. 108-110 depict embodiments of connector 1700. Embodiments of connector 1700 may include a coupling member 1730, a post 1740, a connector body 1750, a continuity member 1770, a sleeve 1790, a compression portion 1760, and a radial restriction member 1765. Embodiments of post 1740 and connector body 1750 may share the same or substantially the same structural and functional aspects of the embodiments of post 40/940/1040/1140/1240/1340/1440/1540 and connector body 50/950/1050/1150/1250/1350/1450/1550 described supra. Embodiments of continuity member 1770 may be disposed in the same or substantially the same location in a connector 100/900/1000/1100/1200/1300-1323/1400-1415/1501508 and may share the same structural and functional aspects of continuity member 70/170/270/370/470/570/670/970/1070/1170/1270/1370/1470/1570/1670, as described supra. However, continuity member 1770 may share the same structural and functional aspects of continuity member 770/870 if a connector body, such as connector body 1450, is appropriately modified to accommodate the continuity member, such as continuity member 770/870. Connector 1700 may come in a preassembled configuration or may require additional operable attachment of the sleeve 1790 to connector 1700 during installation.

Embodiments of connector 1700 may include a coupling member 1730. Coupling member 1730 may share the same or substantially the same structural and functional aspects of the embodiments of nut 30/930/1030/1130/1230, such as being mated, threaded or otherwise, to a corresponding interface port 20. Accordingly, coupling member 1730 may include a first end 1730, a second end 1730, an inner surface 1730, an outer surface 1736, an internal lip 1734, such as an annular protrusion, located proximate the second rearward end 1732 of the coupling member 1730, wherein the internal lip 1734 includes a surface 1735 facing the first forward end 1731 of the coupling member 1730. Additionally, coupling member 1730 may include a retaining structure 1737 on the outer surface 1736 of the coupling member 1730, similar to retaining structure 1337b, described supra to engage, retain, etc. sleeve 1790.

Embodiments of connector 1700 may include an outer sleeve 1790. Embodiments of sleeve 1790 may share the same structural and functional aspects of sleeve 1390b described in association with, for example, connector 1303. Accordingly, sleeve 1790 may include an engagement member 1797 that is configured to mate or engage with a retaining structure 1737 of the coupling member 1730. For example, the sleeve 1790 may include a first end 1791, a second end 1792, an inner surface 1793, and an outer surface 1794, and may be a generally annular member having a generally axial opening therethrough. However, the sleeve 1790 may be radially disposed over the coupling member 1730, or a portion thereof, the post 1740, the connector body 1750, or a portion thereof, and the compression portion 1760, or a portion thereof, while operably assembled and/or in a compressed position. Additionally, the sleeve 1790 may include an annular ramped surface 1795 or chamfer proximate or otherwise near the first end 1791 to accommodate an increased diameter or general size of the coupling member 1730 proximate a second, rearward end 1732 of the coupling member 1732. Embodiments of the ramped surface 1795 may be structurally integral with the engagement member 1797 and the body of the sleeve 1790.

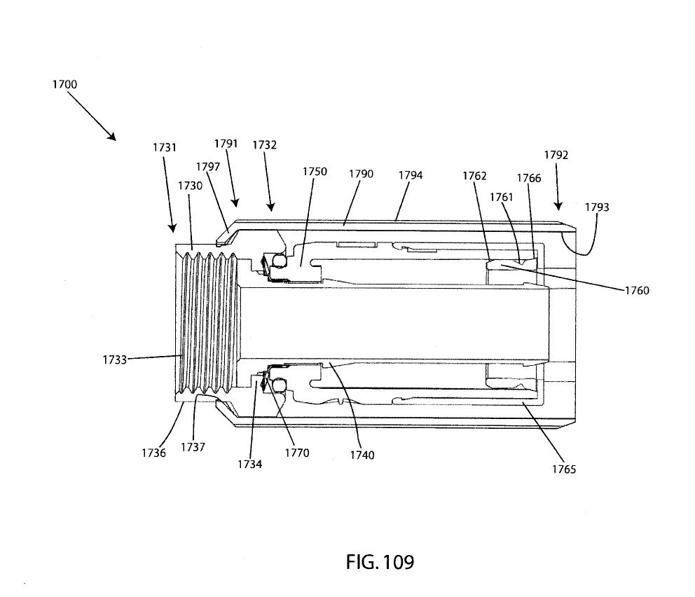

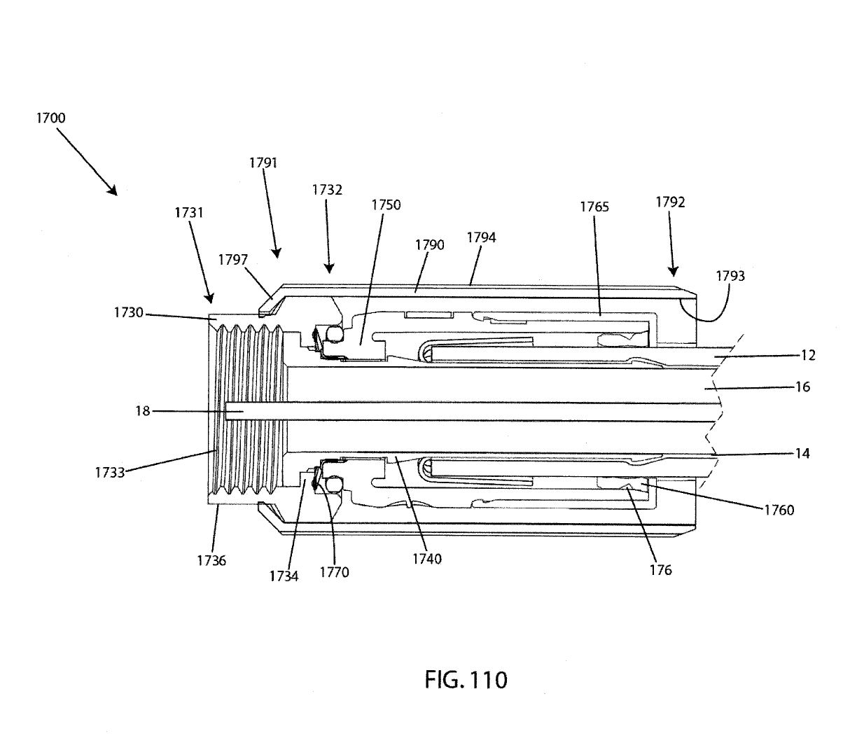

Furthermore, embodiments of connector 1700 may include a compression portion 1760. Compression portion 1760 may be a separate component from the connector body 1750 (as shown in FIG. 108A) or may be structurally integral with the connector body 1750 having a frangible connection therebetween (as shown in FIG. 108B) that may deform upon engagement with the connector body 1750; engagement with the connector body 1750 occurs when an axial force is applied, by a compression tool, or other means of axial compression. For instance, compression portion 1760 may be a generally annular member having an opening therethrough that may be compressed/deformed onto the cable 10 by the inner surface of the connector body 1750. The compression portion 1760 may include one or more notches 1761 to facilitate the deformation of the compression portion 1760. Moreover, the compression portion 1760 may include a tapered or ramped surface 1763 to facilitate even engagement with the connector body 1750, and to further facilitate deformation of the compression portion. The connector body 1750 may include an inner ramped surface 1766 that may opposingly correspond to the ramped surface 1763 of the compression portion. FIGS. 109 and 110 show the manner in which the compression portion deforms upon engagement with the connector body 1750 and ultimately is axially displaced within the connector body 1750 and compressed onto the cable to create a seal around the cable jacket 12. Embodiments of the compression portion 1760 may be made of metal or plastic, or any material that permits deformation under compressive engagement with the connector body 1750.

Embodiments of connector 1700 may further include a radial restriction member 1765. The radial restriction member 1765 may be a bushing or similar annular tubular member having an inwardly extending lip disposed partially over a rearward second end of the connector body 1750, and around the compression portion while in an uncompressed position, as shown in FIG. 108A. For instance, the radial restriction member 1765 may be a generally annular, hollow cylindrically-shaped sleeve-like member comprised of stainless steel or other substantially rigid materials which may structurally assist the compress-seal process of compression portion 1760. Moreover, when the compression portion 1760 is axially compressed in a direction towards the coupling member 1730, the radial restriction member 1760a may axially displace along with the compression portion 1760 and may prevent the compression portion 1730 from splintering or otherwise displacing in a direction other than substantially axial towards the coupling member 1730. Additionally, radial restriction member 1765 may be a cap-like member, or similar generally annular, tubular member having an engagement surface for operable engagement with a compression tool. For instance, embodiments of the radial restriction member 1765 may include an internal annular lip or inwardly extending flange proximate a rearward end of the radial restriction member 1765. The internal lip proximate the rearward end of the radial restriction member 1765 may provide an engagement surface for operable engagement with a compression tool, or other device/means that provides the necessary compression to compress seal connector 1700.

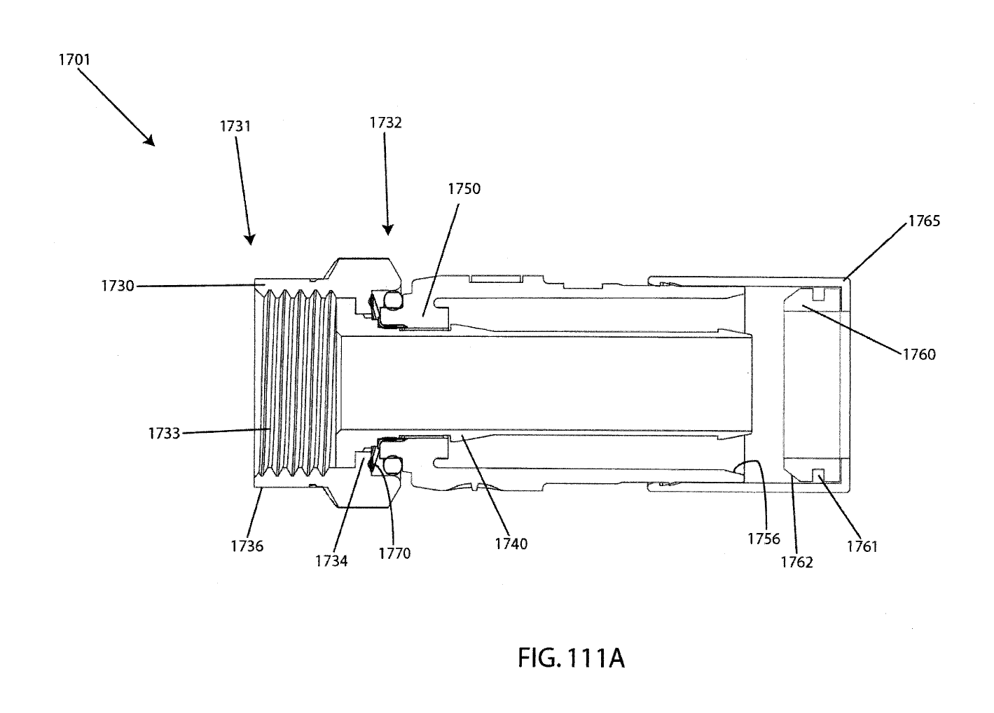

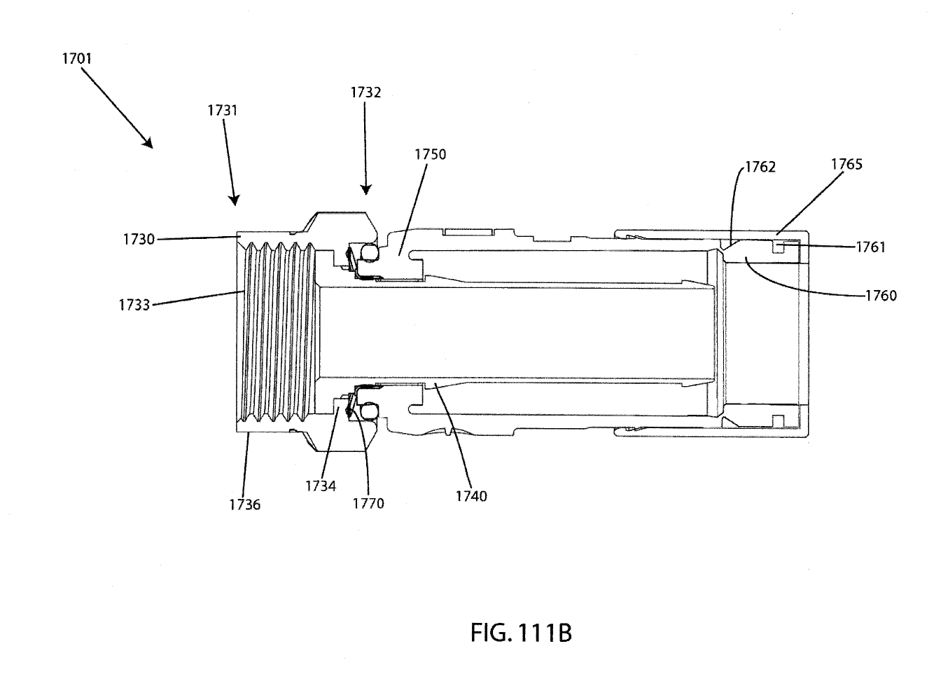

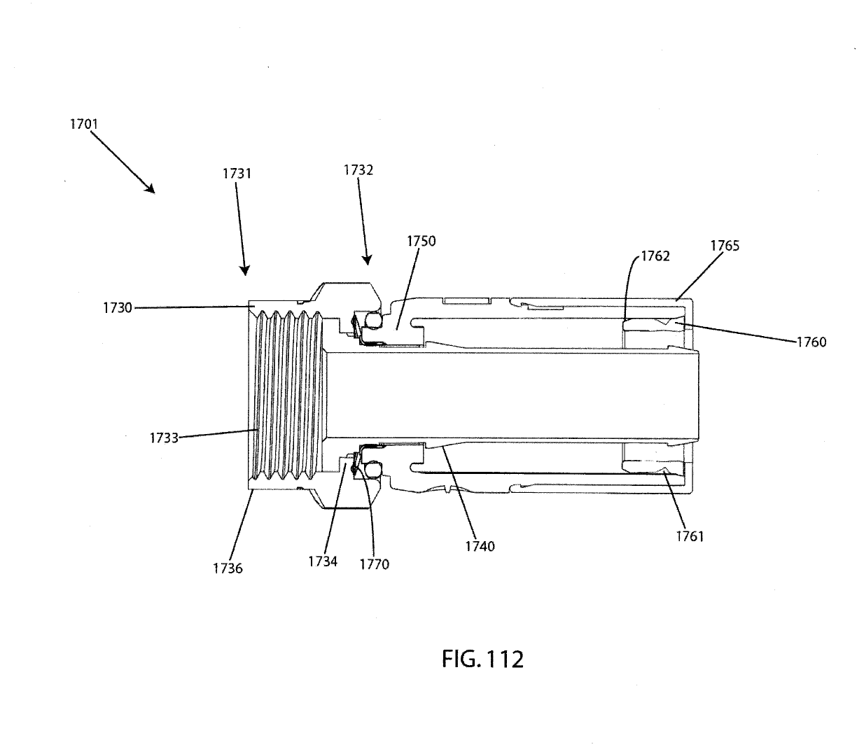

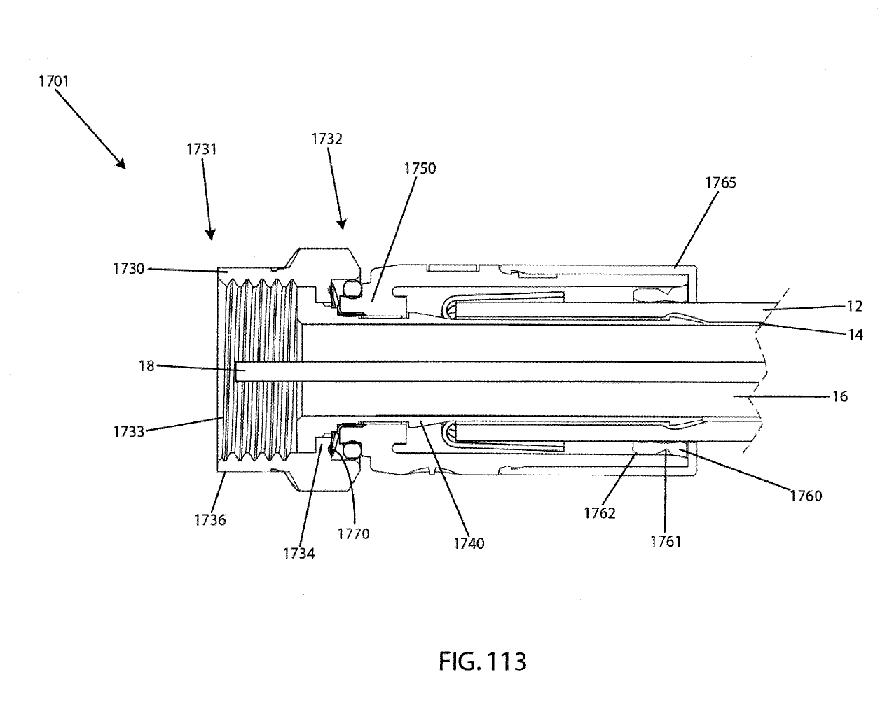

Referring still to the drawings, FIGS. 111A-113 depict embodiments of connector 1701. Embodiments of connector 1701 may include a coupling member 1730, a post 1740, a connector body 1750, a continuity member 1770, a compression portion 1760, and a radial restriction member 1765. As described supra, embodiments of compression 1760 may be structurally independent of or structurally connected to the connector body 1750, as shown in FIG. 111A and FIG. 111B, respectively. FIGS. 112 and 113 show the manner in which the compression portion deforms upon engagement with the connector body 1750 and ultimately is axially displaced within the connector body 1750 and compressed onto the cable to create a seal around the cable jacket 12.

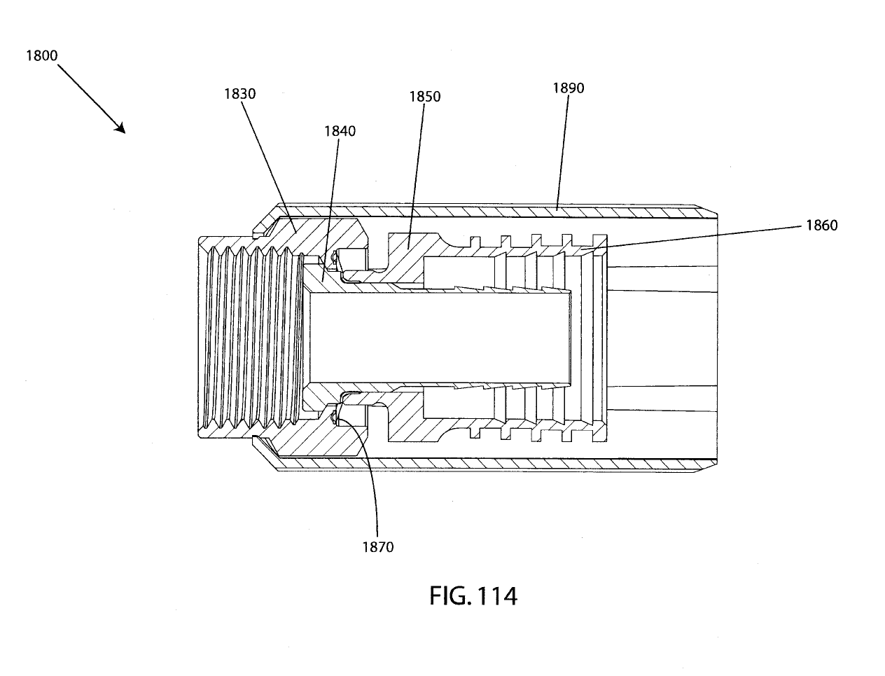

Referring now to FIG. 114, embodiments of connector 1800 may include a coupling member 1830, a post 1840, a connector body 1850, a continuity member 1870, an outer sleeve 1890, and a compression portion 1860. Embodiments of coupling member 1830 may share the same or substantially the same structural and functional aspects of nut 30/930/1030/1130/1230, and coupling member 1330b/1430b/1530b/1730 such as being mated, threaded or otherwise, to a corresponding interface port 20. Embodiments of sleeve 1890 may share the same or substantially the same structural and functional aspects of the outer sleeve 1390b/1490b/1590b. Similarly, embodiments of post 1840 and connector body 1850 may share the same or substantially the same structural and functional aspects of the embodiments of post 40/940/1040/1140/1240/1340/1440/1540/1740 and connector body 50/950/1050/1150/1250/1350/1450/1550/1750 described supra. Embodiments of continuity element 1870 may be disposed in the same or substantially the same location in connector 1800 and may share the same structural and functional aspects as continuity member 70/170/270/370/470/570/670/970/1070/1170/1270/1370/1470/1570/1670/1770, as described supra. However, continuity member 1870 may share the same structural and functional aspects of continuity member 770/870 if connector body 1850 is appropriately modified to accommodate continuity member 770/870. Connector 1800 may come in a preassembled configuration or may require additional operable attachment of connector components during installation.

Embodiments of connector 1800 may include compression portion 1860. Compression portion 1860 may be structurally integral with the connector body 1850; however, the compression portion 1860 may be configured to be crimped onto a coaxial cable 10. For example, the compression portion 1860 may be a portion of the connector body 1850 that may be compressed, by a tool or other crimping means, tightly around the jacket 12 of the coaxial cable 10. In most embodiments, the sleeve 1890 may be operably assembled after the crimping of compression portion 1860. The operable attachment of the outer sleeve is described in detail supra.

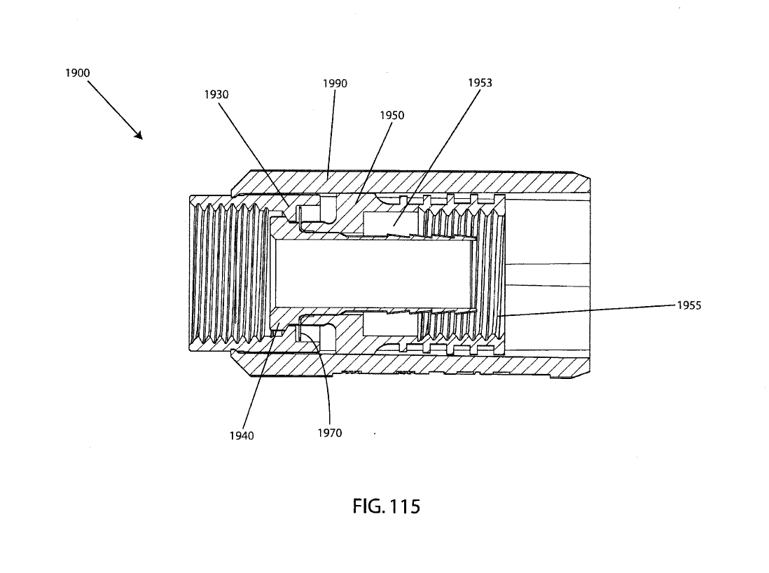

With reference now to FIG. 115, embodiments of connector 1900 may include a coupling member 1930, a post 1940, a connector body 1950, a continuity member 1970, and an outer sleeve 1990. Embodiments of coupling member 1930 may share the same or substantially the same structural and functional aspects of coupling member 1630 such as being mated, threaded or otherwise, to a corresponding interface port 20. Embodiments of sleeve 1990 may share the same or substantially the same structural and functional aspects of the outer sleeve 1390a/1490a/1590a. Similarly, embodiments of post 1840 may share the same or substantially the same structural and functional aspects of the embodiments of post 40/940/1040/1140/1240/1340/1440/1540/1740/1840 described supra. Embodiments of continuity element 1970 may be disposed in the same or substantially the same location in connector 1800 and may share the same structural and functional aspects as continuity member 70/170/270/370/470/570/670/970/1070/1170/1270/1370/1470/1570/1670/1770/1870, as described supra. However, continuity member 1970 may share the same structural and functional aspects of continuity member 770/870 if connector body 1950 is appropriately modified to accommodate continuity member 770/870. Connector 1900 may come in a preassembled configuration or may require additional operable attachment of connector components during installation.

Embodiments of connector 1900 may include a connector body 1950. Connector body 1950 may share the same structural and functional aspects of connector body 50/950/1050/1150/1250/1350/1450/1550/1750. However, connector body may include internal threads 1955 along an inner surface 1953 of the connector body 1950. The internal threads 1955 of the connector body 1950 may correspond to threads of a hardline cable, or other coaxial cable having a threadable outer, rigid conductive strand.

Those skilled in the art should appreciate that various combinations and embodiments disclosed and described in detail herein may include a body sealing element, such as sealing element 80, to provide an environmental seal for the coaxial cable connector.

With reference to FIGS. 54A-115, a method of obtaining electrical continuity for a coaxial cable connection may include the steps of providing a coaxial cable connector including: a connector body 50/950/1050/1150/1250/1350/1450/1550/1750/1850/1950, a post 40/940/1040/1140/1240/1340/1440/1540/1740/1840/1940 operably attached to the connector body50/950/1050/1150/1250/1350/1450/1550/1750/1850/1950, the post 40/940/1040/1140/1240/1340/1440/1540/1740/1840/1940 having a flange 44, a coupling member 1330/1430/1530/1630/1730/1830/1930 axially rotatable with respect to the post 40/940/1040/1140/1240/1340/1440/1540/1740/1840/1940 and the connector body 50/950/1050/1150/1250/1350/1450/1550/1750/1950, the coupling member 1330/1430/1530/1630/1730/1830/1930 including a lip 34/1334a/1334b/1434a/1434b/1534a/1534b/1634a/1634b/1734a/1734b continuity member 70/170/270/3 70/470/570/670/970/1070/1170/1270/1370/1470/1570/1670/1770/1870/1970 located between the post 40/940/1040/1140/1240/1340/1440/1540/1740/1840/1940 and the coupling member 1330/1430/1530/1630/1730/1830/1930, an outer sleeve 1390/1490/1590/1690/1790/1890/1990 engageable with the coupling member 1330/1430/1530/1630/1730/1830/1930, and a compression portion 1360/1460/1560/1660/1760/1760/1860/1960 structurally integral with the connector body 50/950/1050/1150/1250/1350/1450/1550/1750/1850/1950, wherein the compression portion 1360/1460/1560/1660/1760/1760/1860/1960 is configured to break apart from the connector body 50/950/1050/1150/1250/1350/1450/1550/1750/1850/1950 when axially compressed; securely attaching a coaxial cable 10 to the connector so that the grounding shield of the cable 10 electrically contacts the post 40/940/1040/1140/1240/1340/1440/1540/1740/1840/1940, by axially compressing the compression portion 1360/1460/1560/1660/1760/1760/1860/1960 so that the compression portion 1360/1460/1560/1660/1760/1760/1860/1960 breaks away from the body 50/950/1050/1150/1250/1350/1450/1550/1750/1850/1950 and securely connects to the coaxial cable 10; extending electrical continuity from the post 40/940/1040/1140/1240/1340/1440/1540/1740/1840/1940 through the continuity member 70/170/270/370/470/570/670/970/1070/1170/1270/1370/1470/1570/1670/1770/1870/1970 to the coupling member 1330/1430/1530/1630/1730/1830/1930; and fastening the coupling member 1330/1430/1530/1630/1730/1830/1930 to a conductive interface port 20 to complete the ground path and obtain electrical continuity in the cable connection.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

1. A coaxial cable connector comprising;
a connector body;
a post engageable with connector body, wherein the post includes a flange;
a coupling member, axially rotatable with respect to the post and the connector body, the coupling member having a first end, an opposing second end portion, and an internal lip;
a continuity member disposed only axially rearward of a surface of the internal lip of the coupling member that faces the flange;
an outer sleeve engageable with the coupling member, the sleeve configured to rotate the coupling member; and
a compression portion structurally integral with the connector body, wherein the compression portion is configured to break apart from the body when axially compressed.

2. The coaxial cable connector of claim 1, further comprising a radial restriction member, wherein at least some part of the radial restriction member is disposed radially extent of the compression portion to restrict radial expansion of the compression portion.

3. The coaxial cable connector of claim 2, wherein the radial restriction member comprises at least one strap positioned around at least a section of the compression portion.

4. The coaxial cable connector of claim 2, wherein the radial restriction member includes an inwardly extending lip.

5. The coaxial cable connector of claim 1, wherein the outer sleeve extends to the first end of the coupling member.

6. The coaxial cable connector of claim 1, wherein the outer sleeve extends beyond the first end of the coupling member, to guide the coupling member onto a corresponding port.

7. The coaxial cable connector of claim 1, wherein the outer sleeve includes an engagement member configured to mate with a retaining structure of the coupling member.

8. A coaxial cable connector comprising;
a connector body;
a post engageable with the connector body, wherein the post includes a flange;
a coupling member, axially rotatable with respect to the post and the connector body, the coupling member having a first end, an opposing second end portion, and an internal lip;
a continuity member disposed only axially rearward of a surface of the internal lip of the coupling member that faces the flange; and
an outer sleeve engageable with the coupling member, the sleeve configured to rotate the coupling member.

9. The coaxial cable connector of claim 8, further comprising a compression portion structurally integral with the connector body, wherein the compression portion is configured to break apart from the body when axially compressed.

10. The coaxial cable connector of claim 8, further comprising a separate fastener member radially disposed over the connector body to radially compress a coaxial cable.

11. The coaxial cable connector of claim 8, further comprising a separate insertable compression sleeve configured to be inserted within an opening of the connector body proximate a rearward end of the connector body.

12. The coaxial cable connector of claim 8, wherein the outer sleeve extends to the first end of the coupling member.

13. The coaxial cable connector of claim 8, wherein the outer sleeve extends beyond the first end of the coupling member to guide the coupling member onto a corresponding port.

14. The coaxial cable connector of claim 8, wherein the outer sleeve includes an engagement member configured to mate with a retaining structure of the coupling member.

15. A coaxial cable connector comprising;
a connector body;
a post engageable with connector body, wherein the post includes a flange;
a coupling member, axially rotatable with respect to the post and the connector body, the coupling member having a first end, an opposing second end portion, and an internal lip;
a continuity member disposed only axially rearward of a surface of the internal lip of the coupling member that faces the flange; and
a compression portion structurally integral with the connector body, wherein the compression portion is configured to break apart from the body when axially compressed.

16. The coaxial cable connector of claim 15, further comprising a radial restriction member, wherein at least some part of the radial restriction member is disposed radially extent of the compression portion to restrict radial expansion of the compression portion.

17. The coaxial cable connector of claim 16, wherein the radial restriction member comprises at least one strap positioned around at least a section of the compression portion.

18. The coaxial cable connector of claim 16, wherein the radial restriction member includes an inwardly extending lip.

19. A method of obtaining electrical continuity for a coaxial cable connection, the method comprising:
providing a coaxial cable connector including:
a connector body;
a post operably attached to the connector body, the post having a flange;
a coupling member axially rotatable with respect to the post and the connector body, the coupling member including a lip;
a continuity member located between the post and the coupling member;
an outer sleeve engageable with the coupling member; and
a compression portion structurally integral with the connector body,
wherein the compression portion is configured to break apart from the body when axially compressed;
securely attaching a coaxial cable to the connector so that the grounding shield of the cable electrically contacts the post, by axially compressing the compression portion so that the compression portion breaks away from the body and securely connects to the coaxial cable;
extending electrical continuity from the post through the continuity member to the coupling member; and
fastening the coupling member to a conductive interface port to complete the ground path and obtain electrical continuity in the cable connection.
